(19) United States
(12) Patent Application Publication
(10) Pub. No.: US 2020/0071504 A1
(43) Pub. Date: Mar. 5, 2020

(54) RESIN COMPOSITION AND RESIN MOLDED BODY

(71) Applicant: FUJI XEROX CO., LTD., Tokyo (JP)

(72) Inventors: Kana MIYAZAKI, Minamiashigara-shi (JP); Ryo TANAKA, Minamiashigara-shi (JP); Kenji YAO, Minamiashigara-shi (JP)

(73) Assignee: FUJI XEROX CO., LTD., Tokyo (JP)

(21) Appl. No.: 16/270,933

(22) Filed: Feb. 8, 2019

(30) Foreign Application Priority Data
Aug. 31, 2018 (JP) 2018-164069

(51) Int. Cl. C08L 1/14

(52) U.S. Cl. CPC C08L 1/14; C08L 2205/06; C08L 2207/53; C08L 2207/04

(57) ABSTRACT

Provided is a resin composition containing: a cellulose acylate (A); a thermoplastic elastomer (B); and particles (C) of at least one type of organic compound containing two or more nitrogen atoms in a molecule.

### CROSS-REFERENCE TO RELATED APPLICATIONS

This application is based on and claims priority under 35 USC 119 from Japanese Patent Application No. 2018-164069 filed on Aug. 31, 2018.

### BACKGROUND

### Technical Field

The present invention relates to a resin composition and a resin molded body.

### Related Art

In the related art, various resin compositions are provided and used for various applications. The resin composition is particularly used in various parts, housings, and the like of home electric appliances and automobiles. A thermoplastic resin is also used in parts such as housings of business equipment and electronic and electric equipment.

In recent years, a plant-derived resin has been used, and examples of the plant-derived resin known in the related art include a cellulose acylate.

For example, Patent Literature 1 discloses “a thermoplastic elastomer composition comprising a thermoplastic resin and an elastomer, wherein the thermoplastic resin forms a continuous phase, the elastomer forms a discontinuous phase, and the elastomer contains a colorant”.

Patent Literature 2 discloses “a resin composition comprising a polylactic acid resin (a), a resin (b) superior in heat resistance to the polylactic acid resin, an elastomeric resin (c), and a crystal nucleating agent (d) which promotes crystallization of the polylactic acid resin, wherein the crystal nucleating agent is a soluble azo lake pigment.

Patent Literature 3 discloses “a cellulose acylate film comprising a cellulose acylate, a benzotriazole-based ultraviolet absorbent, and an ester oligomer, wherein the cellulose acylate film has a thickness of 10 μm or more and 40 μm or less, the benzotriazole-based ultraviolet absorbent is contained in 4 parts by mass or more and 20 parts by mass or less with respect to 100 parts by mass of the cellulose acylate, the ester oligomer comprises a unit derived from a diol and at least one of a unit derived from 1,2-cyclohexane dicarboxylic acid and a unit derived from 1,4-cyclohexane dicarboxylic acid, an end is sealed with a group derived from a monocarboxylic acid having an alicyclic structure, and a hydroxyl value is 30 mg KOH/g or less”.

### CITATION LIST

### Patent Literature

Patent Literature 1: JP-A-10-237227
Patent Literature 2: JP-A-2010-132816
Patent Literature 3: JP-A-2016-222809

### SUMMARY

When a resin composition containing a cellulose acylate (A) is molded (for example, injection molded), since molecules of the cellulose acylate (A) are oriented to form an orientation layer on a surface, a molded body excellent in surface glossiness is easily obtained. However, when particles (C) of organic compound is contained in the resin composition, the surface glossiness might be reduced since the particles (C) of organic compound tends to enter and localize in the above orientation layer.

Aspects of non-limiting embodiments of the present disclosure relate to a resin composition by which a resin molded body having high surface glossiness is obtained as compared with a resin composition which contains a cellulose acylate (A) and particles (C) at least of at least one type of organic compound containing two or more nitrogen atoms in the molecule and does not contain a thermoplastic elastomer (B), or a resin composition which contains a cellulose acylate (A), a thermoplastic elastomer (B), and particles (C) of organic compound containing only one or less nitrogen atom in the molecule.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a resin composition containing:

a cellulose acylate (A);

a thermoplastic elastomer (B); and

particles (C) of at least one type of organic compound containing two or more nitrogen atoms in a molecule.

### DETAILED DESCRIPTION

An exemplary embodiment of the present invention is described below. These descriptions and examples illustrate the exemplary embodiment and do not limit a scope of the exemplary embodiment.

In the present invention, a numerical range indicated by using “to” shows a range including numerical values described before and after “to” as a minimum value and a maximum value respectively.

In the numerical range described stepwise in the present invention, an upper limit value or a lower limit value described in one numerical range may be replaced with an upper limit value or a lower limit value of a numerical range in other stepwise descriptions. In addition, in a numerical range described in the present disclosure, an upper limit value or a lower limit value of the numerical range may be replaced with a value shown in an example, respectively.

In the present invention, a term “process” is not only an independent process, but also a process that cannot be clearly distinguished from other processes as long as an intended purpose of the process is achieved.

In the present invention, each component may contain a plurality of corresponding substances. In the present invention, when referring to an amount of each component in the composition, it means a total amount of a plurality of substances present in the composition in a case where the plurality of substances corresponding to each component are present in the composition, unless otherwise specified.

In the present invention, “(meth)acryl” means at least one of acryl and methacryl, and “(meth)acrylate” means at least one of acrylate and methacrylate.

In the present invention, a cellulose acylate (A), a thermoplastic elastomer (B), particles (C) of at least one type of organic compound containing two or more nitrogen atoms in the molecule, a plasticizer (D), a polyester resin (E), and a poly (meth)acrylate compound (F) are also called component (A), component (B), component (C), component (D), component (E), and component (F) respectively.

### <Resin Composition>

The resin composition according to the exemplary embodiment contains a cellulose acylate (A), a thermoplastic elastomer (B), and particles (C) of at least one type of organic compound containing two or more nitrogen atoms in the molecule.

The resin composition according to the exemplary embodiment may further contain a plasticizer (D), a polyester resin (E), and a poly (meth)acrylate compound (F), and other additives.

According to the resin composition according to the exemplary embodiment including the above constituents, high surface glossiness (gloss) is obtained when a resin molded body is formed.

A reason for this is presumed as follows.

In the related art, the particles (C) of organic compound is added to the resin composition containing the cellulose acylate (A) from various viewpoints (for example, a purpose of coloration, improving strength, improving weather resistance, and the like).

Here, when the resin composition containing the cellulose acylate (A) is molded, since molecules of the cellulose acylate (A) are oriented to form an orientation layer on a surface, a molded body excellent in surface glossiness is obtained. In particular, in a case where the molded body is formed by injection molding, since the orientation layer is made strong, the gloss is more excellent. However, when the particles (C) of organic compound is contained in the resin composition containing the cellulose acylate (A), the particles (C) of organic compound tends to enter and localize between the molecules of the oriented cellulose acylate (A), so that the gloss may be lost and the surface gloss may be reduced.

In contrast, the resin composition according to the exemplary embodiment further contains the thermoplastic elastomer (B). The thermoplastic elastomer (B) tends to be more likely to localize on a core layer side than the orientation layer, that is, on a center side than a surface side of the resin molded body.

Further, the thermoplastic elastomer (B) has a property that easily combines the particles (C) of organic compound, and a property that shows adhesiveness to the particles (C) of organic compound. In particular, in a case where the thermoplastic elastomer (B) is a polymer having a core-shell structure (for example, polymer (b1) and polymer (b2) described later), there is a strong tendency to easily combine the particles (C) of organic compound as the property thereof, and in a case where the thermoplastic elastomer (B) is a linear or branched polymer (for example, an elastomer of (b3) to (b6) described later), there is a strong tendency to have high adhesiveness to the particles (C) of organic compound as the property thereof. Therefore, when the resin composition according to the exemplary embodiment is kneaded, the particles (C) of organic compound is dispersed so as to be attracted by dispersion of the thermoplastic elastomer (B), and is more likely to localize on the central side of the core layer, that is, the resin molded body.

As a result, it is presumed that the particles (C) of organic compound is suppressed from localizing in the orientation layer, that is, the surface side, and high surface glossiness (gloss) is obtained in the formed resin molded body.

It is considered that the gloss is reduced by containing the particles (C) of organic compound “containing two or more nitrogen atoms in the molecule” as the organic compound particle as described above, and in other words, it is considered that the gloss is hard to be reduced even containing the organic compound particle containing only one nitrogen atom in the molecule.

A reason for this is presumed as follows.

In the organic compound particle containing one nitrogen atom in the molecule, it is considered that the surface glossiness is not reduced since it is difficult to enter between the molecules of the cellulose acylate (A) as described above or force of pushing the particle aside is stronger than entering force when the particle is transited between the molecules of the cellulose acylate (A).

It is preferable that the resin composition according to the exemplary embodiment further contains the plasticizer (D). A resin molded body having high surface glossiness is easily obtained by containing the plasticizer (D).

A reason for this is presumed as follows.

The plasticizer (D) has an action of competing with the entry of the cellulose acylate (A) molecules into the orientation layer by the organic compound particles (C). Therefore, the plasticizer (D) enters before the particles (C) of organic compound enters between the molecules of the oriented cellulose acylate (A), or the plasticizer (D) enters by pushing aside the organic compound particles (C) entering between the molecules of the cellulose acylate (A) previously. Accordingly, it is presumed that localization of the particles (C) of organic compound to the surface side of the resin molded body is suppressed, and high surface glossiness (gloss) is obtained.

The components of the resin composition according to the exemplary embodiment are described in detail below.

### [Cellulose Acylate (A): Component (A)]

The cellulose acylate (A) is a cellulose derivative in which at least a part of hydroxy groups in the cellulose are substituted (acylated) with an acyl group. The acyl group is a group having a structure of —CO—R^{AC} (R^{AC} represents a hydrogen atom or a hydrocarbon group.).

The cellulose acylate (A) is, for example, a cellulose derivative represented by the following general formula (CA).

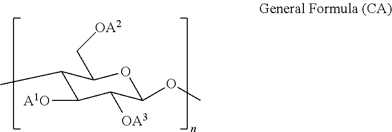

In the general formula (CA), each of A¹, A² and A³ independently represents a hydrogen atom or an acyl group, and n represents an integer of 2 or more. However, at least a part of n A¹, n A², and n A³ represents acyl groups. n A¹ in the molecule may be all the same, partly the same, or different from each other. Similarly, n A² and n A³ in the molecule each may be all the same, partly the same, or different from each other.

The hydrocarbon group in the acyl group represented by A¹, A² and A³ may be any of linear, branched, or cyclic, but is preferably linear or branched, and more preferably linear.

The hydrocarbon group in the acyl group represented by A¹, A² and A³ may be a saturated hydrocarbon group or an unsaturated hydrocarbon group, but is more preferably a saturated hydrocarbon group.

The acyl group represented by A¹, A² and A³ is preferably an acyl group having 1 to 6 carbon atoms. That is, the cellulose acylate (A) is preferably a cellulose acylate (A) in which the acyl group has 1 to 6 carbon atoms. The cellulose acylate (A) in which the acyl group has 1 to 6 carbon atoms is more likely to obtain a resin molded body having high surface glossiness than a cellulose acylate (A) containing an acyl group having 7 or more carbon atoms.

A hydrogen atom in the acyl group represented by A¹, A² and A³ may be substituted with a halogen atom (such as a fluorine atom, a bromine atom, and an iodine atom), an oxygen atom, a nitrogen atom, or the like, but is preferably not substituted.

Examples of the acyl group represented by A¹, A² and A³ include a formyl group, an acetyl group, a propionyl group, a butyryl group (butanoyl group), a propenoyl group, and a hexanoyl group. Among these, the acyl group is more preferably an acyl group having 2 to 4 carbon atoms, and still more preferably an acyl group having 2 or 3 carbon atoms in view of moldability of the resin composition and the surface glossiness of the resin molded body.

Examples of the cellulose acylate (A) include cellulose acetate (cellulose monoacetate, cellulose diacetate (DAC), cellulose triacetate, cellulose acetate propionate (CAP), and cellulose acetate butyrate (CAB).

The cellulose acylate (A) is preferably cellulose acetate propionate (CAP) and cellulose acetate butyrate (CAB), and is more preferably cellulose acetate propionate (CAP) in view of the surface glossiness of the resin molded body.

The cellulose acylate (A) may be used alone or in combination of two or more.

A weight average polymerization degree of the cellulose acylate (A) is preferably 200 or more and 1,000 or less, more preferably 500 or more and 1,000 or less, and still more preferably 600 or more and 1,000 or less in view of the moldability of the resin composition and the surface glossiness of the resin molded body.

The weight average polymerization degree of the cellulose acylate (A) is determined from a weight average molecular weight (Mw) by the following procedure.

First, the weight average molecular weight (Mw) of the cellulose acylate (A) in terms of polystyrene is measured by a gel permeation chromatography apparatus (GPC apparatus: manufactured by Tosoh Corporation, HLC-8320 GPC, column: TSKgel α-M) using tetrahydrofuran.

Next, the weight average molecular weight (Mw) of the cellulose acylate (A) is divided by a molecular weight of the monomer of the cellulose acylate (A) to determine the polymerization degree thereof. For example, in a case where a substituent of the cellulose acylate is an acetyl group, the molecular weight of the monomer is 263 when a substitution degree is 2.4, and is 284 when the substitution degree is 2.9.

The substitution degree of the cellulose acylate (A) is preferably 2.1 or more and 2.9 or less, more preferably 2.2 or more and 2.9 or less, still more preferably 2.3 or more and 2.9 or less, and particularly preferably 2.6 or more and 2.9 or less in view of the moldability of the resin composition and the surface glossiness of the resin molded body.

In the cellulose acetate propionate (CAP), a substitution degree ratio of the acetyl group to the propionyl group (acetyl group/propionyl group) is preferably 0.01 or more and 1 or less, and more preferably 0.05 or more and 0.1 or less in view of the moldability of the resin composition and the surface glossiness of the resin molded body.

The CAP preferably satisfies at least one of the following (1), (2), (3), and (4), more preferably satisfies the following (1), (3), and (4), and still more preferably satisfies the following (2), (3), and (4). (1) When measured by a GPC method using tetrahydrofuran as a solvent, the weight average molecular weight (Mw) in terms of polystyrene is 160,000 or more and 250,000 or less, and a ratio Mn/Mz of a number average molecular weight (Mn) in terms of polystyrene to a Z average molecular weight (Mz) in terms of polystyrene is 0.14 or more and 0.21 or less. (2) When the CAP is measured by the GPC method using tetrahydrofuran as a solvent, the weight average molecular weight (Mw) in terms of polystyrene is 160,000 or more and 250,000 or less, a ratio Mn/Mz of the number average molecular weight (Mn) in terms of polystyrene to the Z average molecular weight (Mz) in terms of polystyrene is 0.14 or more and 0.21 or less, and a ratio Mw/Mz of the weight average molecular weight (Mw) in terms of polystyrene to the Z average molecular weight (Mz) in terms of polystyrene is 0.3 or more and 0.7 or less. (3) When the CAP is measured by capillography under conditions of 230° C. in accordance with ISO 11443: 1995, a ratio η1/η2 of viscosity η1 (Pa·s) at a shear speed of 1216 (/sec) to viscosity η2 (Pa·s) at a shear speed of 121.6 (/sec) is 0.1 more and 0.3 or less. (4) When a small square plate test piece (D11 test piece specified by JIS K7139: 2009, 60 mm×60 mm, thickness 1 mm) obtained by injection molding of the CAP is left for 48 hours in an atmosphere at a temperature of 65° C. and a relative humidity of 85%, both an expansion rate in an MD direction and an expansion rate in a TD direction are 0.4% or more and 0.6% or less. Here, the MD direction means a length direction of a cavity of a mold used for injection molding, and the TD direction means a direction orthogonal to the MD direction.

In the cellulose acetate butyrate (CAB), the substitution degree ratio of the acetyl group to the butyryl group (acetyl group/butyryl group) is preferably 0.05 or more and 3.5 or less, and more preferably 0.5 or more and 3.0 or less in view of the moldability of the resin composition and the surface glossiness of the resin molded body.

The substitution degree of the cellulose acylate (A) is an index indicating a degree in which the hydroxy group of cellulose is substituted with the acyl group. That is, the substitution degree is an index indicating a degree of acylation of the cellulose acylate (A). Specifically, the substitution degree means an intramolecular average of the number of substitution in which three hydroxy groups in a D-glucopyranose unit of the cellulose acylate are substituted with acyl groups. The substitution degree is determined from an integral ratio of cellulose-derived hydrogen and an acyl group-derived peak by ¹H-NMR (JMN-ECA/JEOL manufactured by RESONANCE).

[Thermoplastic elastomer (B): Component (B)]

Examples of the thermoplastic elastomer (B) include at least one thermoplastic elastomer (B) selected from the group consisting of:

a polymer (b1) having a core-shell structure which includes a core layer and a shell layer containing an alkyl (meth)acrylate on a surface of the core layer;

an olefin polymer (b2) which is a polymer of an α-olefin and an alkyl (meth)acrylate and contains 60 mass % or more of monomers derived from the α-olefin;

a polymer (b3) having a core-shell structure which includes a core layer containing a butadiene polymer, and a shell layer containing a polymer selected from a styrene polymer and an acrylonitrile-styrene polymer on a surface of the core layer;

a styrene-ethylene-butadiene-styrene copolymer (b4);

a polyurethane (b5); and

a polyester (b6).

The thermoplastic elastomer (B) is, for example, a thermoplastic elastomer having elasticity at normal temperature (25° C.) and having a softening property same as a thermoplastic resin at high temperature.

(Polymer (b1) Having Core-Shell Structure: Component (b1))

The polymer (b1) having a core-shell structure includes a core layer and a shell layer on a surface of the core layer.

The polymer (b1) having a core-shell structure is a polymer in which the core layer is set as an innermost layer and the shell layer is set as an outermost layer (specifically, a polymer in which the shell layer is obtained by graft-polymerizing a polymer of an alkyl (meth)acrylate on a polymer as the core layer).

One or more other layers (for example, 1 or more and 6 or less other layers) may be provided between the core layer and the shell layer. In a case where other layers are provided, the polymer (b1) having a core-shell structure is a polymer in which a plurality of polymers are graft-polymerized to be multilayered on a polymer as the core layer.

The core layer is not particularly limited, but may be a rubber layer. Examples of the rubber layer include layers of (meth)acrylic rubber, silicone rubber, styrene rubber, conjugated diene rubber, α-olefin rubber, nitrile rubber, urethane rubber, polyester rubber, polyamide rubber, or copolymer rubber of two or more thereof.

Among these, the rubber layer is preferably a layer of (meth)acrylic rubber, silicone rubber, styrene rubber, conjugated diene rubber, α-olefin rubber, or copolymer rubber of two or more thereof.

The rubber layer may be a rubber layer obtained by copolymerizing and crosslinking a crosslinking agent (divinylbenzene, allyl acrylate, butylene glycol diacrylate, or the like).

Examples of the (meth)acrylic rubber include a polymer rubber obtained by polymerizing a (meth)acrylic component (for example, an alkyl (meth)acrylate in which the alkyl has 2 to 8 carbon atoms).

Examples of the silicone rubber include a rubber composed of a silicone component (polydimethylsiloxane, polyphenylsiloxane, or the like).

Examples of the styrene rubber include a polymer rubber obtained by polymerizing a styrene component (styrene, α-methylstyrene, or the like).

Examples of the conjugated diene rubber include a polymer rubber obtained by polymerizing a conjugated diene component (butadiene, isoprene, or the like).

Examples of the α-olefin rubber include a polymer rubber obtained by polymerizing an α-olefin component (ethylene, propylene, 2-methylpropylene).

Examples of the copolymer rubber include a copolymer rubber obtained by polymerizing two or more (meth)acrylic components, a copolymer rubber obtained by polymerizing a (meth)acrylic component and a silicone component, and a copolymer of a (meth)acrylic component, a conjugated diene component, and a styrene component.

In the polymer constituting the shell layer, examples of the alkyl (meth)acrylate include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, stearyl (meth)acrylate, and octadecyl (meth)acrylate. In the alkyl (meth)acrylate, at least a part of hydrogen of the alkyl chain may be substituted. Examples of a substituent of the hydrogen include an amino group, a hydroxyl group, and a halogen group.

Among these, a polymer of the alkyl (meth)acrylate is preferably a polymer of an alkyl (meth)acrylate in which an alkyl chain has 1 to 8 carbon atoms, more preferably a polymer of an alkyl (meth)acrylate in which an alkyl chain has 1 or 2 carbon atoms, and still more preferably a polymer of an alkyl (meth)acrylate in which an alkyl chain has one carbon atom in view of the surface glossiness of the resin molded body.

The polymer constituting the shell layer may be a polymer obtained by polymerizing at least one selected from a glycidyl group-containing vinyl compound or an unsaturated dicarboxylic acid anhydride in addition to the alkyl (meth)acrylate.

Examples of the glycidyl group-containing vinyl compound include glycidyl (meth)acrylate, glycidyl itaconate, glycidyl itaconate, allyl glycidyl ether, styrene-4-glycidyl ether, and 4-glycidyl styrene.

Examples of the unsaturated dicarboxylic acid anhydride include maleic anhydride, itaconic anhydride, glutaconic anhydride, citraconic anhydride, and aconitic anhydride. Among these, maleic anhydride is preferable.

One or more other layers between the core layer and the shell layer include the layer of the polymer described in the shell layer.

A mass proportion of the shell layer with respect to the entire core-shell structure is preferably 1 mass % or more and 40 mass % or less, more preferably 3 mass % or more and 30 mass % or less, and still more preferably 5 mass % or more and 15 mass % or less.

The polymer (b1) having a core-shell structure can be manufactured by a well-known method.

Examples of the well-known method include emulsion polymerization. Specifically, the following methods are exemplified as a manufacturing method. First, a mixture of monomers is emulsified and polymerized to produce core particles (core layer), and then another mixture of monomers is emulsified and polymerized in the presence of the core particles (core layer) to produce a polymer having a core-shell structure that forms a shell layer around the core particles (core layer).

In a case where another layer is formed between the core layer and the shell layer, the emulsion polymerization of another mixture of monomers is repeated to obtain a polymer having a core-shell structure composed of the core layer, another layer, and the shell layer as targets.

Examples of a commercially available product of the polymer (b1) having a core-shell structure include “METABLEN” (registered trademark) manufactured by Mitsubishi Chemical Corporation, “KANE ACE” (registered trademark) manufactured by Kaneka Corporation, “PARALOID” (registered trademark) manufactured by Dow Chemical Japan Ltd., “STAFILOID” (registered trademark) manufactured by Aica Kogyo Co., Ltd., and “PARAFACE” (registered trademark) manufactured by Kuraray Co., Ltd.

(Olefin Polymer (b2): Component (b2))

The olefin polymer (b2) is preferably an olefin polymer which is a polymer of an α-olefin and an alkyl (meth)acrylate and contains 60 mass % or more of monomers derived from the α-olefin.

In the olefin polymer, examples of the α-olefin include ethylene, propylene, and 2-methylpropylene. The α-olefin preferably has 2 to 8 carbon atoms, and more preferably has 2 to 3 carbon atoms in view of the surface glossiness of the resin molded body. Among these, ethylene is still more preferable.

Meanwhile, examples of the alkyl (meth)acrylate polymerized with the α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, stearyl (meth)acrylate, and octadecyl (meth)acrylate. Examples of the alkyl (meth)acrylate polymerized with the α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, octadecyl (meth)acrylate, or the like. In view of the surface glossiness of the resin molded body, an alkyl (meth)acrylate in which an alkyl chain has 1 to 8 carbon atoms is preferable, an alkyl (meth)acrylate in which an alkyl chain has 1 to 4 carbon atoms is more preferable, and an alkyl (meth)acrylate in which an alkyl chain has 1 or 2 carbon atoms is still more preferable.

Here, the olefin polymer is preferably a polymer of ethylene and methyl acrylate in view of the surface glossiness of the resin molded body.

The olefin polymer contains the monomer derived from the α-olefin preferably in 60 mass % or more and 97 mass % or less, and more preferably in 70 mass % or more and 85 mass % or less of in view of the surface glossiness of the resin molded body.

The olefin polymer may have monomers other than the monomer derived from the α-olefin and the monomers derived from the alkyl (meth)acrylate. However, other monomers may be 10 mass % or less with respect to all monomers in the olefin polymer.

(Polymer (b3) Having Core-Shell Structure: Component (b3)) The polymer (b3) having a core-shell structure includes a core layer and a shell layer on a surface of the core layer.

The polymer (b3) having a core-shell structure is a polymer in which the core layer is set as an innermost layer and the shell layer is set as an outermost layer (specifically, a polymer in which the shell layer is obtained by graft-polymerizing a styrene polymer or an acrylonitrile-styrene polymer on the core layer containing a butadiene polymer).

One or more other layers (for example, 1 or more and 6 or less other layers) may be provided between the core layer and the shell layer. In a case where other layers are provided, the polymer (b3) having a core-shell structure is a polymer in which a plurality of polymers are graft-polymerized to form a multilayered polymer on a polymer to be the core layer.

The core layer containing the butadiene polymer is not particularly limited as long as the polymer is obtained by polymerizing components containing butadiene. The core layer may contain a homopolymer of butadiene or a copolymer of butadiene and other monomers. In a case where the core layer is a copolymer of butadiene and other monomers, examples of other monomers include vinyl aromatic series. The vinyl aromatic series may be a styrene component (such as an alkyl-substituted styrene (such as α-methylstyrene, 2-methylstyrene, 3-methylstyrene, 4-methylstyrene, 2-ethylstyrene, 3-ethylstyrene, and 4-ethylstyrene), and a halogen-substituted styrene (such as 2-chlorostyrene, 3-chlorostyrene, and 4-chlorostyrene)). The styrene components may be used alone or in combination of two or more thereof. Among the styrene components, styrene is preferably used. In addition, polyfunctional monomers such as allyl (meth)acrylate, triallyl isocyanurate, and divinylbenzene may be used as other monomers.

Specific examples of the core layer containing the butadiene polymer may include a homopolymer of butadiene, a copolymer of butadiene and styrene, and a terpolymer of butadiene, styrene, and divinyl benzene.

The butadiene polymer contained in the core layer preferably contains 60 mass % or more and 100 mass % or less (preferably 70 mass % or more and 100 mass % or less) of monomers derived from butadiene, and 0 mass % or more and 40 mass % or less (preferably 0 mass % or more and 30 mass % or less) of monomers derived from other monomers (preferably styrene components). For example, proportions of butadiene and styrene as monomers derived from monomers constituting the butadiene polymer are 60 mass % or more and 100 mass % or less and 0 mass % or more and 40 mass % or less respectively, and divinylbenzene may be 0 mass % or more and 5 mass % or less with respect to a total amount of styrene and divinylbenzene.

The shell layer containing the styrene polymer is not particularly limited as long as the shell layer contains a polymer obtained by polymerizing the styrene component. The shell layer may contain a homopolymer of styrene or a copolymer of styrene and other monomers. Examples of the styrene component include components similar to the styrene component exemplified in the core layer. Examples of other monomers include an alkyl (meth)acrylate (such as methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, stearyl (meth)acrylate, and octadecyl (meth)acrylate. In the alkyl (meth)acrylate, at least a part of hydrogen of the alkyl chain may be substituted. Examples of a substituent of the hydrogen include an amino group, a hydroxyl group, and a halogen group. The alkyl (meth)acrylate may be used alone or in combination of two or more thereof. In addition, polyfunctional monomers such as allyl (meth)acrylate, triallyl isocyanurate, and divinylbenzene may be used as other monomers. The styrene polymer contained in the shell layer may be a copolymer of 85 mass % or more and 100 mass % or less of the styrene component and 0 mass % or more and 15 mass % or less of other monomer components (preferably, alkyl (meth)acrylate).

Among these, the styrene polymer contained in the shell layer is preferably a copolymer of styrene and alkyl (meth)acrylate in view of the surface glossiness of the resin molded body. On the same point, a copolymer of styrene and alkyl (meth)acrylate in which an alkyl chain has 1 to 8 carbon atoms is preferable, and a polymer of alkyl (meth)acrylate in which an alkyl chain has 1 to 4 carbon atoms is more preferable.

A shell layer containing an acrylonitrile-styrene polymer contains a copolymer of an acrylonitrile component and a styrene component. The acrylonitrile-styrene polymer is not particularly limited, and examples thereof include a well-known acrylonitrile-styrene polymer. Examples of the acrylonitrile-styrene polymer include a copolymer of 10 mass % or more and 80 mass % or less of the acrylonitrile component and 20 mass % or more and 90 mass % or less of the styrene component. Examples of the styrene component copolymerized with the acrylonitrile component include components similar to the styrene component exemplified in the core layer. In addition, polyfunctional monomers such as allyl (meth)acrylate, triallyl isocyanurate, and divinylbenzene may be used in the acrylonitrile-styrene polymer contained in the shell layer.

One or more other layers between the core layer and the shell layer include the layer of the polymer described in the shell layer.

A mass proportion of the shell layer with respect to the entire core-shell structure is preferably 1 mass % or more and 40 mass % or less, more preferably 3 mass % or more and 30 mass % or less, and still more preferably 5 mass % or more and 15 mass % or less.

Among the component (b3), examples of a commercially available product of the polymer (b3) having a core-shell structure which includes a core layer containing a butadiene polymer and a shell layer containing a styrene polymer on a surface of the core layer include “METABLEN” (registered trademark) manufactured by Mitsubishi Chemical Corporation, “KANE ACE” (registered trademark) manufactured by Kaneka Corporation, “CLEARSTRENGTH” (registered trademark) manufactured by Arkema, and “PARALOID” (registered trademark) manufactured by Dow Chemical Japan.

In addition, among the component (b3), examples of a commercially available product of the polymer (b3) having a core-shell structure which includes a core layer containing a butadiene polymer and a shell layer containing an acrylonitrile-styrene polymer on the surface of the core layer include “BLENDEX” (registered trademark) manufactured by Galata Chemicals and “ELIX” manufactured by ELIX POLYMERS.

An average primary particle diameter of the polymers (b1, b3) having a core-shell structure is not particularly limited, but is preferably 50 nm or more and 500 nm or less, more preferably 50 nm or more and 400 nm or less, still more preferably 100 nm or more and 300 nm or less, and particularly preferably 150 nm or more and 250 nm or less in view of the surface glossiness of the resin molded body.

The average primary particle diameter refers to a value measured by the following method. A number average primary particle diameter is obtained by: observing particles with a scanning electron microscope; setting the maximum diameter of primary particles as a primary particle diameter; and measuring and averaging the primary particle diameter of 100 particles. Specifically, the number average primary particle diameter is determined by observing a dispersion form of the polymer having a core-shell structure in the resin composition with the scanning electron microscope.

(Styrene-Ethylene-Butadiene-Styrene Copolymer (b4): Component (b4))

The copolymer (b4) is not particularly limited as long as the copolymer (b4) is a thermoplastic elastomer, and examples thereof include a well-known styrene-ethylene-butadiene-styrene copolymer. The copolymer (b4) may be a styrene-ethylene-butadiene-styrene copolymer and a hydrogenated product thereof.

The copolymer (b4) is preferably the hydrogenated product of the styrene-ethylene-butadiene-styrene copolymer in view of the surface glossiness of the resin molded body. In addition, on the same point, the copolymer (b4) may be a block copolymer, and for example, is preferably a copolymer (triblock copolymer of styrene-ethylene/butylene-styrene) including a block of a styrene moiety at both ends and a block of a moiety containing ethylene/butylene in the center, which is obtained by hydrogenating at least a part of a double bond of a butadiene moiety. A block moiety of ethylene/butylene of the styrene-ethylene/butylene-styrene copolymer may be a random copolymer.

The copolymer (b4) is obtained by a well-known method. In a case where the copolymer (b4) is the hydrogenated product of the styrene-ethylene-butadiene-styrene copolymer, the copolymer (b4) is obtained by, for example, hydrogenating the butadiene moiety of a styrene-butadiene-styrene block copolymer in which a conjugated diene portion is composed of 1, 4 bonds.

Examples of a commercially available product of the copolymer (b4) include “KRATON” (registered trademark) manufactured by Clayton Co., Ltd. and “SEPTON” (registered trademark) manufactured by Kuraray Co., Ltd.

(Polyurethane (b5): Component (b5))

The polyurethane (b5) is not particularly limited as long as the polyurethane (b3) is a thermoplastic elastomer, and examples thereof include well-known polyurethanes. The polyurethane (b5) is preferably a linear polyurethane. The polyurethane (b5) is obtained by, for example, reacting a polyol component (polyether polyol, polyester polyol, polycarbonate polyol, or the like), an organic isocyanate component (aromatic diisocyanate, aliphatic (including alicyclic) diisocyanate, or the like), and a chain extender (aliphatic (including alicyclic) diol or the like) if necessary. The polyol component and the organic isocyanate component each may be used alone or in combination of two or more thereof.

The polyurethane (b5) is preferably an aliphatic polyurethane in view of the surface glossiness of the resin molded body. The aliphatic polyurethane is preferably an aliphatic polyurethane obtained by, for example, reacting a polyol component containing polycarbonate polyol with an isocyanate component containing aliphatic diisocyanate.

The polyurethane (b5) may be obtained by, for example, reacting the polyol component with the organic isocyanate component in a condition that a value of a NCO/OH ratio in raw materials in synthesis of the polyurethane is in a range of 0.90 or more and 1.5 or less. The polyurethane (b5) is obtained by a well-known method such as a one-shot method and a pre-polymerization method.

Examples of a commercially available product of the polyurethane (b5) include “ESTANE” (registered trademark) manufactured by Lubrizol Corporation and “ELASTOLLAN” (registered trademark) made by BASF SE. Examples thereof also include “Desmopan” (registered trademark) manufactured by Bayer Corporation.

(Aromatic Polyester (b6): Component (b6))

The polyester (b6) is not particularly limited as long as the polyester (b6) is a thermoplastic elastomer, and examples thereof include a well-known polyester. The polyester (b6) is preferably an aromatic polyester in view of the surface glossiness of the resin molded body. In the exemplary embodiment, the aromatic polyester represents a polyester including an aromatic ring in a structure thereof.

Examples of the polyester (b6) include a polyester copolymer (polyether ester, polyester ester, or the like). Examples of the polyester (b6) specifically include: a polyester copolymer including a hard segment consisting of a polyester unit and a soft segment consisting of a polyester unit; a polyester copolymer including a hard segment consisting of a polyester unit and a soft segment consisting of a polyether unit; and a polyester copolymer including a hard segment consisting of a polyester unit and a soft segment consisting of a polyether unit and a polyester unit. A mass ratio of the hard segment to the soft segment of the polyester copolymer (hard segment/soft segment) is preferably, for example, 20/80 or more and 80/20 or less. The polyester unit constituting the hard segment and the polyester unit and polyether unit constituting the soft segment may be either aromatic or aliphatic (including alicyclic).

The polyester copolymer as the polyester (b6) is obtained by a well-known method. The polyester copolymer is preferably a linear polyester copolymer. The polyester copolymer is obtained by: a method of esterifying or transesterifying a dicarboxylic acid component having 4 to 20 carbon atoms, a diol component having 2 to 20 carbon atoms, and a polyalkylene glycol component having a number average molecular weight of 300 or more and 20,000 or less (containing an alkylene oxide adduct of the polyalkylene glycol); a method of polycondensing oligomers after the oligomers are manufactured by esterifying or transesterifying the above components; and the like. In addition, examples of the method include a method of esterifying or transesterifying the dicarboxylic acid component having 4 to 20 carbon atoms, the diol component having 2 to 20 carbon atoms, and an aliphatic polyester component having a number average molecular weight of 300 or more and 20,000 or less. The dicarboxylic acid component is an aromatic or aliphatic dicarboxylic acid or an ester derivative thereof. The diol component is an aromatic or aliphatic diol. The polyalkylene glycol component is an aromatic or aliphatic polyalkylene glycol.

Among these components, the dicarboxylic acid component of the polyester copolymer preferably uses the dicarboxylic acid component including an aromatic ring in view of the surface glossiness of the resin molded body. In addition, the diol component and the polyalkylene glycol component preferably use the aliphatic diol component and the aliphatic polyalkylene glycol component, respectively.

Examples of a commercially available product of the polyester (b6) include “PELPRENE” (registered trademark) manufactured by Toyobo Co., Ltd., and “HYTREL” (registered trademark) manufactured by Du Pont-Toray Co., Ltd.

### [Particles (C) of At Least One Type of Organic Compound Containing Two or More Nitrogen Atoms in Molecule: Component (C)]

The structure of the organic compound in particles (C) is not particularly limited as long as the organic compound has a structure containing two or more nitrogen atoms in the molecule.

However, in view of the surface glossiness of the resin molded body, a compound containing a nitrogen-nitrogen double bond (—N═N—), a nitrogen-hydrogen bond (N—H), or both in the molecular structure is preferable. In addition, an organometallic compound is also preferable in view of the surface glossiness of the resin molded body.

As a compound containing a nitrogen-nitrogen double bond (—N═N—), a nitrogen-hydrogen bond (═N—H), or both in the molecular structure, for example, a compound having the following structure is preferable:

a quinacridone backbone (dichloroquinacridone, quinacridone, and the like), an azo group (—N═N—) (monoazo compound, disazo compound, and the like), an oxazine backbone (a six-membered heterocyclic ring structure containing one oxygen atom, one nitrogen atom, and a double bond of the two) (dioxazine and the like), a perylene backbone (perylene and the like), a quinophthalone backbone (quinophthalone yellow and the like), an isoindoline backbone, an isoindolinone backbone, a diketopyrrolopyrrole backbone, and an aminoanthraquinone backbone.

The organometallic compound is preferably, for example, a compound having the following structure:

a phthalocyanine backbone (copper phthalocyanine and the like) and a porphyrin backbone (iron porphyrin and the like).

Examples of the particles (C) of organic compound (component (C)) include, for example, the following organic compound particles.

| | | | | | | | Article Example |
|---|---|---|---|---|---|---|---|
| | | | | Molecular | | C.I. | (manufactured by |
| No. | Type | Compound Name | Chemical Formula | Weight | Classification | name | BASF) |
| 1 | Organic | 2,9-dichloroquino[2,3-b] acridine-7,14(5H,12H)- dione | 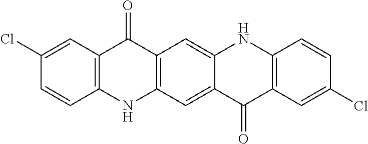 [SMILES: O=c1c2cc(Cl)ccc2[nH]c2cc3c(=O)c4cc(Cl)ccc4[nH]c3cc12] | 381 | Dichloro- quinacridone | PR202 | Cinquasia Magenta K 4535 |
| 2 | Organic | 2,9-dichloroquino[2,3-b] acridine-7,14(5H,12H)- dione | 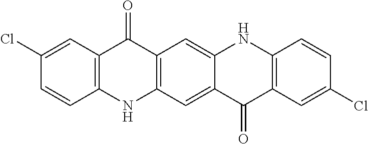 [SMILES: O=c1c2cc(Cl)ccc2[nH]c2cc3c(=O)c4cc(Cl)ccc4[nH]c3cc12] | 381 | Dichloro- quinacridone | PR202 | Cinquasia Magenta K 4535 FP |
| 3 | Organic | 2,9-dimethylquino[2,3-b] acridine-7,14(5H,12H)- dione | 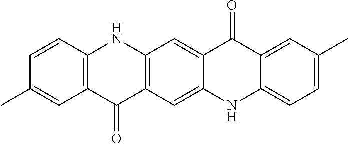 | 340 | Quinacridone | PR122 | Cinquasia Pink K 4410 |
| 4 | Organic | 2,9-dimethylquino[2,3-b] acridine-7,14(5H,12H)- dione | 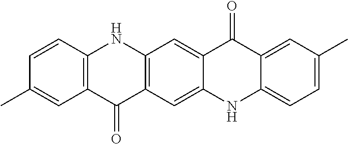 | 340 | Quinacridone | PR122 | Cinquasia Pink K 4430 FP |
| 5 | Organic | Quinacridone | 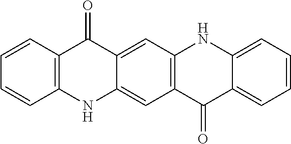 [SMILES: O=c1c2ccccc2[nH]c2cc3c(=O)c4ccccc4[nH]c3cc12] | 312 | Quinacridone | PV19 | Cinquasia Red K 4104 |
| 6 | Organic | Quinacridone | 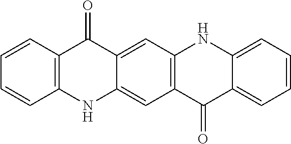 [SMILES: O=c1c2ccccc2[nH]c2cc3c(=O)c4ccccc4[nH]c3cc12] | 312 | Quinacridone | PV19 | Cinquasia Red K 4111 |
| 7 | Organic | — | — | — | Quinacridone | — | Cinquasia Red K |
| | | | | | | | 4330 |
| 8 | Organic | Quinacridone | 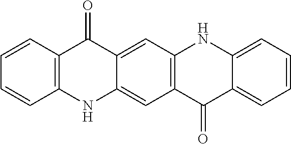 [SMILES: O=c1c2ccccc2[nH]c2cc3c(=O)c4ccccc4[nH]c3cc12] | 312 | Quinacridone | PV19 | Cinquasia Violet K 5350 |
| 9 | Organic | Quinacridone | 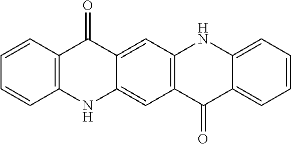 [SMILES: O=c1c2ccccc2[nH]c2cc3c(=O)c4ccccc4[nH]c3cc12] | 312 | Quinacridone | PV19 | Cinquasia Violet K 5350 FP |
| 10 | Organic | N,N′-(2-chloro-1,4- phenylene)bis[4-[(4- chloro-2-nitrophenyl) azo]-3-hydroxy-2- naphthalene carbamide] | 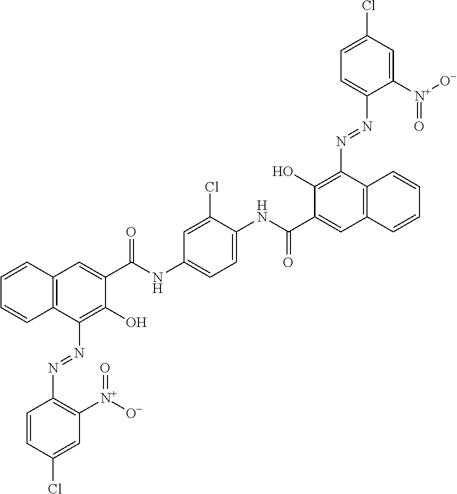 [SMILES: O=C(Nc1ccc(NC(=O)c2cc3ccccc3c(/N=N/c3ccc(Cl)cc3[N+](=O)[O-])c2O)c(Cl)c1)c1cc2ccccc2c(/N=N/c2ccc(Cl)cc2[N+](=O)[O-])c1O] | 850 | Disazo Condensation | PBr23 | Cromophtal Brown K 3001 |
| 11 | Organic | Bzenzimidazolone Orange GP | 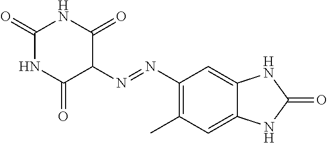 [SMILES: Cc1cc2[nH]c(=O)[nH]c2cc1/N=N/C1C(=O)NC(=O)NC1=O] | 850 | Monoazo | P064 | Cromophtal Orange K 2960 |
| 12 | Organic | 3,3′-[(2,5-dimethyl-1,4- phenylene) bis[iminocarbonyl(2- hydroxy-3,1- naphthalenediyl)azo]] bis(2-chloroethyl 4-methyl benzoate) | 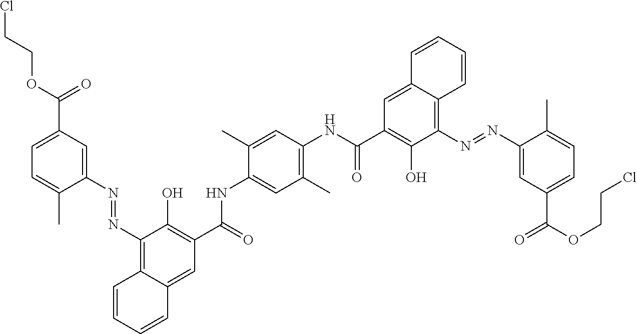 [SMILES: Cc1ccc(C(=O)OCCCl)cc1/N=N/c1c(O)c(C(=O)Nc2cc(C)c(NC(=O)c3cc4ccccc4c(/N=N/c4cc(C(=O)OCCCl)ccc4C)c3O)cc2C)cc2ccccc12] | 926 | Disazo Condensation | PR220 | Cromophtal Red K 3830 |
| 13 | Organic | N,N′-(2-chloro-1,4- phenylene)bis[4-[(2,5- dichlorophenyl)azo]-3- hydroxy-2-naphthalene carbamide] | 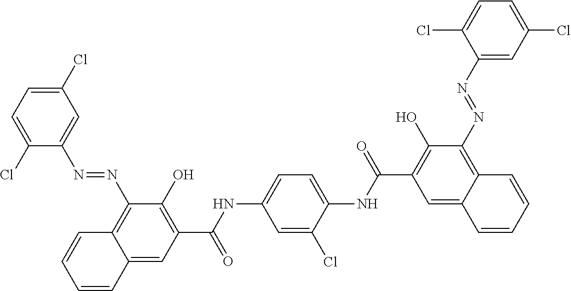 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 829 | Disazo Condensation | PR144 | Cromophtal Red K 3890 |
| 14 | Organic | N,N′-(2-chloro-1,4- phenylene)bis[4-[(2,5- dichlorophenyl azo]-3- hydroxy-2-naphthalene carbamide] | 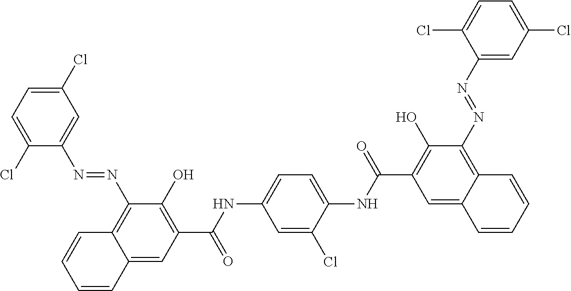 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 829 | Disazo Condensation | PR144 | Cromophtal Red K 3890 FP |
| 15 | Organic | N,N′-(2-chloro-1,4- phenylene)bis[4-[(2,5- dichlorophenyl)azo]-3- hydroxy-2-naphthalene carbamide] | 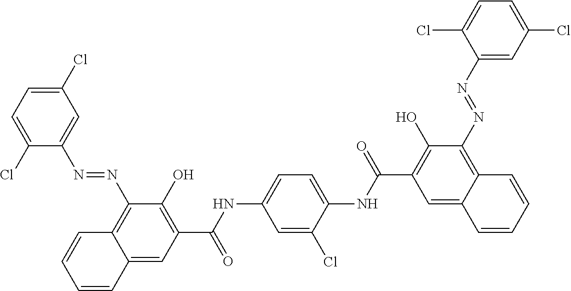 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 863 | Disazo Condensation | PR214 | Cromophtal Red K 3900 |
| 16 | Organic | N,N′-(2-chloro-1,4- phenylene)bis[4-[(2,5- dichlorophenyl)azo]-3- hydroxy-2-naphthalene carbamide] | 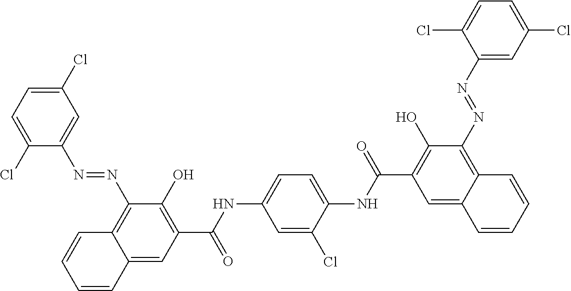 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 864 | Disazo Condensation | PR214 | Cromophtal Red K 3900 FP |
| 17 | Organic | 3,3′-[(2,5-dichloro-1,4- phenylene) bis[iminocarbonyl(2- hydroxy-3,1- naphthalenediyl)azo]]bis(1- methylethyl 4-methyl benzoate) | 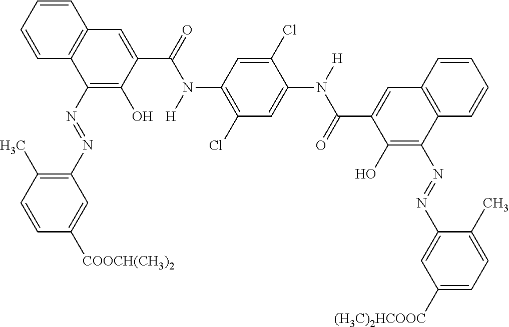 | 926 | Disazo Condensation | PR221 | Cromophtal Red K 4035 |
| 18 | Organic | N,N′-(1,4-phenylene)bis[4- [(2,5-dichlorophenyl)azo]-3- hydroxy-2-naphthalene carbamide] | 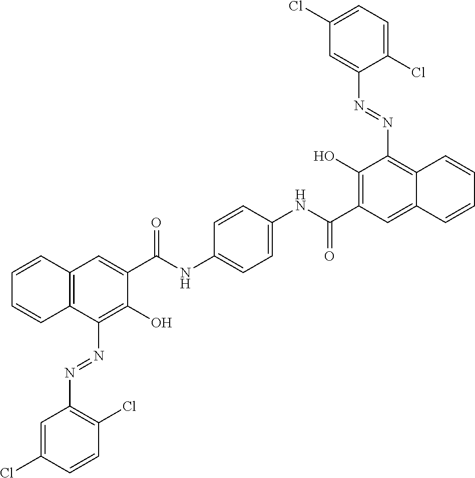 [SMILES: O=C(Nc1ccc(NC(=O)c2cc3ccccc3c(/N=N/c3cc(Cl)ccc3Cl)c2O)cc1)c1cc2ccccc2c(/N=N/c2cc(Cl)ccc2Cl)c1O] | 794 | Disazo Condensation | PR166 | Cromophtal Scarlet K 3540 |
| 19 | Organic | N,N′-(6,13-bis(acetylamino)- 2,9-diethoxy triphenodioxazine-3,10-diyl] bis(benzamide) | 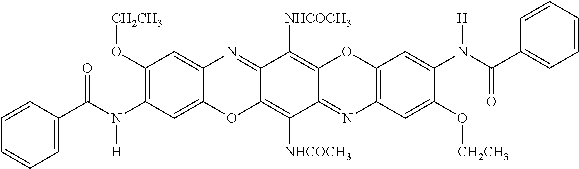 | 727 | Dioxazine | PV37 | Cromophtal Violet K 5700 |
| 20 | Organic | 2,2′-[1,4-phenylene) bis[imino(1-acetyl-2- oxoethane-2,1-diyl)azo] bis(dimethyl terephthalate) | 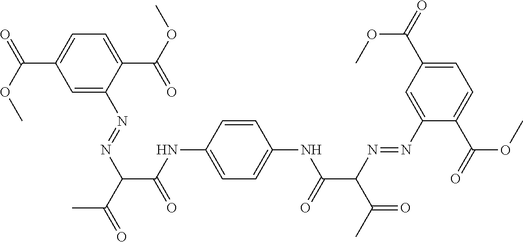 [SMILES: COC(=O)c1ccc(C(=O)OC)c(/N=N/C(C(C)=O)C(=O)Nc2ccc(NC(=O)C(/N=N/c3cc(C(=O)OC)ccc3C(=O)OC)C(C)=O)cc2)c1] | 717 | Disazo | PY155 | Cromophtal Yellow 2GF |
| 21 | Organic | 3,3′-(2-chloro-5-methyl-1,4- phenylene))bis[imino(1- acetyl-2-oxo-2,1-ethanediyl) azo]bis[4-chloro-N-[(2-(4- chlorophenoxy)-5- (trifluoromethyl)phenyl] benzamide] | 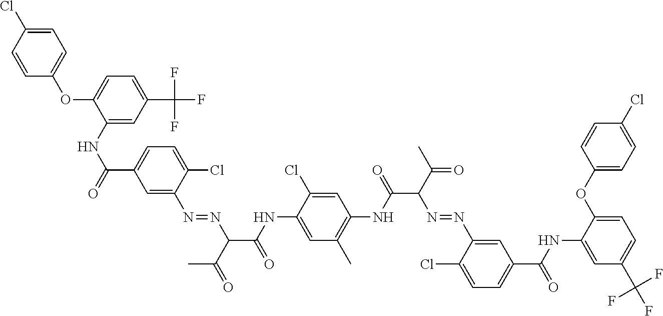 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C] | 1229 | Disazo | PY128 | Cromophtal Yellow K 0990 |
| 22 | Organic | 3,3′-(2-chloro-5-methyl-1,4- phenylene))bis[imino(1- acetyl-2-oxo-2,1-ethanediyl) azo]bis[4-chloro-N-[(2-(4- chlorophenoxy)-5- (trifluoromethyl)phenyl] benzamide] | 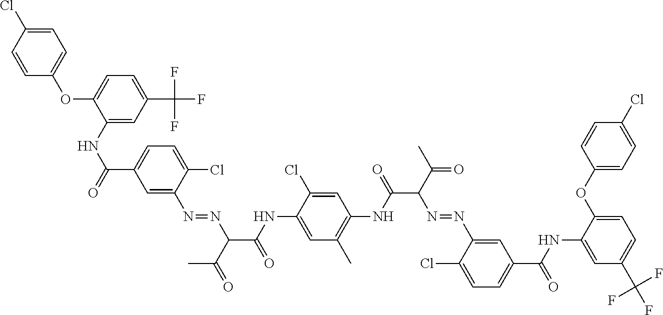 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C] | 1229 | Disazo | PY128 | Cromophtal Yellow K 0990 FP |
| 23 | Organic | 3,3′-(2-chloro-5-methyl-1,4- phenylene))bis(imino)bis(1- acetyl-2-oxo-2,1-ethanediyl) bis(azo)]bis[4-chloro-N-(3- chloro-2-methylphenyl) benzamide] | 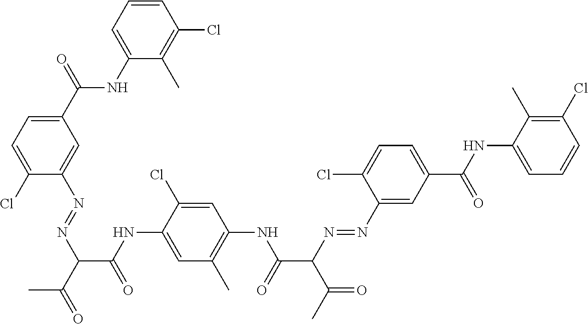 [SMILES: CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C] | 937 | Disazo | PY93 | Cromophtal Yellow K 1210 |
| 24 | Organic | 3,3′-[(2-chloro-5-methyl-1,4- phenylene)bis(imino)bis(1- acetyl-2-oxo-2,1-ethanediyl) bis(azo)]bis[4-chloro-N-[3- chloro-2-methylphenyl] benzamide] | 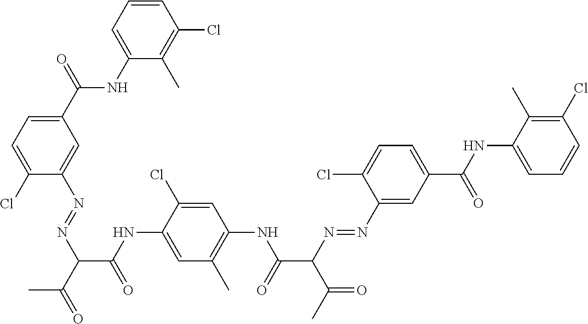 [SMILES: CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C] | 937 | Disazo | PY93 | Cromophtal Yellow K 1210 FP |
| 25 | Organic | Pyrimido[5,4-g]pteridine- 2,4,6,8-tetramine, 4- methylbenzenesulfonate, base-hydrolysed | 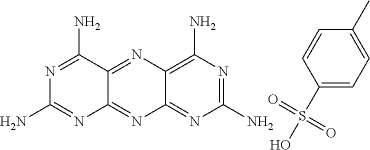 | 416 | Pyrimido Pteridine | PY215 | Cromophtal Yellow K 1310 |
| 26 | Organic | 2,2′-[1.2-ethanediyl bis(oxy- 2,1-phenylene azo)]bis[N- [(2,3dihydro-2-oxo-1H- benzoimidazole)-5-yl]-3- oxobutane amide] | 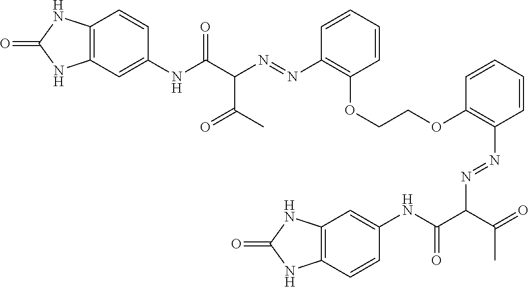 [SMILES: CC(=O)C(/N=N/c1ccccc1OCCOc1ccccc1/N=N/C(C(C)=O)C(=O)Nc1ccc2[nH]c(=O)[nH]c2c1)C(=O)Nc1ccc2[nH]c(=O)[nH]c2c1] | 733 | Disazo | PY180 | Cromophtal Yellow K 1410 |
| 27 | Organic | 3,3′-[(2,5-dimethyl-1,4- phenylene)bis[imino(1- acetyl-2-oxo-2,1-ethanediyl) azo]]bis[4-chloro-N-(5- chloro-2-methylphenyl) benzamide] | 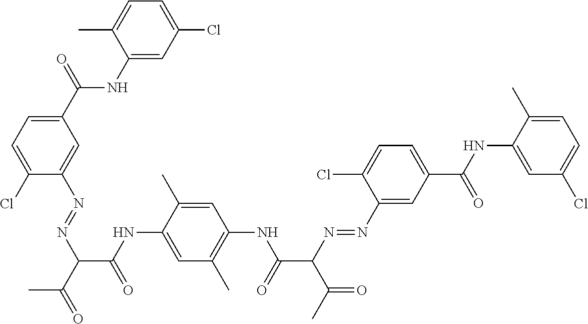 [SMILES: CC(=O)C(/N=N/c1cc(C(=O)Nc2cc(Cl)ccc2C)ccc1Cl)C(=O)Nc1cc(C)c(NC(=O)C(/N=N/c2cc(C(=O)Nc3cc(Cl)ccc3C)ccc2Cl)C(C)=O)cc1C] | 917 | Disazo | PY95 | Cromophtal Yellow K 1500 |
| 28 | Organic | 3,3′-[(2,5-dimethyl-1,4- phenylene)bis[imino(1- acetyl-2-oxo-2,1-ethanediyl) azo]]bis[4-chloro-N-(5- chloro-2-methylphenyl) benzamide] | 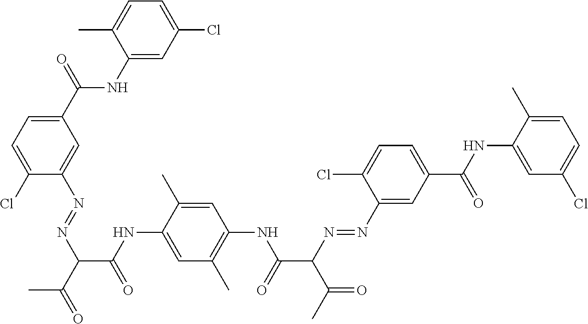 [SMILES: CC(=O)C(/N=N/c1cc(C(=O)Nc2cc(Cl)ccc2C)ccc1Cl)C(=O)Nc1cc(C)c(NC(=O)C(/N=N/c2cc(C(=O)Nc3cc(Cl)ccc3C)ccc2Cl)C(C)=O)cc1C] | 917 | Disazo | PY95 | Cromophtal Yellow K 1500 FP |
| 29 | Organic Metal | Phthalocyanine Copper (α-type) | 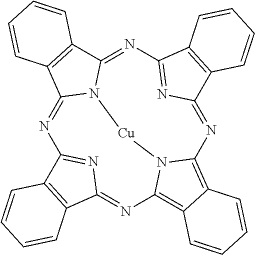 | 576 | Phthalocyanine | PB15:1 | Eupolen PE Blue 69-1501 |
| 30 | Organic Metal | Phthalocyanine Copper (α-type) | 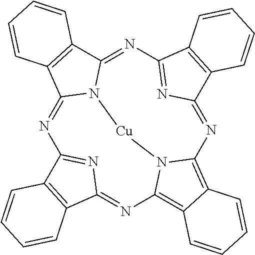 | 576 | Phthalocyanine | PB15:1 | Eupolen PE Blue 69-2001 |
| 31 | Organic Metal | Phthalocyanine Copper (α-type) | 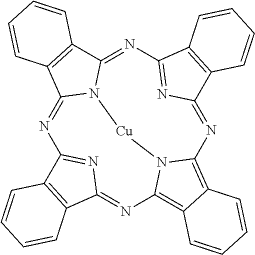 | 576 | Phthalocyanine | PB15:3 | Eupolen PE Blue 70-9001 |
| 32 | Organic Metal | Phthalocyanine Copper (α-type) | 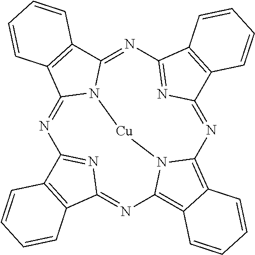 | 576 | Phthalocyanine | PB15:3 | Eupolen PE Blue 70-9005 |
| 33 | Organic Metal | Phthalocyanine Copper (α-type) | 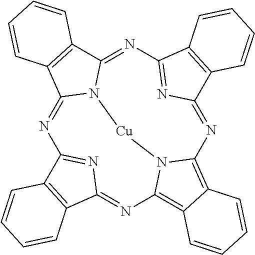 | 576 | Phthalocyanine | PB15:4 | Eupolen PE Blue 71-0401 |
| 34 | Organic Metal | Pigment Green 7 | 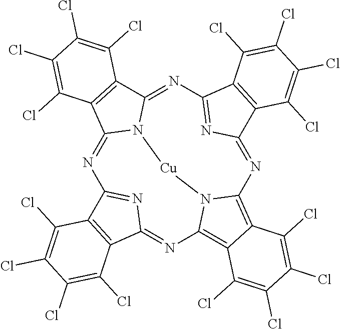 | 1127 | Phthalocyanine | PG7 | Eupolen PE Green 87-3001 |
| 35 | Organic Metal | Pigment Green 7 | 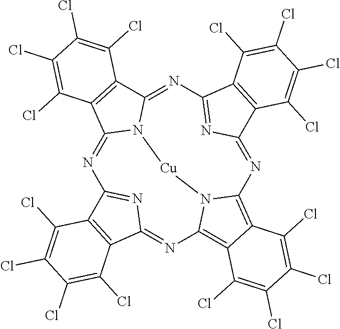 | 1127 | Phthalocyanine | PG7 | Eupolen PE Green 87-3005 |
| 36 | Organic Metal | Pigment Green 7 | 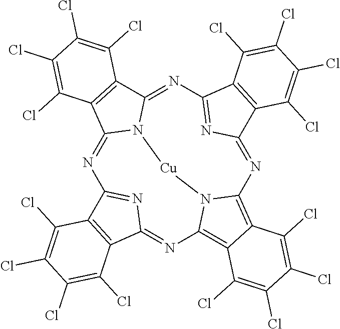 | 1127 | Phthalocyanine | PG7 | Eupolen PE Green 87-3501 |
| 37 | Organic | Copper Compound Pigment Green 36 | 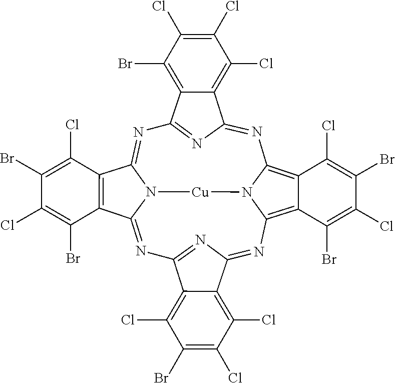 | 1393 | Phthalocyanine | PG36 | Eupolen PE Green 93-6001 |
| 38 | Organic | 2,9-bis[4-(phenylazo)phenyl] anthra[2,1,9-def: 6,5,10- d′e′f′]diisoquinoline- 1,3,8,10-tetraone | 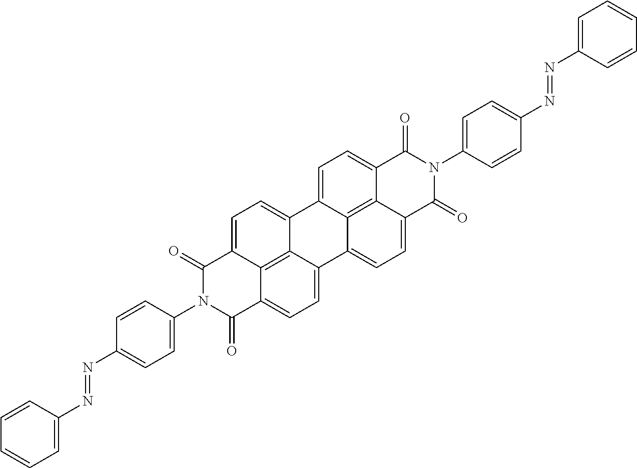 [SMILES: O=C1c2ccc3c4ccc5c6c(ccc(c7ccc(c2c37)C(=O)N1c1ccc(/N=N/c2ccccc2)cc1)c64)C(=O)N(c1ccc(/N=N/c2ccccc2)cc1)C5=O] | 751 | Perylene | PR178 | Eupolen PE Red 39-1101 |
| 39 | Organic | 2,9-dimethylquino[2,3-b] acridine-7,14(5H,12H)- dione | 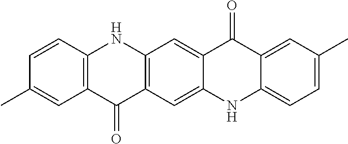 | 340 | Quinophthalone | PR122 | Eupolen PE Red 47-9001 |
| 40 | Organic | 4,5,6,7-tetrachloro-2-[2- [(4,5,6,7-tetrachloro-2,3- dihydro-1,3-dioxo-1H- indene)-2-yl]-8-quinolinyl]- 1H-isoindole-1,3(2H)-dione | 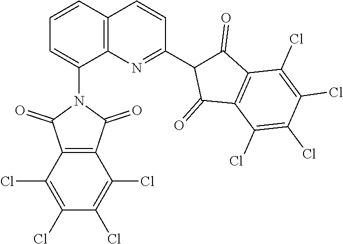 [SMILES: O=C1c2c(Cl)c(Cl)c(Cl)c(Cl)c2C(=O)C1c1ccc2cccc(N3C(=O)c4c(Cl)c(Cl)c(Cl)c(Cl)c4C3=O)c2n1] | 695 | Quinophthalone | PY138 | Eupolen PE Yellow 09-6101 |
| 41 | Organic | Pyrimido[5,4-g]pteridine- 2,4,6,8-tetramine, 4- methylbenzenesulfonate, base-hydrolysed | 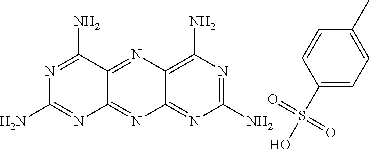 | 416 | Pyrimido Pteridine | PY215 | Eupolen PE Yellow 13-1501 |
| 42 | Organic | — | 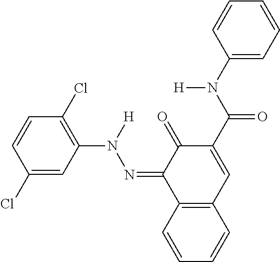 [SMILES: O=C(Nc1ccccc1)C1=Cc2ccccc2/C(=N/Nc2cc(Cl)ccc2Cl)C1=O] | 525 | — | PY191:1 | Eupolen PE Yellow 17-6001 |
| 43 | Organic | — | 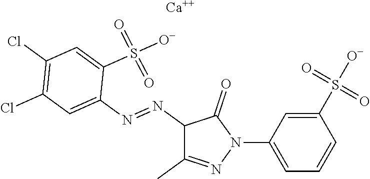 [SMILES: [Ca+2] ; CC1=NN(c2cccc(S(=O)(=O)[O-])c2)C(=O)C1/N=N/c1cc(Cl)c(Cl)cc1S(=O)(=O)[O-]] | 545 | Monoazo | PY183 | Eupolen PE Yellow 18-0001 |
| 44 | Organic | Calcium = 4,5-dichloro-2-[5- hydroxy-3-methyl-1-(3- sulfonatophenyl)-4-pyrazolyl azo]benzene sulfonate | 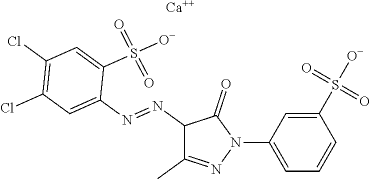 [SMILES: [Ca+2] ; CC1=NN(c2cccc(S(=O)(=O)[O-])c2)C(=O)C1/N=N/c1cc(Cl)c(Cl)cc1S(=O)(=O)[O-]] | 545 | Monoazo | PY183 | Eupolen PE Yellow 18-0004 |
| 45 | Organic | 5,5′-[1,3-dihydro-2H- isoindole-1,3-diylidene] bis[pyrimidine-2,4,6(1H, 3H,5H)-trione] | 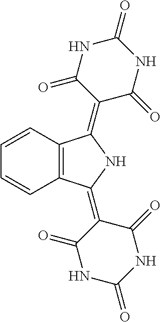 [SMILES: O=C1NC(=O)C(=c2[nH]c(=C3C(=O)NC(=O)NC3=O)c3ccccc23)C(=O)N1] | 367 | Isoindoline | PY139 | Eupolen PE Yellow 18-4101 |
| 46 | Organic | 5,5′-[1,3-dihydro-2H- isoindole-1,3-diylidene] bis[pyrimidine-2,4,6(1H, 3H,5H)-trione] | 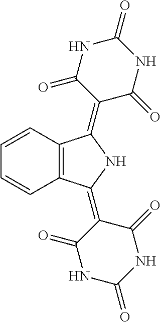 [SMILES: O=C1NC(=O)C(=c2[nH]c(=C3C(=O)NC(=O)NC3=O)c3ccccc23)C(=O)N1] | 367 | Isoindoline | PY139 | Eupolen PE Yellow 18-4105 |
| 47 | Organic | 4,5,6,7-tetrachloro-3-[4-[(1- oxo-4,5,6,7-tetrachloro-2H- isoindole-3-ylidene)amino] phenyl]imino]-2H- isoindole-1(3H)-one | 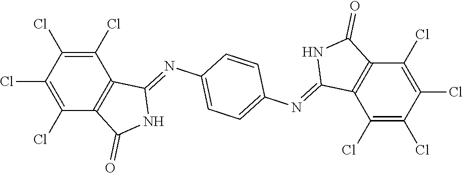 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Eupolen PE Yellow 20-8501 |
| 48 | Organic Metal | Phthalocyanine Copper (α-type) | 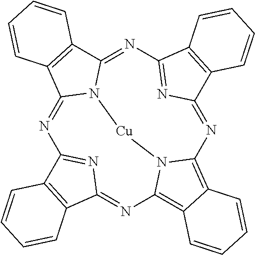 | 576 | Phthalocyanine | PB15 | Heliogen Blue K 6850 |
| 49 | Organic Metal | Phthalocyanine Copper (α-type) | 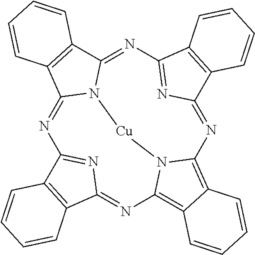 | 576 | Phthalocyanine | PB15 | Heliogen Blue K 6860 |
| 50 | Organic Metal | Phthalocyanine Copper (α-type) | 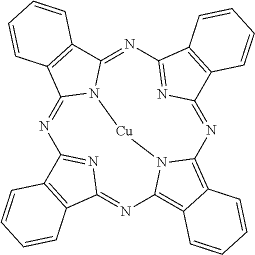 | 576 | Phthalocyanine | PB15:1 | Heliogen Blue K 6902 |
| 51 | Organic Metal | Phthalocyanine Copper (α-type) | 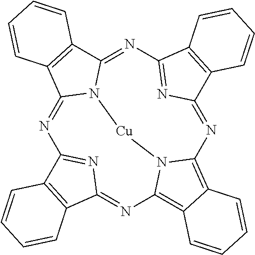 | 576 | Phthalocyanine | PB15:1 | Heliogen Blue K 6907 |
| 52 | Organic Metal | Phthalocyanine Copper (α-type) | 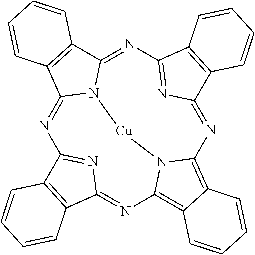 | 576 | Phthalocyanine | PB15:1 | Heliogen Blue K 6911 |
| 53 | Organic Metal | Phthalocyanine Copper (α-type) | 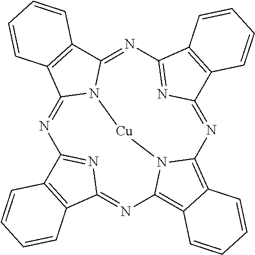 | 576 | Phthalocyanine | PB15:1 | Heliogen Blue K 6912 FP |
| 54 | Organic Metal | Phthalocyanine Copper (α-type) | 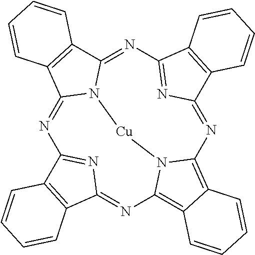 | 576 | Phthalocyanine | PB15:1 | Heliogen Blue K 6916 |
| 55 | Organic Metal | Phthalocyanine Copper (α-type) | 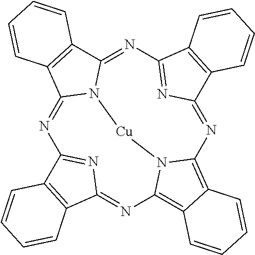 | 576 | Phthalocyanine | PB15:3 | Heliogen Blue K 7090 |
| 56 | Organic Metal | Phthalocyanine Copper (α-type) | 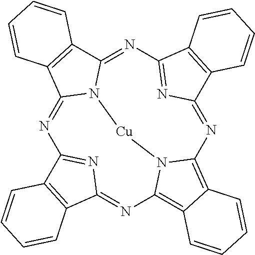 | 576 | Phthalocyanine | PB15:3 | Heliogen Blue K 7090 FP |
| 57 | Organic Metal | Phthalocyanine Copper (α-type) | 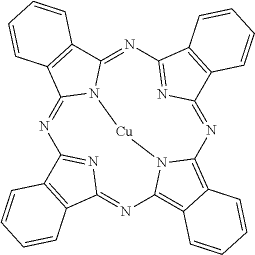 | 576 | Phthalocyanine | PB15:3 | Heliogen Blue K 7097 |
| 58 | Organic Metal | Phthalocyanine Copper (α-type) | 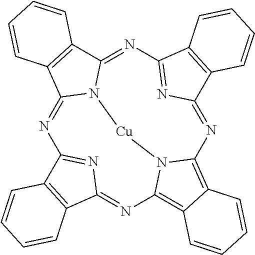 | 576 | Phthalocyanine | PB15:4 | Heliogen Blue K 7104 LW |
| 59 | Organic Metal | Pigement Green 7 | 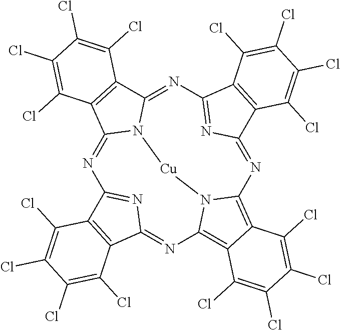 | 1127 | Phthalocyanine | PG7 | Heliogen Green K 8683 |
| 60 | Organic Metal | Pigement Green 7 | 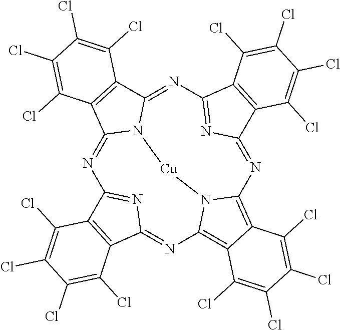 | 1127 | Phthalocyanine | PG7 | Heliogen Green K 8730 |
| 61 | Organic Metal | Pigement Green 7 | 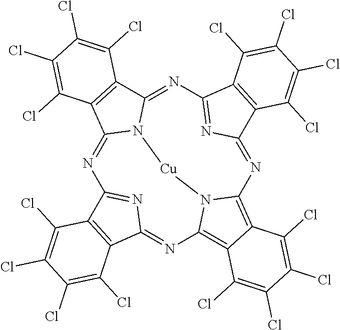 | 1127 | Phthalocyanine | PG7 | Heliogen Green K 8730 FP |
| 62 | Organic Metal | Pigement Green 7 | 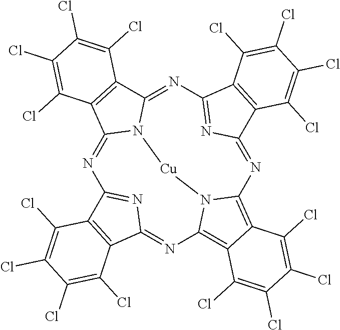 | 1127 | Phthalocyanine | PG7 | Heliogen Green K 8730 Z |
| 63 | Organic Metal | Pigement Green 7 | 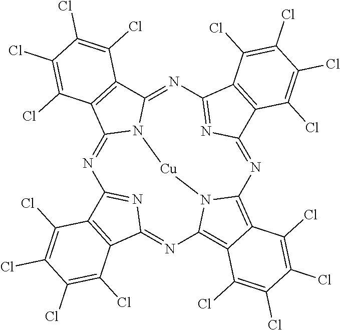 | 1127 | Phthalocyanine | PG7 | Heliogen Green K 8740 |
| 64 | Organic Metal | Copper Compound Pigement Green 36 | 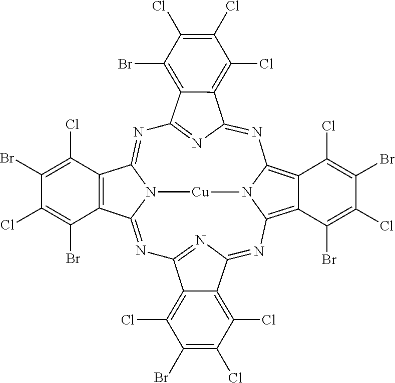 | 1394 | Phthalocyanine | PG36 | Heliogen Green K 9360 FK |
| 65 | Organic | (5-chloro-4-methyl-3- sulfophenyl)azo]-3- hydroxy-2-naphthalene sulfonic acid/strontium (1:1) | 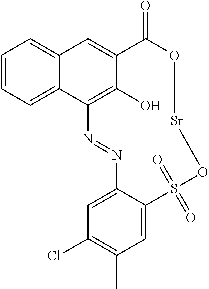 | 506 | Monoazo | PR48:3 | Irgalite Red K 4060 FP |
| 66 | Organic | 4-[(5-chloro-4-methyl-2- sulfophenyl)azo]-3- hydroxy-2-naphthalene carboxylic acid/calcium (1:1) | 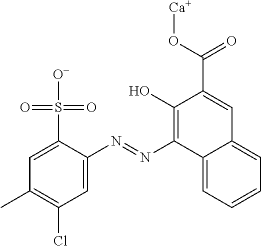 | 459 | Monoazo | PR48:2 | Irgalite Red K 4170 FP |
| 67 | Organic | Pigment Red 57:1 | 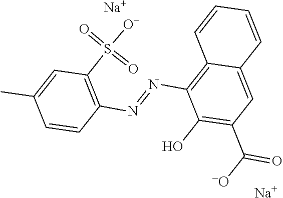 | 430 | Monoazo | PR57:1 | Irgalite Rubine K 4270 FP |
| 68 | Organic | (5-chloro-4-methyl-3- sulfophenyl)azo]-3- hydroxy-2-naphthalene sulfonic acid/strontium (1:1) | 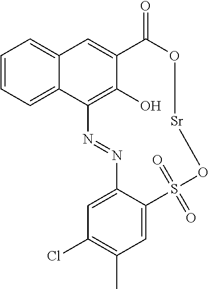 | 506 | Monoazo | PR48:3 | Irgalite Scarlet K 4165 |
| 69 | Organic | 3,6-bis(4-toryl)-2,5- dihydropyrrolo[3,4-c] pyrrole-1,4-dione | 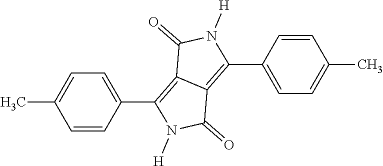 | 316 | Diketo Pyrrolo Pyrrole | PR272 | Irgazin Flame Red 3800 |
| 70 | Organic | 4,5,6,7-tetrachloro-2,3- dihydro-3-[[3-methyl-4-[[4- [(4,5,6,7-tetrachloro-2,3- dihydro-3-oxo-1H-isoindol- 1-ylidene)amino]phenyl] azo]phenyl]imino]-1H- isoindol-1-one | 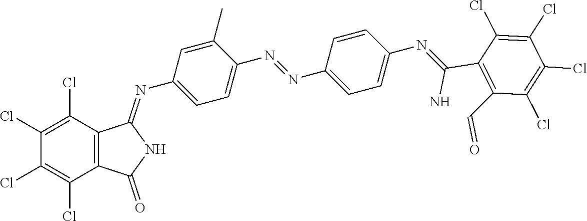 [SMILES: Cc1cc(/N=C2\NC(=O)c3c(Cl)c(Cl)c(Cl)c(Cl)c32)ccc1/N=N/c1ccc(/N=C(\N)c2c(Cl)c(Cl)c(Cl)c(Cl)c2C=O)cc1] | 760 | Isoindoline | P061 | Irgazin Orange K 2890 |
| 71 | Organic | 3,3′-(1,4-dioxopyrrolo[3,4- C]pyrrole 3,6-diyl) dibenzonitrile | 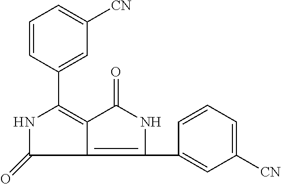 [SMILES: N#Cc1cccc(C2=C3C(=O)NC(c4cccc(C#N)c4)=C3C(=O)N2)c1] | 338 | Diketo Pyrrolo Pyrrole | P071 | Irgazin Orange K 2910 |
| 72 | Organic | Pigment Red 254 3,6-bis(4- chlorophenyl)-2,5- dihydropyrrolo[3,4-c] pyrrole-1,4-dione | 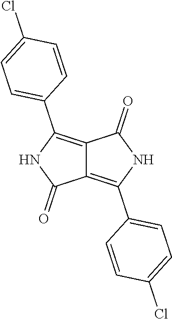 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3810 |
| 73 | Organic | Pigment Red 254 3,6-bis(4- chlorophenyl)-2,5- dihydropyrrolo[3,4-c] pyrrole-1,4-dione | 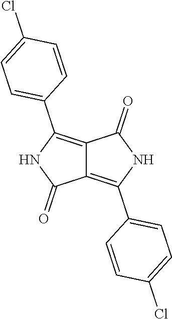 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3840 |
| 74 | Organic | Pigment Red 254 | 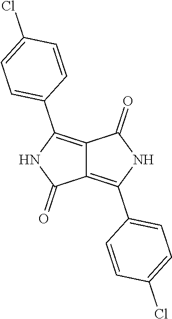 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3840 LW |
| 75 | Organic | Pigment Red 254 | 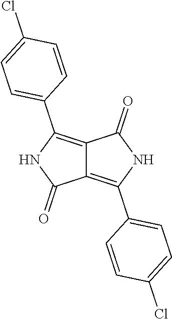 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3840 SQ |
| 76 | Organic | Pigment Red 254 | 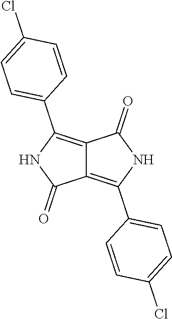 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3842 |
| 77 | Organic | Pigment Red 254 | 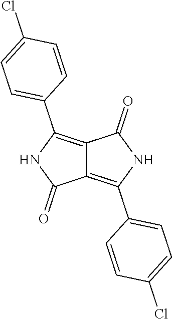 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3845 |
| 78 | Organic | Pigment Red 254 | 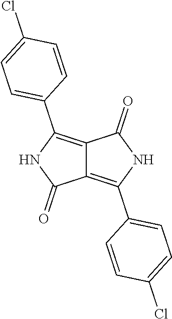 [SMILES: O=C1NC(c2ccc(Cl)cc2)=C2C(=O)NC(c3ccc(Cl)cc3)=C12] | 357 | Diketo Pyrrolo Pyrrole | PR254 | Irgazin Red K 3845 LW |
| 79 | Organic | 3,3′-(1,4-dioxopyrrolo[3,4- C]pyrrole 3,6-diyl) dibenzonitrile | 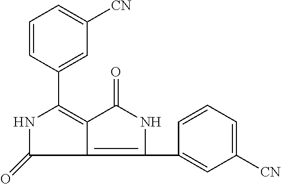 [SMILES: N#Cc1cccc(C2=C3C(=O)NC(c4cccc(C#N)c4)=C3C(=O)N2)c1] | 338 | Diketo Pyrrolo Pyrrole | P071 | Irgazin Rubine K 4080 |
| 80 | Organic | 3,6-di(biphenyl-4-yl)pprrolo [3,4-c]pyrrole-1,4(2H,5H)- dione- | 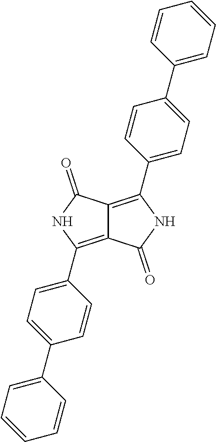 [SMILES: O=C1NC(c2ccc(-c3ccccc3)cc2)=C2C(=O)NC(c3ccc(-c4ccccc4)cc3)=C12] | 440 | Diketo Pyrrolo Pyrrole | PR264 | Irgazin Rubine K 4085 |
| 81 | Organic | 4,5,6,7-tetrachloro-3-[[4-[(1- oxo-4,5,6,7-tetrachloro-2H- isoindole-3-ylidene)amino] phenyl]imino]-2H-isoindole- 1(3H)-one | 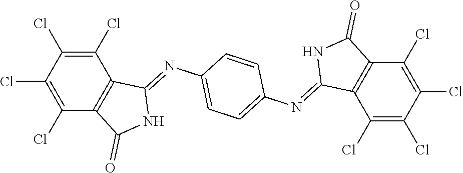 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Irgazin Yellow K 2060 |
| 82 | Organic | 4,5,6,7-tetrachloro-3-[[4-[(1- oxo-4,5,6,7-tetrachloro-2H- isoindole-3-ylidene)amino] phenyl]imino]-2H-isoindole- 1(3H)-one | 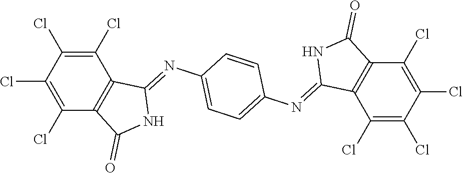 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Irgazin Yellow K 2060 FP |
| 83 | Organic | 4,5,6,7-tetrachloro-3-[[4-[(1- oxo-4,5,6,7-tetrachloro-2H- isoindole-3-ylidene)amino] phenyl]imino]-2H-isoindole- 1(3H)-one | 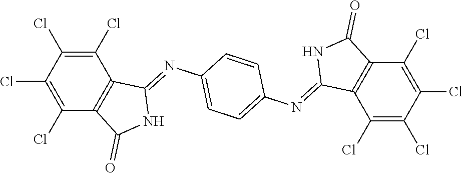 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Irgazin Yellow K 2060 SQ |
| 84 | Organic | 4,5,6,7-tetrachloro-3-[[4-[(1- oxo-4,5,6,7-tetrachloro-2H- isoindole-3-ylidene)amino] phenyl]imino]-2H-isoindole- 1(3H)-one | 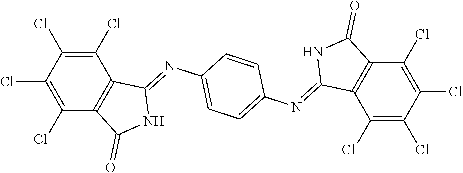 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Irgazin Yellow K 2070 |
| 85 | Organic | 4,5,6,7-tetrachloro-3-[[4-[(1- oxo-4,5,6,7-tetrachloro-2H- isoindole-3-ylidene)amino] phenyl]imino]-2H-isoindole- 1(3H)-one | 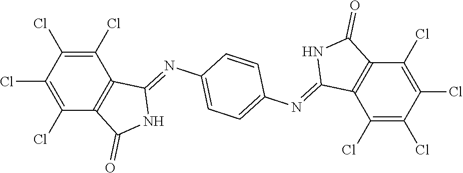 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Irgazin Yellow K 2080 |
| 86 | Organic Metal | Phthalocyanine Copper (α-type) | 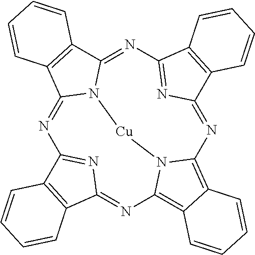 | 576 | Phthalocyanine | PB15:1 | Microlen Blue 6907 MC |
| 87 | Organic Metal | Phthalocyanine Copper (α-type) | 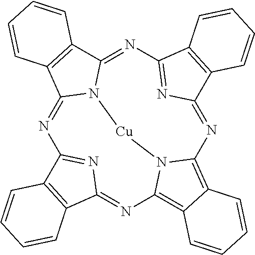 | 576 | Phthalocyanine | PB15:1 | Microlen Blue 6911 MC |
| 88 | Organic Metal | Phthalocyanine Copper (α-type) | 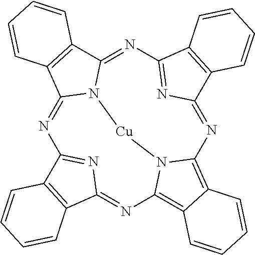 | 576 | Phthalocyanine | PB15:1 | Microlen Blue 6916 MC |
| 89 | Organic Metal | Phthalocyanine Copper (α-type) | 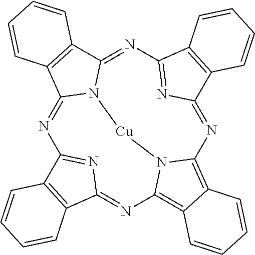 | 576 | Phthalocyanine | PB15:3 | Microlen Blue 7079 MC |
| 90 | Organic Metal | Phthalocyanine Copper (α-type) | 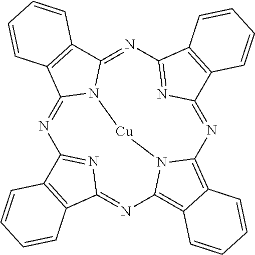 | 576 | Phthalocyanine | PB15:3 | Microlen Blue 7098 MC |
| 91 | Organic | 3,6-bis(4-toryl)-2,5- dihydropyrrolo[3,4-c] pyrrole-1,4-dione | 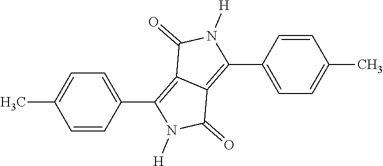 | — | Diketo Pyrrolo Pyrrole | PR272 | Microlen Flame Red 3800 MC |
| 92 | Organic Metal | Pigement Green 7 | 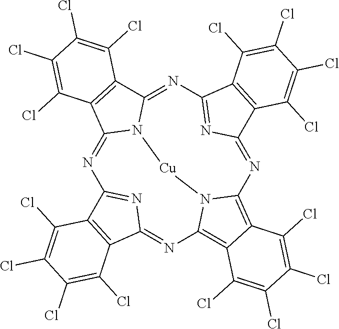 | 1127 | Phthalocyanine | PG7 | Microlen Green 8730 MC |
| 93 | Organic Metal | Pigement Green 7 | 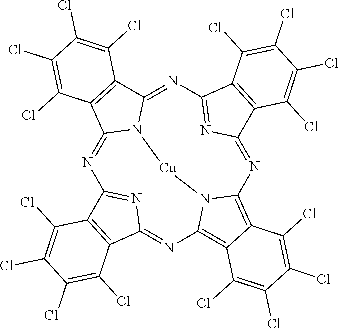 | 1127 | Phthalocyanine | PG7 | Microlen Green 8745 LW MC |
| 94 | Organic | 2,9-dichloroquino[2,3- b]acridine- 7,14(5H,12H)-dione | 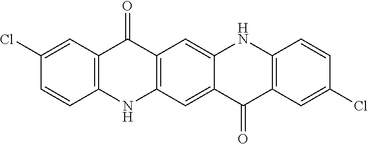 [SMILES: O=c1c2cc(Cl)ccc2[nH]c2cc3c(=O)c4cc(Cl)ccc4[nH]c3cc12] | 381 | Dichloro- quinacridone | PR202 | Microlen Magenta 4535 MC |
| 95 | Organic | 3,3′-(1,4-dioxopyrrolo[3,4-C] pyrrole 3,6-diyl)dibenzonitrile | 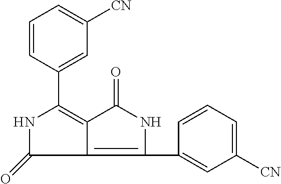 [SMILES: N#Cc1cccc(C2=C3C(=O)NC(c4cccc(C#N)c4)=C3C(=O)N2)c1] | 338 | Diketo Pyrrolo Pyrrole | P071 | Microlen Orange 2910 MC |
| 96 | Organic | Benzimidazolone Orange GP 5- [[(2,3-dihydro-6-methyl-2-oxo- 1H-benzoimidazole)-5-yl]azo]- 2,4,6(1H,3H,5H)- pyrimidine trione | 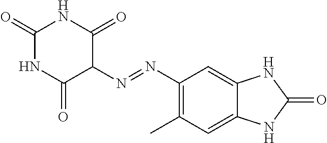 [SMILES: Cc1cc2[nH]c(=O)[nH]c2cc1/N=N/C1C(=O)NC(=O)NC1=O] | 302 | Monoazo | P064 | Microlen Orange 2960 MP |
| 97 | Organic | 2,9-dichloroquino[2,3- b]acridine- 7,14(5H,12H)-dione | 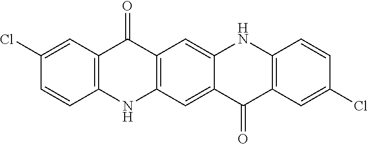 [SMILES: O=c1c2cc(Cl)ccc2[nH]c2cc3c(=O)c4cc(Cl)ccc4[nH]c3cc12] | 340 | Quinacridone | PR122 | Microlen Pink 4430 MC |
| 98 | Organic | Pigment Red 254 | 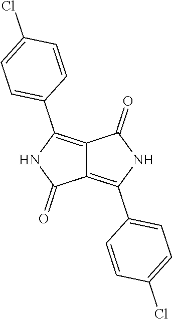 [SMILES: O=C1NC(c2ccc(Cl)cc2)=C2C(=O)NC(c3ccc(Cl)cc3)=C12] | 357 | Diketo Pyrrolo Pyrrole | PR254 | Microlen Red 3840 LW MC |
| 99 | Organic | Pigment Red 254 | 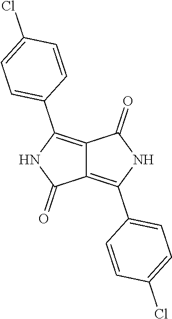 [SMILES: O=C1NC(c2ccc(Cl)cc2)=C2C(=O)NC(c3ccc(Cl)cc3)=C12] | 357 | Diketo Pyrrolo Pyrrole | PR254 | Microlen Red 3840 MC |
| 100 | Organic | Pigment Red 254 | 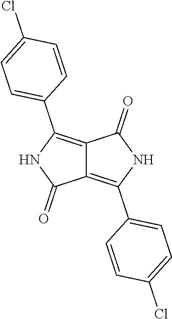 [SMILES: O=C1NC(c2ccc(Cl)cc2)=C2C(=O)NC(c3ccc(Cl)cc3)=C12] | 357 | Diketo Pyrrolo Pyrrole | PR254 | Microlen Red 3845 LW MC |
| 101 | Organic | N,N′-(2-chloro-1,4- phenylene)bis[4-[(2,5- dichlorophenyl)azo]-3- hydroxy-2-naphthalene carbamide] | 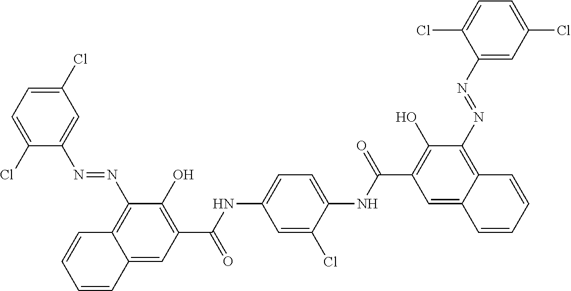 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 829 | Disazo Condensation | PR144 | Microlen Red 3890 MC |
| 102 | Organic | N,N′-(2-chloro-1,4- phenylene)bis[4-[(2,5- dichlorophenyl)azo]-3- hydroxy-2-naphthalene carbamide] | 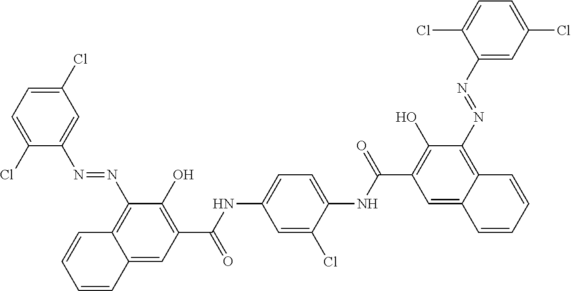 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 829 | Disazo Condensation | PR144 | Microlen Red 3890 MCQ |
| 103 | Organic | (5-chloro-4-methyl-3- sulfophenyl)azo]-3- hydroxy-2-naphthalene sulfonic acid/strontium (1:1) | 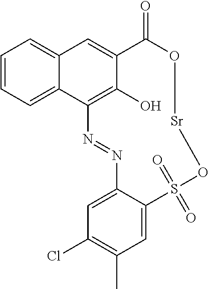 | 506 | Monoazo | PR48:3 | Microlen Red 4060 MC |
| 104 | Organic | Quinacridone | 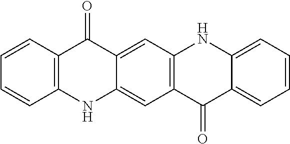 [SMILES: O=c1c2ccccc2[nH]c2cc3c(=O)c4ccccc4[nH]c3cc12] | 312 | Quinacridone | PV19 | Microlen Red 4104 MC |
| 105 | Organic | 4-[(5-chloro-4-methyl-2- sulfophenyl)azo]- 3-hydroxy-2-naphthalene carboxylic acid/calcium (1:1) | 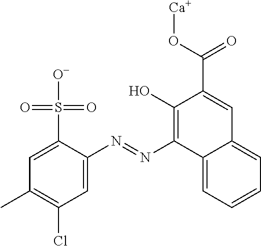 | 459 | Monoazo | PR48:2 | Microlen Red 4170 MC |
| 106 | Organic | 2,9-dimethylquino[2,3- b]acridine- 7,14(5H,12H)-dione | 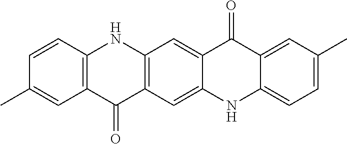 | 340 | Dichloro- quinacridone | PR202 | Microlen Red 4330 MC |
| 107 | Organic | 2′-(alkyl(C = 12 to 18)imino) diethanol | 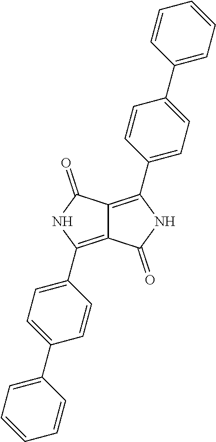 [SMILES: O=C1NC(c2ccc(-c3ccccc3)cc2)=C2C(=O)NC(c3ccc(-c4ccccc4)cc3)=C12] | 440 | Diketo Pyrrolo Pyrrole | PR264 | Microlen Rubine 4085 MC |
| 108 | Organic | Pigment Red 57:1 | 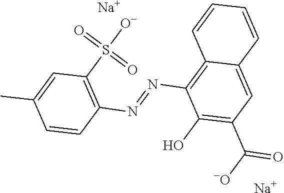 | 430 | Monoazo | PR57:1 | Microlen Rubine 4270 MC |
| 109 | Organic | — | 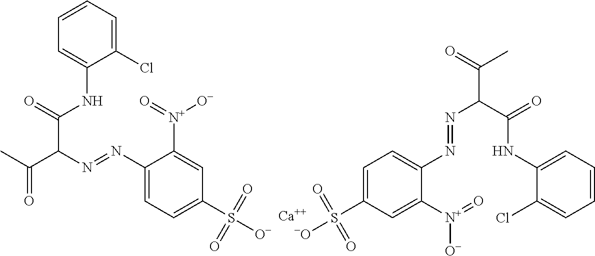 | 920 | Monoazo | PR168 | Microlen Yellow 1070 MC |
| 110 | Organic | 3,3′-[(2-chloro-5-methyl-1,4- phenylene)bis(imino)bis(1- acetyl-2-oxo-2,1-ethanediyl) bis(azo)]bis[4-chloro-N-[3- chloro-2-methylphenyl] benzamide] | 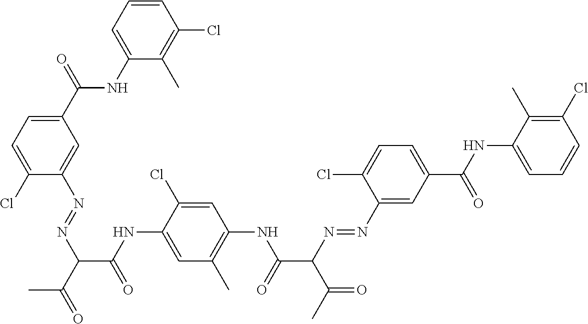 [SMILES: CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C] | 937 | Disazo | PY93 | Microlen Yellow 1210 MC |
| 111 | Organic | 3,3′-[(2-chloro-5-methyl-1,4- phenylene)bis(imino)bis(1- acetyl-2-oxo-2,1-ethanediyl) bis(azo)]bis[4-chloro-N-[3- chloro-2-methylphenyl] benzamide] | 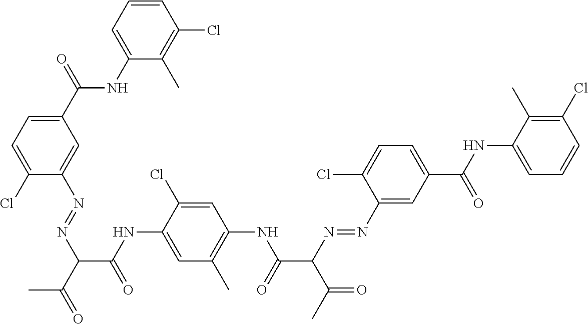 [SMILES: CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C] | 937 | Disazo | PY93 | Microlen Yellow 1210 MCQ |
| 112 | Organic | 2,2′-[1.2-ethanediyl bis(oxy- 2,1-phenylene azo)]bis[N- [(2,3dihydro-2-oxo-1H- benzoimidazole)-5-yl]-3- oxobutane amide] | 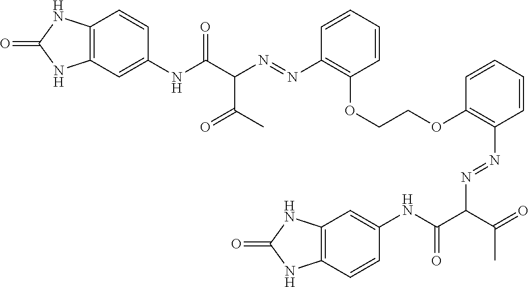 [SMILES: CC(=O)C(/N=N/c1ccccc1OCCOc1ccccc1/N=N/C(C(C)=O)C(=O)Nc1ccc2[nH]c(=O)[nH]c2c1)C(=O)Nc1ccc2[nH]c(=O)[nH]c2c1] | 733 | Disazo | PY180 | Microlen Yellow 1410 MC |
| 113 | Organic | 3,3′-[(2,5-dimethyl-1,4- phenylene)bis[imino(1- acetyl-2-oxo-2,1-ethanediyl) azo]]bis[4-chloro-N-(5- chloro-2-methylphenyl) benzamide] | 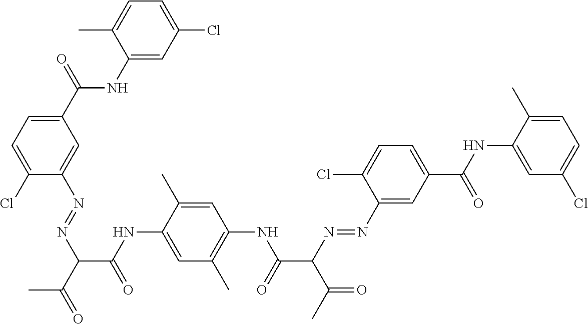 [SMILES: CC(=O)C(/N=N/c1cc(C(=O)Nc2cc(Cl)ccc2C)ccc1Cl)C(=O)Nc1cc(C)c(NC(=O)C(/N=N/c2cc(C(=O)Nc3cc(Cl)ccc3C)ccc2Cl)C(C)=O)cc1C] | 917 | Disazo | PY95 | Microlen Yellow 1500 MC |
| 114 | Organic | 4,5,6,7-tetrachloro-3-[4-[(1- oxo-4,5,6,7-tetrachloro-2H- isoindole-3-ylidene)amino] phenyl]imino]-2H- isoindole-1(3H)-one | 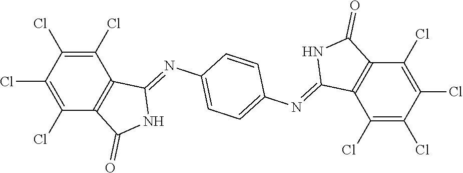 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Microlen Yellow 2070 MC |
| 115 | Organic | 4,5,6,7-tetrachloro-3-[4-[(1- oxo-4,5,6,7-tetrachloro-2H- isoindole-3-ylidene)amino] phenyl]imino]-2H- isoindole-1(3H)-one | 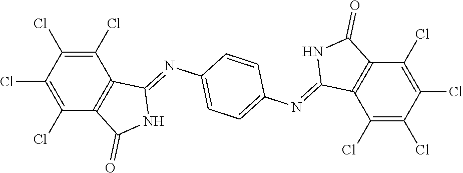 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Microlen Yellow 2070 MCQ |
| 116 | Organic Metal | Phthalocyanine Copper (α-type) | 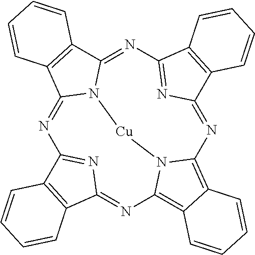 | 576 | Phthalocyanine | PB15:3 | Microlith Blue 7080 KP |
| 117 | Organic | N,N′-(2-chloro-1,4- phenylene)bis[4-[(4-chloro- 2-nitrophenyl)azo]-3- hydroxy-2-naphthalene carbamide] | 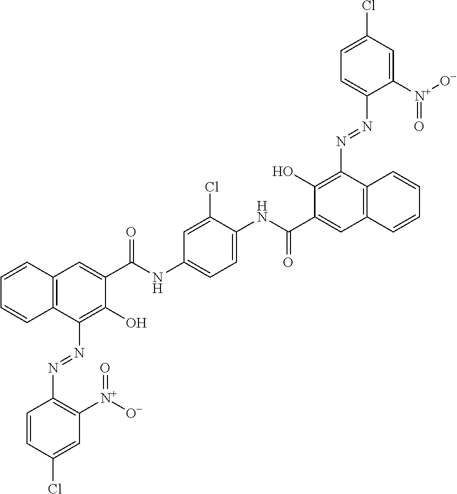 [SMILES: O=C(Nc1ccc(NC(=O)c2cc3ccccc3c(/N=N/c3ccc(Cl)cc3[N+](=O)[O-])c2O)c(Cl)c1)c1cc2ccccc2c(/N=N/c2ccc(Cl)cc2[N+](=O)[O-])c1O] | 850 | Disazo Condensation | PBr23 | Microlith Brown 3001 KP |
| 118 | Organic | Pigment Red 254 | 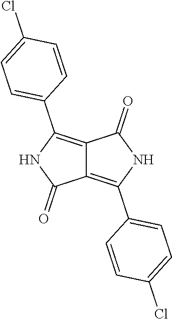 [SMILES: O=C1NC(c2ccc(Cl)cc2)=C2C(=O)NC(c3ccc(Cl)cc3)=C12] | 357 | Diketo Pyrrolo Pyrrole | PR254 | Microlith Red 3840 KP |
| 119 | Organic | N,N′-(2-chloro-1,4- phenylene)bis[4-[(2,5- dichlorophenyl)azo]-3- hydroxy-2-naphthalene carbamide] | 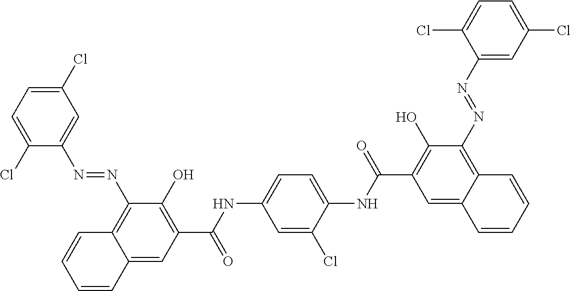 [SMILES: O=C(Nc1ccc(NC(=O)c2cc3ccccc3c(/N=N/c3cc(Cl)ccc3Cl)c2O)c(Cl)c1)c1cc2ccccc2c(/N=N/c2cc(Cl)ccc2Cl)c1O] | 829 | Disazo Condensation | PR144 | Microlith Red 3890 KP |
| 120 | Organic | N,N′-(1,4-phenylene)bis[4- [(2,5-dichlorophenyl)azo]-3- hydroxy-2-naphthalene carbamide] | 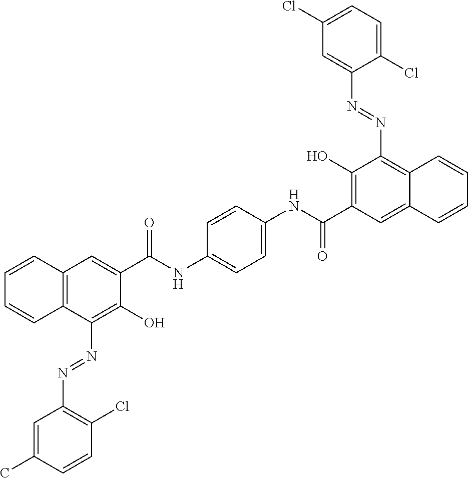 [SMILES: Cc1ccc(Cl)c(/N=N/c2c(O)c(C(=O)Nc3ccc(NC(=O)c4cc5ccccc5c(/N=N/c5cc(Cl)ccc5Cl)c4O)cc3)cc3ccccc23)c1] | 794 | Disazo Condensation | PR166 | Microlith Scarlet 3540 KP |
| 121 | Organic | 3,3′-[(2-chloro-5-methyl-1,4- phenylene)bis(imino)bis(1- acetyl-2-oxo-2,1-ethanediyl) bis(azo)]bis[4-chloro-N-[3- chloro-2-methylphenyl] benzamide] | 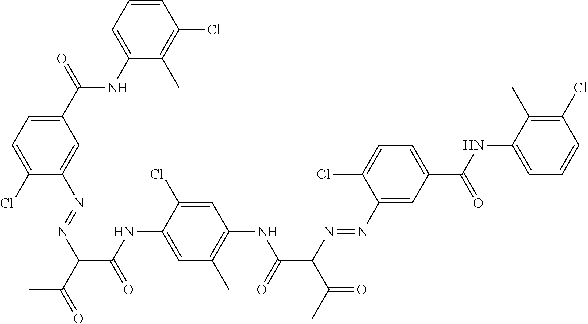 [SMILES: CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C] | 937 | Disazo | PY93 | Microlith Yellow 1210 KP |
| 122 | Organic | 4,5,6,7-tetrachloro-3-[4-[(1- oxo-4,5,6,7-tetrachloro-2H- isoindole-3-ylidene)amino] phenyl]imino]-2H- isoindole-1(3H)-one | 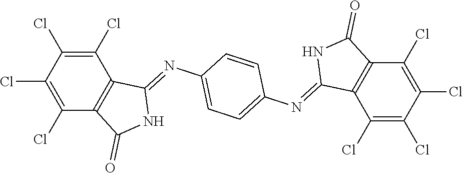 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21] | 642 | Isoindolinone | PY110 | Microlith Yellow 2060 KP |
| 123 | Organic | 1,4-bis(mesitylamino) anthraquinone | 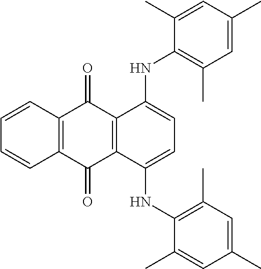 [SMILES: Cc1cc(C)c(Nc2ccc(Nc3c(C)cc(C)cc3C)c3c2C(=O)c2ccccc2C3=O)c(C)c1] | 475 | Aminoanthra- quinone | SB104 | Oracet Blue 690 |
| 124 | Organic | Basic Red 2 | 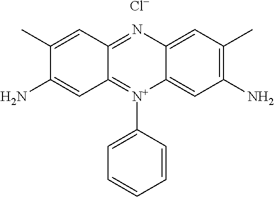 [SMILES: [Cl-] ; Cc1cc2nc3cc(C)c(N)cc3[n+](-c3ccccc3)c2cc1N] | 351 | — | S0116 | Oracet Orange 690 |
| 125 | Organic | 12H-phthaloperin- 12-one | 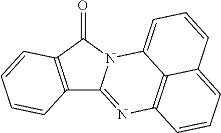 [SMILES: O=C1c2ccccc2C2=Nc3cccc4cccc(c34)N12] | 270 | Phthaloperin | S060 | Oracet Orange 230 |
| 126 | Organic | 8,9,10,11-tetrachloro- 12H-phthaloperin- 12-one | 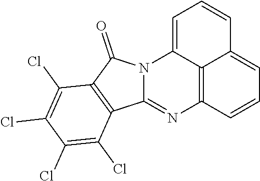 [SMILES: O=C1c2c(Cl)c(Cl)c(Cl)c(Cl)c2C2=Nc3cccc4cccc(c34)N12] | 408 | Phthaloperin | SR135 | Oracet Red 344 |
| 127 | Organic | 1,1′-[(6-phenyl-1,3,5- triazine-2,4-diyl)bis(imino)] bis(9,10-anthracenedione) | 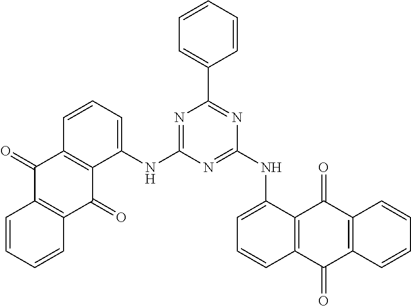 [SMILES: O=C1c2ccccc2C(=O)c2c(Nc3nc(Nc4cccc5c4C(=O)c4ccccc4C5=O)nc(-c4ccccc4)n3)cccc21] | 600 | Anthraquinone | PY147 | Oracet Yellow 140 |
| 128 | Organic | 1,1′-[(6-phenyl-1,3,5- triazine-2,4-diyl)bis(imino)] bis(9,10-anthracenedione) | 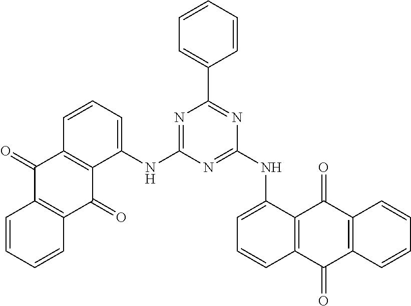 [SMILES: O=C1c2ccccc2C(=O)c2c(Nc3nc(Nc4cccc5c4C(=O)c4ccccc4C5=O)nc(-c4ccccc4)n3)cccc21] | 600 | Anthraquinone | PY147 | Oracet Yellow 144 FE |
| 129 | Organic | 2,9-bis[4-(phenylazo)phenyl] anthra[2,1,9-def: 6,5,10- d′e′f′]diisoquinoline- 1,3,8,10-tetraone | 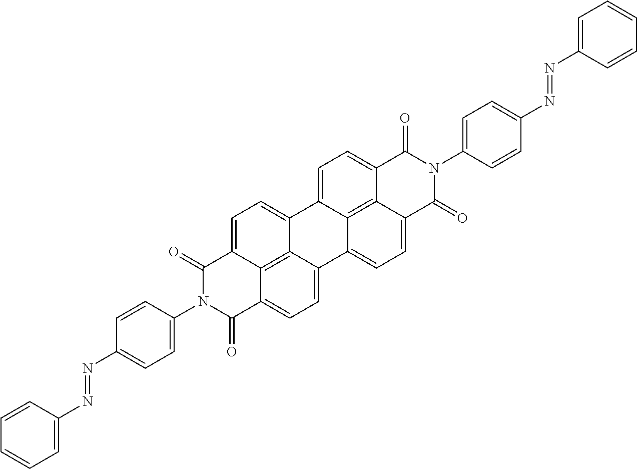 [SMILES: O=C1c2ccc3c4ccc5c6c(ccc(c7ccc(c2c37)C(=O)N1c1ccc(/N=N/c2ccccc2)cc1)c64)C(=O)N(c1ccc(/N=N/c2ccccc2)cc1)C5=O] | 751 | Perylene | PR178 | Paliogen Red K 3911 |
| 130 | Organic | 2,9-dimethylanthra[2,1,9- def: 6,5,10-d′e′f′] diisoquinoline-1(2H), 3,8 (9H), 10-tetraone | 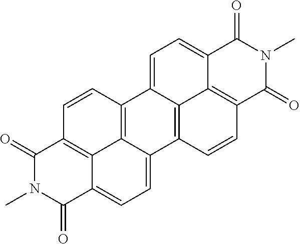 [SMILES: CN1C(=O)c2ccc3c4ccc5c6c(ccc(c7ccc(c2c37)C1=O)c64)C(=O)N(C)C5=O] | 418 | Perylene | PR179 | Paliogen Red K 4180 |
| 131 | Organic | — | 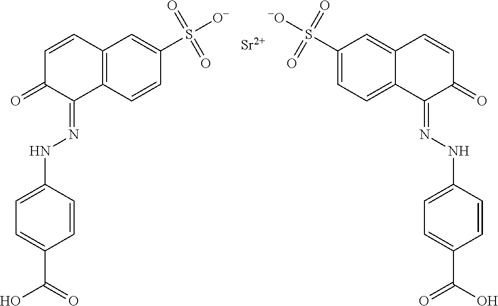 | 830 | Monoazo | P079 | Paliotol Orange K 2920 |
| 132 | Organic | 4,5,6,7-tetrachloro-2-[2- [(4,5,6,7-tetrachloro-2,3- dihydro-1,3-dioxo-1H- indene)-2-yl]-8-quinolinyl]- 1H-isoindole-1,3(2H)-dione | 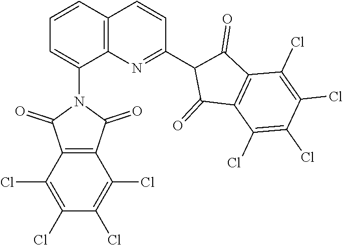 [SMILES: O=C1c2c(Cl)c(Cl)c(Cl)c(Cl)c2C(=O)C1c1ccc2cccc(N3C(=O)c4c(Cl)c(Cl)c(Cl)c(Cl)c4C3=O)c2n1] | 695 | Quinophthalone | PY138 | Paliotol Yellow K 0961 |
| 133 | Organic | — | 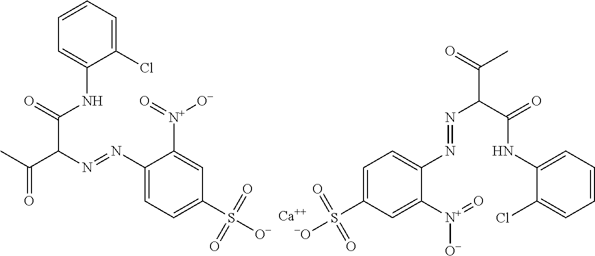 | 920 | Disazo | PY168 | Paliotol Yellow K 1070 |
| 134 | Organic | 4-[2-(5-chloro-4-methyl-2- sulfonatophenyl) hydrazono]-1-(3- sulfonatophenyl)-3-methyl- 2-pyrazoline-5-one and 2 ammonium | 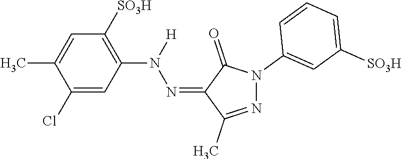 [SMILES: CC1=NN(c2cccc(S(=O)(=O)O)c2)C(=O)/C1=N\Nc1cc(Cl)c(C)cc1S(=O)(=O)O] | 521 | Monoazo | PY191:1 | Paliotol Yellow K 1760 FP |
| 135 | Organic | — | 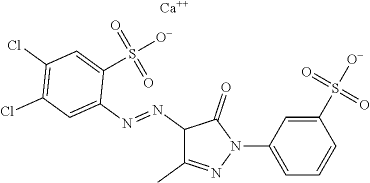 [SMILES: [Ca+2] ; CC1=NN(c2cccc(S(=O)(=O)[O-])c2)C(=O)C1/N=N/c1cc(Cl)c(Cl)cc1S(=O)(=O)[O-]] | 545 | Monoazo | PY183 | Paliotol Yellow K 1800 |
| 136 | Organic | 5,5′-[1,3-dihydro-2H- isoindole-1,3-diylidene] bis[pyrimidine- 2,4,6(1H,3H,5H)-trione] | 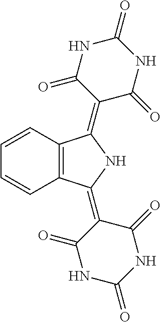 [SMILES: O=C1NC(=O)C(=c2[nH]c(=C3C(=O)NC(=O)NC3=O)c3ccccc23)C(=O)N1] | 367 | Isoindoline | PY139 | Paliotol Yellow K 1841 |
| 137 | Organic | 5,5′-[1,3-dihydro-2H- isoindole-1,3-diylidene] bis[pyrimidine- 2,4,6(1H,3H,5H)-trione] | 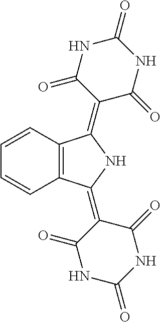 [SMILES: O=C1NC(=O)C(=c2[nH]c(=C3C(=O)NC(=O)NC3=O)c3ccccc23)C(=O)N1] | 367 | Isoindoline | PY139 | Paliotol Yellow K 1841 FP |
| 138 | Organic | 2-(sodio oxysulfonyl) ditridecyl succinate | 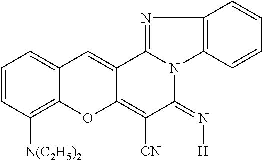 | 397 | — | PR277 | Rightfit Red K 4350 |
| 139 | Organic | 2-(2H-benzotriazole-2-yl)- 4,6-bis(1-methyl-1- phenylethyl)phenol | 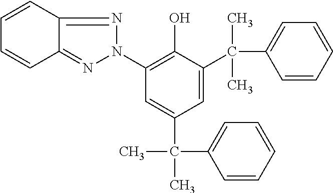 [SMILES: CC(C)(c1ccccc1)c1cc(-n2nc3ccccc3n2)c(O)c(C(C)(C)c2ccccc2)c1] | 448 | — | — | — |

In view of the surface glossiness of the resin molded body, the organic compound in the particles (C) preferably has a molecular weight of 300 or more and 1,500 or less, more preferably 300 or more and 1,200 or less, and still more preferably 300 or more and 1,000 or less.

In view of the surface glossiness of the resin molded body, the particles (C) preferably have a volume average diameter of 10 nm or more and 1,000 nm or less, more preferably 30 nm or more and 800 nm or less, and still more preferably 50 nm or more and 600 nm or less.

The volume average diameter of the particles refers to a value measured by the following method.

The volume average particle diameter is measured using a laser diffraction particle size distribution measurement apparatus (LS13 320: manufactured by Beckman Coulter Inc.). As a measurement method, the organic compound particles (C) is adjusted by ion exchange water so as to be a 1 mass % of dispersion solution in solid content, and is charged into a cell to an appropriate concentration (display density value 40 to 45), and the volume average particle diameter is measured at a stable concentration in the cell after waiting for 10 seconds. A measured particle size cumulative distribution is drawn from a small diameter side regarding the volume with respect to a divided particle size range (channel), and a particle diameter at which accumulation becomes 50% is defined as the volume average particle diameter.

### [Plasticizer (D): Component (D)]

Examples of the plasticizer (D) include a cardanol compound, an ester compound other than an ester compound (H) described later, camphor, a metal soap, a polyol, and a polyalkylene oxide. The plasticizer (D) is preferably a cardanol compound or an ester compound other than the ester compound (H) described later in view of the surface glossiness of the resin molded body.

The plasticizer (D) may be used alone or in combination of two or more thereof.

The plasticizer (D) is preferably an ester compound other than the cardanol compound or the ester compound (H) from a viewpoint that an effect of improving toughness by adding the ester compound (H) is easily obtained. The cardanol compound and the ester compound which are suitable as the plasticizer (D) are described specifically below.

### —Cardanol Compound—

The cardanol compound refers to a component (for example, a compound represented by the following structural formulas (c-1) to (c-4)) contained in a naturally derived compound which uses cashews as raw materials, or a derivative from the above component.

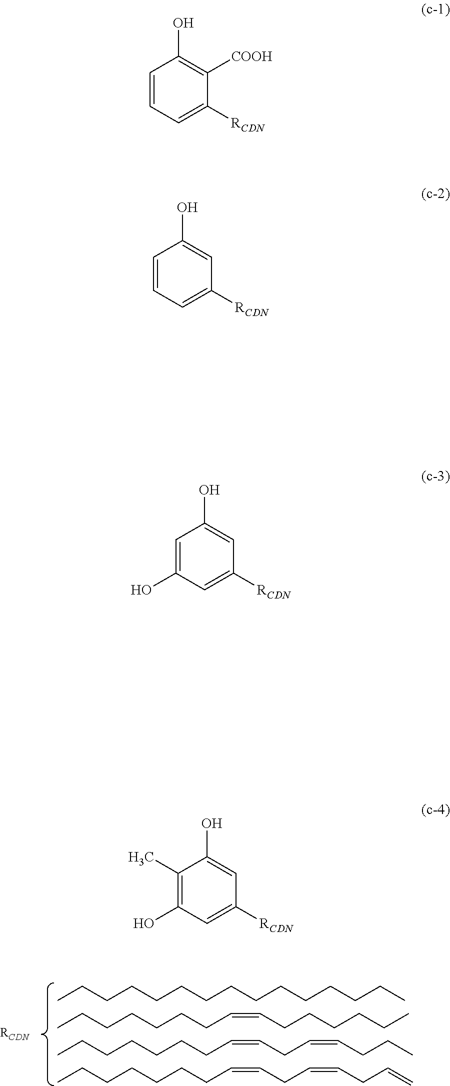

The cardanol compound may be used alone or in combination of two or more thereof.

The resin composition according to the exemplary embodiment may contain a mixture (also referred to as “cashew-derived mixture” below) of the naturally derived compound which uses cashews as raw materials as the cardanol compound.

The resin composition according to the exemplary embodiment may contain a derivative from the cashew-derived mixture as the cardanol compound. Examples of the derivative from the cashew-derived mixture include the following mixtures, monomers, or the like.
A mixture obtained by adjusting a composition ratio of components in a cashew-derived mixture
A monomer obtained by isolating only a specific component from a cashew-derived mixture
A mixture containing a modified product obtained by modifying components in a cashew-derived mixture
A mixture containing a polymer obtained by polymerizing components in a cashew-derived mixture
A mixture containing a modified polymer obtained by modifying and polymerizing components in a cashew-derived mixture
A mixture containing a modified product obtained by further modifying components in a mixture obtained by adjusting the composition ratio
A mixture containing a polymer obtained by further polymerizing components in a mixture obtained by adjusting the composition ratio
A mixture containing a modified polymer obtained by further modifying and polymerizing components in a mixture obtained by adjusting the composition ratio
A modified product obtained by further modifying the isolated monomer
A polymer obtained by further polymerizing the isolated monomer
A modified polymer obtained by further modifying and polymerizing the isolated monomer

Here, the monomer includes a multimer such as a dimer and a trimer.

The cardanol compound is preferably at least one compound selected from the group consisting of a compound represented by a general formula (CDN1) and a polymer obtained by polymerizing the compound represented by the general formula (CDN1) in view of the surface glossiness of the resin molded body.

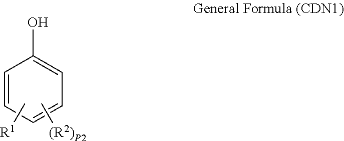

In the general formula (CDN1), R¹ represents an alkyl group which may have a substituent, or an unsaturated aliphatic group which has a double bond and may have a substituent. R² represents a hydroxy group, a carboxy group, an alkyl group which may have a substituent, or an unsaturated aliphatic group which has a double bond and may have a substituent. P2 represents an integer of 0 or more and 4 or less. In a case where P2 is 2 or more, a plurality of R² may be the same group or different groups.

In the general formula (CDN1), the alkyl group represented by R¹ which may have a substituent is preferably an alkyl group having 3 to 30 carbon atoms, more preferably an alkyl group having 5 to 25 carbon atoms, and still more preferably an alkyl group having 8 to 20 carbon atoms.

Examples of the substituent include a hydroxy group; a substituent containing an ether bond of an epoxy group, a methoxy group, and the like; and a substituent containing an ester bond of an acetyl group, a propionyl group, and the like.

Examples of the alkyl group which may have a substituent include a pentadecane-1-yl group, a heptane-1-yl group, an octane-1-yl group, a nonane-1-yl group, a decane-1-yl group, an undecane-1-yl group, a dodecane-1-yl group, and a tetradecane-1-yl group.

In the general formula (CDN1), the unsaturated aliphatic group represented by the R¹, which has a double bond and may have a substituent, is preferably a unsaturated aliphatic group having 3 to 30 carbon atoms, more preferably a unsaturated aliphatic group having 5 to 25 carbon atoms, and still more preferably a unsaturated aliphatic group having 8 to 20 carbon atoms.

The number of the double bond contained in the unsaturated aliphatic group is preferably 1 or more and 3 or less.

Examples of the substituent of the unsaturated aliphatic group are the same as examples of the substituent of the alkyl group.

Examples of the unsaturated aliphatic group, which has a double bond and may have a substituent, include a pentadeca-8-ene-1-yl group, a pentadeca-8,11-diene-1-yl group, a pentadeca-8,11,14-triene-1-yl group, a pentadeca-7-ene-1-yl group, a pentadeca-7,10-diene-1-yl group, and a pentadeca-7,10,14-triene-1-yl group.

In the general formula (CDN1), R¹ is preferably a pentadeca-8-ene-1-yl group, a pentadeca-8,11-diene-1-yl group, a pentadeca-8,11,14-triene-1-yl group, a pentadeca-7-ene-1-yl group, a pentadeca-7,10-diene-1-yl group, or a pentadeca-7,10,14-triene-1-yl group.

In the general formula (CDN1), preferable examples of the alkyl group which may have a substituent and the unsaturated aliphatic group which has a double bond and may have a substituent, which are represented by R², are the same as preferable examples of the alkyl group which may have a substituent and the unsaturated aliphatic group which has a double bond and may have a substituent, which are represented by R¹.

The compound represented by the general formula (CDN1) may be further modified. For example, the compound represented by the general formula (CDN1) may be epoxidized, specifically, may be a compound having a structure in which a hydroxy group of the compound represented by the general formula (CDN1) is replaced with the following group (EP), that is, a compound represented by the following general formula (CDN1-e).

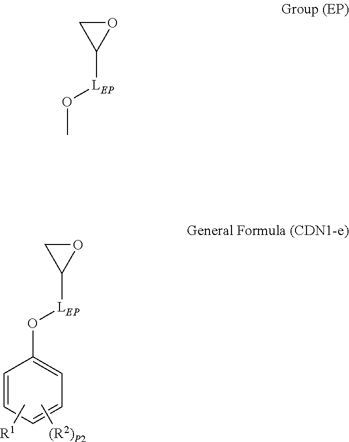

In the group (EP) and the general formula (CDN1-e), L_{EP} represents a single bond or divalent linking group. R¹, R² and P2 in the general formula (CDN1-e) have the same meanings as R¹, R² and P2 in the general formula (CDN1), respectively.

In the group (EP) and the general formula (CDN1-e), examples of the divalent linking group represented by L_{EP} include an alkylene group which may have a substituent (preferably an alkylene group having 1 to 4 carbon atoms, more preferably an alkylene group having one carbon atom) and a —CH₂CH₂OCH₂CH₂— group. Examples of the substituent are the same as examples of the substituent in R¹ of the general formula (CDN1).

L_{EP} is preferably a methylene group.

The polymer obtained by polymerizing the compound represented by the general formula (CDN1) refers to a polymer in which at least two compounds represented by the general formula (CDN1) are polymerized via or without a linking group.

Examples of the polymer obtained by polymerizing the compound represented by the general formula (CDN1) include a compound represented by the following general formula (CDN2).

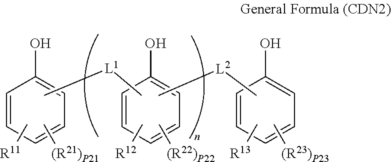

In the general formula (CDN2), each of R¹¹, R¹² and R¹³ independently represents an alkyl group which may have a substituent, or an unsaturated aliphatic group which has a double bond and may have a substituent. Each of R²¹, R²², and R²³ independently represents a hydroxy group, a carboxy group, an alkyl group which may have a substituent, or an unsaturated aliphatic group which has a double bond and may have a substituent. Each of P21 and P23 independently represents an integer of 0 or more and 3 or less, and P22 represents an integer of 0 or more and 2 or less. Each of L¹ and L² independently represents a divalent linking group. n represents an integer of 0 or more and 10 or less. A plurality of R²¹ in a case where P21 is 2 or more, a plurality of R²² in a case where P22 is 2 or more, and a plurality of R²³ in a case where P23 is 2 or more, may be the same group or different groups, respectively. In a case where n is 2 or more, a plurality of R¹², R²², and L¹ may be the same group or different groups, respectively. In a case where n is 2 or more, a plurality of P22 may be the same number or different numbers.

Preferable examples of the alkyl group which may have a substituent and the unsaturated aliphatic group which has a double bond and may have a substituent, which are represented by R¹¹, R¹², R¹³, R²¹, R²², and R²³ in the general formula (CDN2), are the same as preferable examples of R¹ in the general formula (CDN1).

Examples of the divalent linking group represented by L¹ and L² in the general formula (CDN2) include an alkylene group which may have a substituent (preferably an alkylene group having 2 to 30 carbon atoms, more preferably an alkylene group having 5 to 20 carbon atoms).

Examples of the substituent are the same as examples of the substituent in R¹ of the general formula (CDN1).

In the general formula (CDN2), n is preferably 1 or more and 10 or less, and more preferably 1 or more and 5 or less.

The compound represented by the formula (CDN2) may be further modified. For example, the compound represented by the general formula (CDN2) may be epoxidized, specifically, may be a compound having a structure in which a hydroxy group of the compound represented by the general formula (CDN1) is replaced with the group (EP), that is, a compound represented by the following general formula (CDN2-e).

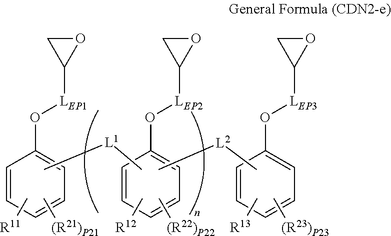

In the general formula (CDN2-e), R¹¹, R¹², R¹³, R²¹, R²², R²³, P21, P22, P23, L¹, L², and n respectively have the same meanings as R¹¹, R¹², R¹³, R²¹, R²², R²³, P21, P22, P23, L¹, L², and n in the general formula (CDN2).

In the general formula (CDN2-e), each of L_{EP1}, L_{EP2}, and L_{EP3} independently represents a single bond or a divalent linking group. In a case where n is 2 or more, a plurality of L_{EP2} may be the same group or different groups.

Preferable examples of the divalent linking group represented by L_{EP1}, L_{EP2}, and L_{EP3} in the general formula (CDN2-e) are the same as preferable examples of the divalent linking group represented by L_{EP} in the general formula (CDN1-e).

The polymer obtained by polymerizing the compound represented by the general formula (CDN1) may be, for example, a polymer in which at least three compounds represented by the general formula (CDN1) are three-dimensionally crosslinked and polymerized via or without a linking group. Examples of the polymer obtained by three-dimensionally crosslinking and polymerizing the compound represented by the general formula (CDN1) include a compound represented by the following structural formula.

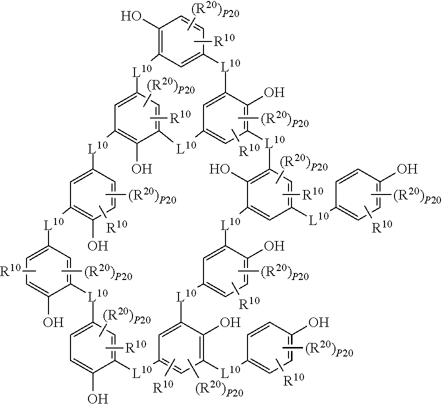

In the above structural formula, R¹⁰, R²⁰ and P20 have the same meanings as R¹, R² and P2 in the general formula (CDN1) respectively. L¹⁰ represents a single bond or a divalent linking group. A plurality of R¹⁰, R²⁰ and L¹⁰ may be the same group or different groups, respectively. A plurality of P20 may be the same number or different numbers.

In the above structural formula, examples of the divalent linking group represented by L¹⁰ include an alkylene group which may have a substituent (preferably an alkylene group having 2 to 30 carbon atoms, more preferably an alkylene group having 5 to 20 carbon atoms).

Examples of the substituent are the same as examples of the substituent in R¹ of the general formula (CDN1).

The compound represented by the above structural formula may be further modified, for example, may be epoxidized. Specifically, a compound having a structure in which a hydroxy group of the compound represented by the above structural formula is replaced with a group (EP) may be used, and examples thereof include a compound represented by the following structural formula, that is, a polymer obtained by three-dimensionally crosslinking and polymerizing the compound represented by the general formula (CDN1-e).

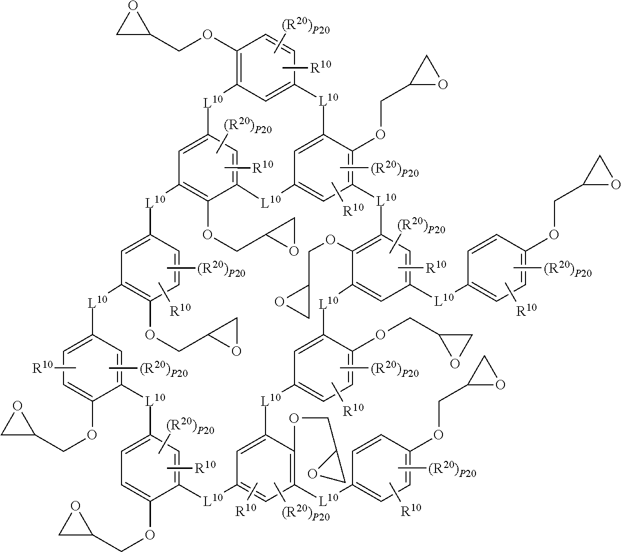

In the structural formula, R¹⁰, R²⁰, and P20 have the same meanings as R¹, R², and P2 in the general formula (CDN1-e) respectively. L¹⁰ represents a single bond or a divalent linking group. A plurality of R¹, R² and L¹ may be the same group or different groups, respectively. A plurality of P20 may be the same number or different numbers.

In the above structural formula, examples of the divalent linking group represented by L¹⁰ include an alkylene group which may have a substituent (preferably an alkylene group having 2 to 30 carbon atoms, more preferably an alkylene group having 5 to 20 carbon atoms).

Examples of the substituent are the same as examples of the substituent in R¹ of the general formula (CDN1).

The cardanol compound preferably contains a cardanol compound having an epoxy group, and more preferably is a cardanol compound having an epoxy group in view of improving the surface glossiness of the resin molded body.

A commercially available product may be used as the cardanol compound. Examples of the commercially available product include NX-2024, Ultra LITE 2023, NX-2026, GX-2503, NC-510, LITE 2020, NX-9001, NX-9004, NX-9007, NX-9008, NX-9201, and NX-9203, which are manufactured by CARDOLITE Corp., and LB-7000, LB-7250, and CD-5L, which are manufactured by Tohoku Chemical Industries, Ltd. Examples of the commercially available product of the cardanol compound having an epoxy group include NC-513, NC-514S, NC-547, LITE 513E, and Ultra LTE 513, which are manufactured by CARDOLITE Corp.

A hydroxy value of the cardanol compound is preferably 100 mg KOH/g or more, more preferably 120 mg KOH/g or more, and still more preferably 150 mg KOH/g or more in view of the surface glossiness of the resin molded body. The hydroxy value of the cardanol compound is measured according to the A method of ISO 14900.

In a case where the cardanol compound having an epoxy group is used, the cardanol compound preferably has an epoxy equivalent of 300 or more and 500 or less, more preferably 350 or more and 480 or less, and still more preferably 400 or more and 470 or less in view of improving the surface glossiness of the resin molded body. The epoxy equivalent of the cardanol compound having an epoxy group is measured according to ISO 3001.

A molecular weight of the cardanol compound is preferably 250 or more and 1,000 or less, more preferably 280 or more and 900 or less, and still more preferably 300 or more and 800 or less from a viewpoint that an effect of improving toughness by adding the component (B) is easily obtained.

### —Ester Compound—

An ester compound contained as the plasticizer (D) in the resin composition according to the exemplary embodiment is not particularly limited as long as the ester compound is an ester compound other than the compounds represented by the general formulas (1) to (5).

Examples of the ester compound contained as the plasticizer (D) include a dicarboxylic acid diester, a citrate, a polyether ester compound, a glycol benzoate, a compound represented by a general formula (6), and an epoxidized fatty acid ester. Examples of the esters include a monoester, a diester, a triester, and a polyester.

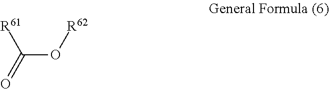

In the general formula (6), R⁶¹ represents an aliphatic hydrocarbon group having 7 to 28 carbon atoms, and R⁶² represents an aliphatic hydrocarbon group having 1 to 8 carbon atoms.

Forms same as those of the group represented by R¹¹ in the general formula (1) are exemplified as specific forms and preferable forms of the group represented by R⁶¹

The group represented by R⁶² may be a saturated aliphatic hydrocarbon group or an unsaturated aliphatic hydrocarbon group, and is preferably the saturated aliphatic hydrocarbon group. The group represented by R⁶² may be a linear aliphatic hydrocarbon group, a branched aliphatic hydrocarbon group, or an aliphatic hydrocarbon group containing an alicyclic ring, and is preferably the branched aliphatic hydrocarbon group. The group represented by R⁶² may be a group in which a hydrogen atom in the aliphatic hydrocarbon group is substituted with a halogen atom (such as a fluorine atom, a bromine atom, and an iodine atom), an oxygen atom, a nitrogen atom or the like, but is preferably not substituted. The group represented by R⁶² preferably has 2 or more carbon atoms, more preferably 3 or more carbon atoms, and still more preferably 4 or more carbon atoms.

Examples of the ester compound contained as the plasticizer (D) specifically include an adipate, a citrate, a sebacate, an azelate, a phthalate, an acetate, a dibasic acid ester, a phosphate, a condensed phosphate, a glycol ester (for example, a glycol benzoate), and a modified product of a fatty acid ester (for example, an epoxidized fatty acid ester). Examples of the ester include a monoester, a diester, a triester, and a polyester. Among these, the dicarboxylic acid diester (an adipic acid diester, a sebacic acid diester, an azelaic acid diester, a phthalic diester, or the like) is preferable.

The ester compound contained as the plasticizer (D) in the resin composition according to the exemplary embodiment has a molecular weight (or weight average molecular weight) of preferably 200 or more and 2,000 or less, more preferably of 250 or more and 1,500 or less, and still more preferably of 280 or more and 1,000 or less. The weight average molecular weight of the ester compound is a value measured in accordance with a method of measuring the weight average molecular weight of the cellulose acylate (A), unless otherwise specified.

The plasticizer (D) is preferably an adipate. The adipate has a high affinity with the cellulose acylate (A) and is dispersed in a state nearly uniform with respect to the cellulose acylate (A), so that thermal fluidity of the adipate is improved more than other plasticizers (D).

Examples of the adipate include an adipic acid diester and an adipic acid polyester. Specific examples include an adipic acid diester represented by the following general formula (AE) and an adipic acid polyester represented by the following general formula (APE).

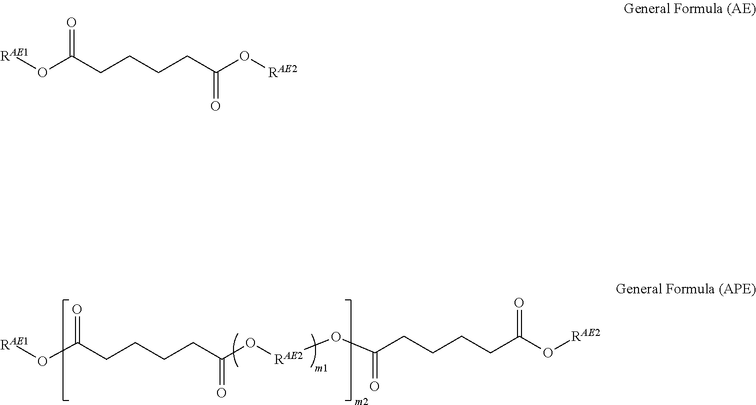

In the general formula (AE), each of R^{AE1} and R^{AE2} independently represents an alkyl group or a polyoxyalkyl group [—(CₓH₂ₓ—O)_{y}—R^{A1}] (wherein, R^{A1} represents an alkyl group, x represents an integer of 1 or more and 10 or less, and y represents an integer of 1 or more and 10 or less.).

In the general formula (APE), each of R^{AE1} and R^{AE2} independently represent an alkyl group or a polyoxyalkyl group [—(CₓH₂ₓ—O)_{y}—R^{A1}] (wherein, R^{A1} represents an alkyl group, x represents an integer of 1 or more and 10 or less, and y represents an integer of 1 or more and 10 or less), and R^{AE3} represents an alkyl group. m1 represents an integer of 1 or more and 10 or less, and m2 represents an integer of 1 or more and 20 or less.

In the general formulas (AE) and (APE), the alkyl group represented by R^{AE1} and R^{AE2} is preferably an alkyl group having 1 to 12 carbon atoms, more preferably an alkyl group having 4 to 10 carbon atoms, and still more preferably an alkyl group having 8 carbon atoms. The alkyl group represented by R^{AE1} and R^{AE2} may be linear, branched, or cyclic, and is preferably linear or branched.

In the polyoxyalkyl group [—(CₓH₂ₓ—O)_{y}—R^{A1}] represented by R^{AE1} and R^{AE2} in the general formulas (AE) and (APE), the alkyl group represented by R^{A1} is preferably an alkyl group having 1 to 6 carbon atoms, and more preferably an alkyl group having 1 to 4 carbon atoms. The alkyl group represented by R^{A1} may be linear, branched, or cyclic, and is preferably linear or branched.

In the general formula (APE), the alkyl group represented by R^{AE3} is preferably an alkylene group having 1 to 6 carbon atoms, more preferably an alkylene group having 1 to 4 carbon atoms. The alkylene group may be linear, branched, or cyclic, and is preferably linear or branched.

In the general formula (APE), m1 is preferably an integer of 1 or more and 5 or less, and m2 is preferably an integer of 1 or more and 10 or less.

In the general formulas (AE) and (APE), the group represented by each symbol may be substituted with a substituent. Examples of the substituent include an alkyl group, an aryl group, and a hydroxy group.

The molecular weight (or weight average molecular weight) of the adipate is preferably 250 or more and 2,000 or less, more preferably 280 or more and 1,500 or less, and still more preferably 300 or more and 1,000 or less. The weight average molecular weight of the adipate is a value measured in accordance with a method of measuring the weight average molecular weight of the cellulose acylate (A).

An adipate and other components may be used as the adipate a mixture. Examples of a commercially available product of the mixture include Daifatty 101 manufactured by Daihachi Chemical Industry Co., Ltd.

A hydrocarbon group at the end of the fatty acid ester such as a citrate, a sebacate, an azelate, a phthalate, and an acetate is preferably an aliphatic hydrocarbon group, and is preferably an alkyl group having 1 to 12 carbon atoms, more preferably an alkyl group having 4 to 10 carbon atoms, and still more preferably an alkyl group having 8 carbon atoms. The alkyl group may be linear, branched, or cyclic, and is preferably linear or branched.

Examples of the fatty acid ester such as a citrate, a sebacate, an azelate ester, a phthalate, and an acetate include an ester formed of a fatty acid and an alcohol. Examples of the alcohol include: a monohydric alcohol such as methanol, ethanol, propanol, butanol, and 2-ethylhexanol; and a polyhydric alcohol such as glycerin, a polyglycerin (for example, diglycerin), pentaerythritol, ethylene glycol, diethylene glycol, propylene glycol, butylene glycol, trimethylolpropane, trimethylolethane, and a sugar alcohol.

Examples of the glycol in the glycol benzoate include ethylene glycol, diethylene glycol, and propylene glycol.

The epoxidized fatty acid ester is an ester compound having a structure (that is, an oxacyclopropane) in which a carbon-carbon unsaturated bond of an unsaturated fatty acid ester is epoxidized. Examples of the epoxidized fatty acid ester include an ester formed of an alcohol and a fatty acid in which a part or all of the carbon-carbon unsaturated bonds in the unsaturated fatty acid (such as oleic acid, palmitoleic acid, vaccenic acid, linoleic acid, linolenic acid, and nervonic acid) are epoxidized. Examples of the alcohol include: a monohydric alcohol such as methanol, ethanol, propanol, butanol, and 2-ethylhexanol; and a polyhydric alcohol such as glycerin, a polyglycerin (for example, diglycerin), pentaerythritol, ethylene glycol, diethylene glycol, propylene glycol, butylene glycol, trimethylolpropane, trimethylolethane, and a sugar alcohol.

Examples of a commercially available product of the epoxidized fatty acid ester include ADK CIZER D-32, D-55, O-130P, O-180A (manufactured by ADEKA) and SANSOSAIZA E-PS, nE-PS, E-PO, E-4030, E-6000, E-2000H, and E-9000H (manufactured by New Japan Chemical Co., Ltd.).

Each of a polyester unit and a polyether unit in a polyether ester compound may be either aromatic or aliphatic (including alicyclic). A mass ratio of the polyester unit to the polyether unit is, for example, 20:80 to 80:20 or less. The molecular weight (or weight average molecular weight) of the polyether ester compound is preferably 250 or more and 2,000 or less, more preferably 280 or more and 1,500 or less, and still more preferably 300 or more and 1,000 or less. Examples of a commercially available product of the polyether ester compound include ADK CIZER RS-1000 (ADEKA).

As a polyether compound having 1 or more unsaturated bonds in the molecule, a polyether compound having an allyl group at an end thereof is exemplified, and polyalkylene glycol allyl ether is preferable. The molecular weight (or weight average molecular weight) of the polyether compound having 1 or more unsaturated bonds in the molecule is preferably 250 or more and 2,000 or less, more preferably 280 or more and 1,500 or less, and still more preferably 300 or more and 1,000 or less. Examples of a commercially available product of the polyether compound having 1 or more unsaturated bonds in the molecule include polyalkylene glycol allyl ether such as UNIOX PKA-5006, UNIOX PKA-5008, UNIOX PKA-5014, UNIOX PKA-5017 (NOF CORPORATION).

### [Polyester Resin (E): Component (E)]

Examples of the polyester resin (E) include a polymer of hydroxyalkanoate (hydroxyalkanoic acid), a polycondensate of a polyvalent carboxylic acid and a polyhydric alcohol, and a ring-opening polycondensate of a cyclic lactam.

The polyester resin (E) may be an aliphatic polyester resin. Examples of the aliphatic polyester include a polyhydroxyalkanoate (a polymer of hydroxyalkanoate) and a polycondensate of an aliphatic diol and an aliphatic carboxylic acid.

Among these, the polyester resin (E) is preferably a polyhydroxyalkanoate in view of the surface glossiness of the obtained resin molded body.

The polyester resin (E) may be used alone or in combination of two or more thereof.

Examples of the polyhydroxyalkanoate include a compound having a structural unit represented by a general formula (PHA).

In the compound having a structural unit represented by the general formula (PHA), both ends of a polymer chain (ends of a main chain) may be a carboxyl group, or only one end may be a carboxyl group, and the other end may be other groups (for example, hydroxy group).

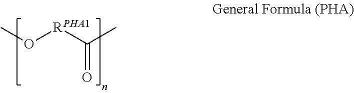

R^{PHA1} in the general formula (PHA) represents an alkylene group having 1 to 10 carbon atoms. n represents an integer of 2 or more.

The alkylene group represented by R^{PHA1} in the general formula (PHA) is preferably an alkylene group having 3 to 6 carbon atoms. The alkylene group represented by R^{PHA1} may be either linear or branched, preferably branched.

Here, that R^{PHA1} represents an alkylene group in the general formula (PHA) denotes that 1) a [O—R^{PHA1}—C(═O)—] structure is contained in which R^{PHA1} represents the same alkylene group; and 2) a plurality of [O—R^{PHA1}—C(═O)—] structures (that is, [O—R^{PHA1A}—C(═O)—] and [O—R^{PHA1B}—C(═O)—] structures) are contained in which R^{PHA1} represents different alkylene groups (R^{PHA1} is an alkylene group having different number of carbon atoms or a different branch).

That is, the polyhydroxyalkanoate may be a homopolymer of one hydroxyalkanoate (hydroxyalkanoic acid), or may be a copolymer of two or more hydroxyalkanoates (hydroxyalkanoic acid).

In the general formula (PHA), an upper limit of n is not particularly limited, but is, for example, 20,000 or less. A range of n is preferably 500 or more and 10,000 or less, and more preferably 1,000 or more and 8,000 or less.

Examples of the polyhydroxyalkanoate include a homopolymer of a hydroxyalkanoic acid (lactic acid, 2-hydroxybutyric acid, 3-hydroxybutyric acid, 4-hydroxybutyric acid, 2-hydroxy-3-methylbutyric acid, 2-hydroxy-3,3-dimethylbutyric acid, 3-hydroxyvaleric acid, 4-hydroxyvaleric acid, 5-hydroxyvaleric acid, 3-hydroxyhexanoic acid, 2-hydroxyhexanoic acid, 2-hydroxyisohexanoic acid, 6-hydroxyhexanoic acid, 3-hydroxypropionic acid, 3-hydroxy-2,2-dimethylpropionic acid, 3-hydroxyhexanoic acid, 2-hydroxy-n-octanoic acid, or the like), or a copolymer of 2 or more of these hydroxyalkanoic acids.

Among these, in view of the surface glossiness of the resin molded body and suppressing reduction in transparency of the obtained resin molded body, the polyhydroxyalkanoate may be preferably a homopolymer of a branched hydroxyalkanoic acid having 2 to 4 carbon atoms, and a homo-copolymer of the branched hydroxyalkanoic acid having 2 to 4 carbon atoms and a branched hydroxyalkanoic acid having 5 to 7 carbon atoms, more preferably a homopolymer of a branched hydroxyalkanoic acid having 3 carbon atoms (that is, polylactic acid) and a homo-copolymer of 3-hydroxybutyric acid and 3-hydroxyhexanoic acid (that is, polyhydroxybutyrate hexanoate), and still more preferably a homopolymer of the branched hydroxyalkanoic acid having 3 carbon atoms (that is, polylactic acid).

The number of carbon in the hydroxyalkanoic acid is a number also including the number of carbon in a carboxyl group.

The polylactic acid is a polymer compound in which lactic acid polymerizes by an ester bond.

Examples of the polylactic acid include a homopolymer of L-lactic acid, a homopolymer of D-lactic acid, a block copolymer containing at least one polymer of L-lactic acid and D-lactic acid, and a graft copolymer containing at least one polymer of L-lactic acid and D-lactic acid.

Examples of “a compound capable of copolymerizing with L-lactic acid or D-lactic acid” include: a polyvalent carboxylic acid such as glycolic acid, dimethylglycolic acid, 3-hydroxybutyric acid, 4-hydroxybutyric acid, 2-hydroxypropanoic acid, 3-hydroxypropanoic acid, 2-hydroxyvaleric acid, 3-hydroxyvaleric acid, 4-hydroxyvaleric acid, oxalic acid, malonic acid, succinic acid, glutaric acid, adipic acid, pimelic acid, azelaic acid, sebacic acid, undecanedioic acid, dodecanedioic acid, and terephthalic acid, and anhydrides thereof; a polyhydric alcohol such as ethylene glycol, diethylene glycol, triethylene glycol, 1,2-propanediol, 1,3-propanediol, 1,3-butanediol, 1,4-butanediol, 2,3-butanediol, 1,5-pentanediol, 1,6-hexanediol, 1,9-nonanediol, 3-methyl-1,5-pentanediol, neopentyl glycol, tetramethylene glycol, and 1,4-hexane dimethanol; polysaccharides such as cellulose; an aminocarboxylic acid such as α-amino acid; a hydroxy carboxylic acid such as 5-hydroxyvaleric acid, 2-hydroxycaproic acid, 3-hydroxycaproic acid, 4-hydroxycaproic acid, 5-hydroxycaproic acid, 6-hydroxycaproic acid, 6-hydroxymethylcaproic acid, and mandelic acid; and a cyclic ester such as glycolide, β-methyl-6-valerolactone, γ-valerolactone, and ε-caprolactone.

It is known that the polylactic acid can be manufactured by a lactide method via lactide; a direct polymerization method in which lactic acid is heated under reduced pressure and polymerized while water is removed in a solvent; or the like.

In polyhydroxybutyrate hexanoate, in view of the surface glossiness of the obtained resin molded body, a copolymerization ratio of 3-hydroxyhexanoic acid (3-hydroxyhexanoate) to a copolymer of 3-hydroxybutyric acid (3-hydroxybutyrate) and 3-hydroxyhexanoic acid (3-hydroxyhexanoate) is preferably 3 mol % or more and 20 mol % or less, more preferably 4 mol % or more and 15 mol % or less, and still more preferably 5 mol % or more and 12 mol % or less.

In a measurement method of the copolymerization ratio of 3-hydroxyhexanoic acid (3-hydroxyhexanoate), a hexanoate ratio is calculated from an integral value of peaks derived from a hexanoate end and a butyrate end using ¹H-NMR.

The weight average molecular weight (Mw) of the polyester resin (E) may be 10,000 or more and 1,000,000 or less (preferably 50,000 or more and 800,000 or less, more preferably 100,000 or more and 600,000 or less) in view of the surface glossiness of the obtained resin molded body.

The weight average molecular weight (Mw) of the polyester resin (E) is a value measured by gel permeation chromatography (GPC). Specifically, the molecular weight measurement by GPC is performed in a chloroform solvent using HLC-8320 GPC manufactured by Tosoh Corporation as a measurement apparatus and using a column: TSKgel GMHHR-M+TSKgel GMHHR-M (7.8 mm I.D. 30 cm).

The weight average molecular weight (Mw) is calculated from this measurement result by using a molecular weight calibration curve made according to a monodisperse polystyrene standard sample.

### [Poly (Meth)acrylate Compound (F): Compound (F)]

The poly (meth)acrylate compound (F) is a compound (resin) containing 50 mass % or more (preferably 70 mass % or more, more preferably 90 mass %, still more preferably 100 mass %) of monomers derived from an alkyl (meth)acrylate.

The poly (meth)acrylate compound (F) may be a compound (resin) containing monomers derived from a monomer other than a (meth)acrylate.

The monomers contained in the poly (meth)acrylate compound (F) may be one type alone or two or more types.

In addition, the poly (meth)acrylate compound (F) may be used alone or in combination of two or more types thereof.

Examples of the alkyl (meth)acrylate include methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, Isooctyl (meth)acrylate, 2-ethylhexyl (meth)acrylate, octyl (meth)acrylate, decyl (meth)acrylate, cyclohexyl (meth)acrylate, and dicyclopentanyl (meth)acrylate.

Among these, in view of the surface glossiness of the obtained resin molded body, the alkyl (meth)acrylate may be an alkyl (meth)acrylate in which an alkyl chain has 1 to 8 carbon atoms (preferably 1 or more and 4 or less, more preferably 1 or more and 2 or less, still more preferably 1).

That is, the poly (meth)acrylate compound (F) may be a polymer containing 50 mass % or more (preferably 70 mass % or more, more preferably 90 mass %, and still more preferably 100 mass %) of the monomers derived from the alkyl (meth)acrylate in which the alkyl chain has 1 to 8 carbon atoms (preferably 1 or more and 4 or less, more preferably 1 or more and 2 or less, and still more preferably 1).

The poly (meth)acrylate compound (F) may be a polymer containing 100 mass % of the monomers derived from the alkyl (meth)acrylate in which the alkyl chain has 1 to 8 carbon atoms (preferably 1 or more and 4 or less, more preferably 1 or more and 2 or less, and still more preferably 1). That is, the poly (meth)acrylate compound (F) may be a polyalkyl (meth)acrylate in which the alkyl chain has 1 to 8 carbon atoms (preferably 1 or more and 4 or less, more preferably 1 or more and 2 or less, and still more preferably 1). The polyalkyl (meth)acrylate in which the alkyl chain has one carbon atom is preferably a polymethyl methacrylate.

In the poly (meth) acrylate compound (F), examples of the monomer other than the (meth) acrylate include

a styrene compound [a monomer having a styrene backbone such as styrene, an alkyl-substituted styrene (such as α-methyl styrene, 2-methyl styrene, 3-methyl styrene, 4-methylstyrene, 2-ethylstyrene, 3-ethylstyrene, and 4-ethylstyrene), a halogen-substituted styrene (such as 2-chlorostyrene, 3-chlorostyrene, and 4-chlorostyrene), a vinylnaphthalene (2-vinylnaphthalene and the like), and a hydroxystyrene (4-ethenylphenol and the like)], and

an unsaturated dicarboxylic anhydride [“a compound having an ethylenic double bond and a dicarboxylic acid anhydride group” such as maleic anhydride, itaconic anhydride, glutaconic anhydride, citraconic anhydride, and aconitic anhydride].

The weight average molecular weight (Mw) of the poly (meth)acrylate compound (F) is not particularly limited, but may be 15,000 or more and 120,000 or less (preferably more than 20,000 and 100,000 or less, more preferably 22,000 or more and 100,000 or less, and more preferably 25,000 or more and 100,000 or less).

In particular, in view of the surface glossiness of the obtained resin molded body, the weight average molecular weight (Mw) of the poly (meth)acrylate compound (F) is preferably less than 50,000 (that is, less than 50 thousands), more preferably 40,000 or less, and still more preferably 35,000 or less. However, the weight average molecular weight (Mw) of the poly (meth)acrylate compound (F) may be 15,000 or more.

The weight average molecular weight (Mw) of the poly (meth)acrylate compound (F) is a value measured by gel permeation chromatography (GPC). Specifically, the molecular weight measurement by GPC is performed in a tetrahydrofuran solvent using HLC-8320 GPC manufactured by Tosoh Corporation as a measurement apparatus and using a column: TSKgel α-M manufactured by Tosoh Corporation. The weight average molecular weight (Mw) is calculated from this measurement result by using a molecular weight calibration curve made according to a monodisperse polystyrene standard sample.

[Other additives] (at least one compound (G) selected from the group consisting of a hindered phenol compound, a tocopherol compound, a tocotrienol compound, a phosphite compound, and a hydroxylamine compound: component (G))

The resin composition according to the exemplary embodiment may further contain the compound (G).

The compound (G) is at least one selected from the group consisting of the hindered phenol compound, the tocopherol compound, the tocotrienol compound, the phosphite compound, and the hydroxylamine compound.

### —Hindered Phenol Compound—

In the exemplary embodiment, the hindered phenol compound refers to a compound in which at least one of the ortho position of a hydroxy group of a phenol is substituted with an alkyl group. The alkyl group is preferably a bulky alkyl group such as a tert-butyl group and a tert-pentyl group (1,1-dimethylpropyl group).

Examples of the hindered phenol compound include a compound represented by the following general formula (HP1).

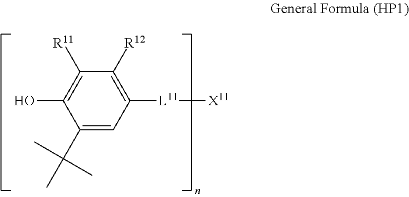

In the general formula (HP1), each of R¹¹ and R¹² independently represents an alkyl group having 1 or more and 6 or less of hydrogen atoms or carbons, L¹¹ represents a single bond or a divalent linking group, X¹¹ represents a single bond or an n-valent group, and n represents 1, 2, 3, or 4.

The alkyl group having 1 to 6 carbon atoms represented by R¹¹ is preferably an alkyl group having 1 to 5 carbon atoms, and more preferably an alkyl group having 1 to 4 carbon atoms. The alkyl group having 1 to 6 carbon atoms represented by R¹¹ may be linear, branched, or cyclic, but is preferably a linear or branched alkyl group.

Specifically, the alkyl group having 1 to 6 carbon atoms represented by R¹¹ is preferably a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, or a 1,1-dimethylbutyl group, more preferably a methyl group, a tert-butyl group, or a tert-pentyl group, and still more preferably a methyl group or a tert-butyl group.

The alkyl group having 1 to 6 carbon atoms represented by R¹² is preferably an alkyl group having 1 to 3 carbon atoms, and more preferably an alkyl group having 1 or 2 carbon atoms. The alkyl group having 1 to 6 carbon atoms represented by R¹² may be linear, branched, or cyclic, but is preferably a linear or branched alkyl group.

Specifically, the alkyl group having 1 to 6 carbon atoms represented by R¹² is preferably a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, or a 1,1-dimethylbutyl group, more preferably a methyl group, an ethyl group, an n-propyl group, or an isopropyl group, and still more preferably a methyl group or an ethyl group.

The group represented by R¹¹ is preferably a hydrogen atom, a methyl group, a tert-butyl group, or a tert-pentyl group.

The group represented by R¹² is preferably a hydrogen atom, a methyl group, or an ethyl group.

R¹¹ and R¹² may be linked to each other to form a ring.

Examples of the divalent linking group represented by R¹¹ include an alkylene group having 1 to 6 carbon atoms (preferably an alkylene group having 1 to 4 carbon atoms) and —R—C(═O)O—R′—. Here, each of R and R′ independently represents an alkylene group having 1 to 6 carbon atoms (preferably an alkylene group having 1 to 4 carbon atoms, and more preferably an alkylene group having 1 or 2 carbon atoms) or a phenylene group.

—R—C(═O)O—R′— is preferably —CH₂CH₂—C(═O)O—CH₂—.

Examples of the monovalent group represented by X¹¹ include an aliphatic hydrocarbon group.

The aliphatic hydrocarbon group may be linear, branched, or alicyclic. From a viewpoint that the compound represented by the general formula (HP1) easily disperses in the cellulose acylate (A), the aliphatic hydrocarbon group is preferably an aliphatic hydrocarbon group containing an alicyclic ring (that is, a chain aliphatic hydrocarbon group), and more preferably a linear aliphatic hydrocarbon group.

The aliphatic hydrocarbon group may be a saturated aliphatic hydrocarbon group or an unsaturated aliphatic hydrocarbon group. The aliphatic hydrocarbon group is preferably a saturated aliphatic hydrocarbon group from the viewpoint that the compound represented by the general formula (HP1) easily disperses in the cellulose acylate (A).

From the viewpoint that the compound represented by the general formula (HP1) easily disperses in the cellulose acylate (A), the aliphatic hydrocarbon group preferably has 1 to 24 carbon atoms, more preferably has 6 to 20 carbon atoms, and still more preferably has 12 to 18 carbon atoms.

Specific examples of the aliphatic hydrocarbon group include groups same as specific examples of Y⁴¹ in a general formula (P1) described later.

A specific example of the aliphatic hydrocarbon group is preferably a linear alkyl group having 6 to 20 carbon atoms, more preferably a linear alkyl group having 12 to 18 carbon atoms, and still more preferably a linear alkyl group having 16 to 18 carbon atoms.

Examples of the divalent group represented by X¹¹ include a group (alkanediyl group) obtained by removing two hydrogen atoms from an alkane having 1 to 6 carbon atoms (preferably an alkane having 1 to 4 carbon atoms), and —(R—O—R′)ₘ. Here, each of R and R′ independently represents an alkylene group or a phenylene group having 1 to 4 carbon atoms, and m represents 1, 2, 3, or 4 (preferably 1 or 2).

—(R—O—R′)ₘ— is preferably —CH₂—O—CH₂— and —(CH₂—O—CH₂)₂—.

Examples of the divalent group represented by X¹¹ also include the following group (HP1-a). * represents a binding position with L¹.

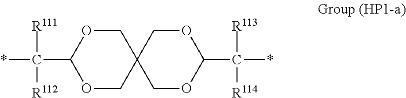

In the group (HP1-a), each of R¹¹¹, R¹¹², R¹¹³, and R¹¹⁴ independently represents a hydrogen atom or an alkyl group having 1 to 4 carbon atoms. The alkyl group having 1 to 4 carbon atoms is preferably a methyl group, an ethyl group, an n-propyl group, an isopropyl group, an n-butyl group, a sec-butyl group, an isobutyl group, or a tert-butyl group, more preferably a methyl group or an ethyl group, and still more preferably a methyl group.

Examples of the trivalent group represented by X¹¹ include a group (alkanetriyl group) obtained by removing three hydrogen atoms from an alkane having 1 to 6 carbon atoms (preferably an alkane having 1 to 4 carbon atoms).

Examples of the trivalent group represented by X¹¹ also include the following group (HP1-b) and group (HP1-c). * represents a binding position with L¹¹.

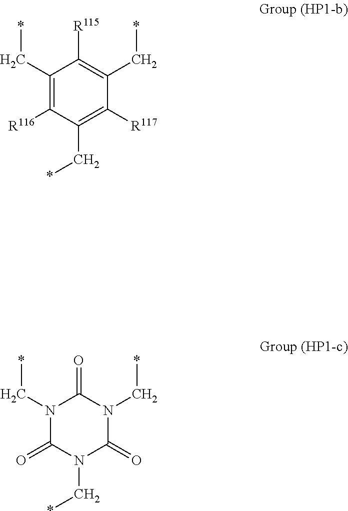

In the group (HP1-b), each of R¹¹⁵, R¹¹⁶, and R¹¹⁷ independently represents a hydrogen atom or an alkyl group having 1 to 4 carbon atoms. The alkyl group having 1 to 4 carbon atoms is preferably a methyl group, an ethyl group, an n-propyl group, an isopropyl group, an n-butyl group, a sec-butyl group, an isobutyl group, or a tert-butyl group, more preferably a methyl group or an ethyl group, and still more preferably a methyl group.

Examples of the tetravalent group represented by X¹¹ include a group (alkanetetrayl group) obtained by removing four hydrogen atoms from an alkane having 1 to 6 carbon atoms (preferably an alkane having 1 to 4 carbon atoms), among them methanetetrayl is preferable.

In a case where n is 2, 3, or 4, a plurality of R¹¹, R¹², and L¹¹ may be the same group or different groups, respectively.

Specific examples of the compound represented by the general formula (HP1) include “Irganox 1010”, “Irganox 245”, and “Irganox 1076” manufactured by BASF SE, “ADK STAB AO-80”, “ADK STAB AO-60”, “ADK STAB AO-50”, “ADK STAB AO-40”, “ADK STAB AO-30”, “ADK STAB AO-20”, and “ADK STAB AO-330” manufactured by ADEKA Corporation, and “Sumilizer GA-80” manufactured by Sumitomo Chemical Co., Ltd.

Examples of the hindered phenol compound include a compound represented by the following general formula (HP2).

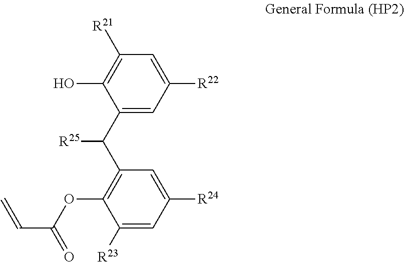

In the general formula (HP2), each of R²¹, R²², R²³, R²⁴, and R²⁵ independently represents a hydrogen atom or an alkyl group having 1 to 6 carbon atoms.

The alkyl group having 1 to 6 carbon atoms represented by R²¹ is preferably an alkyl group having 4 to 6 carbon atoms, and more preferably an alkyl group having 4 or 5 carbon atoms. The alkyl group having 1 to 6 carbon atoms represented by R²¹ may be linear, branched, or cyclic, but is preferably a linear or branched alkyl group, and more preferably a branched alkyl group.

Specifically, the alkyl group having 1 to 6 carbon atoms represented by R²¹ is preferably a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, or a 1,1-dimethylbutyl group, more preferably a tert-butyl group, a tert-pentyl group, or a 1,1-dimethylbutyl, and still more preferably a tert-butyl group or a tert-pentyl group.

The alkyl group having 1 to 6 carbon atoms represented by R²² is preferably an alkyl group having 1 to 5 carbon atoms, and more preferably an alkyl group having 1 to 4 carbon atoms. The alkyl group having 1 to 6 carbon atoms represented by R²² may be linear, branched, or cyclic, but is preferably a linear or branched alkyl group.

Specifically, the alkyl group having 1 to 6 carbon atoms represented by R²² is preferably a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, or a 1,1-dimethylbutyl group, and more preferably a methyl group, a tert-butyl group, or a tert-pentyl group.

Specific forms and preferable forms of the group represented by R²³ are the same as forms described for R²¹.

Specific forms and preferable forms of the group represented by R²⁴ are the same as forms described for R²².

The alkyl group having 1 to 6 carbon atoms represented by R²⁵ is preferably an alkyl group having 1 to 3 carbon atoms, and more preferably an alkyl group having 1 or 2 carbon atoms. The alkyl group having 1 to 6 carbon atoms represented by R²⁵ may be linear, branched, or cyclic, but is preferably a linear or branched alkyl group.

Specifically, the alkyl group having 1 to 6 carbon atoms represented by R²⁵ is preferably a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, or a 1,1-dimethylbutyl group, more preferably a methyl group, an ethyl group, an n-propyl group, or an isopropyl group, and still more preferably a methyl group or an ethyl group.

The group represented by R²¹ is preferably a tert-butyl group or a tert-pentyl group.

The group represented by R²² is preferably a methyl group, a tert-butyl group, or a tert-pentyl group.

The group represented by R²³ is preferably a tert-butyl group or a tert-pentyl group.

The group represented by R²⁴ is preferably a methyl group, a tert-butyl group, or a tert-pentyl group.

The group represented by R²⁵ is preferably a hydrogen atom, a methyl group, or an ethyl group.

Specific examples of the compound represented by the general formula (HP2) include “Sumilizer GM” and “Sumilizer GS” manufactured by Sumitomo Chemical Co., Ltd.

### —Tocopherol Compound, Tocotrienol Compound—

Examples of the tocopherol compound or the tocotrienol compound include a compound represented by the following general formula (Ti).

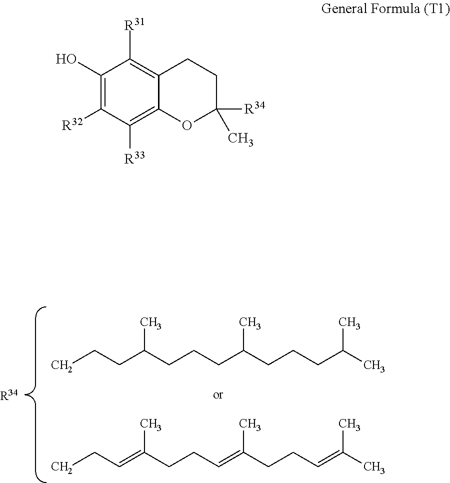

In the general formula (Ti), each of R³¹, R³², and R³³ independently represents a hydrogen atom or an alkyl group having 1 to 3 carbon atoms.

The alkyl group having 1 to 3 carbon atoms represented by R³¹ may be linear, branched, or cyclic, but is preferably a linear or branched alkyl group.

Specifically, the alkyl group having 1 to 3 carbon atoms which is represented by R³¹ is preferably a methyl group, an ethyl group, an n-propyl group, or an isopropyl group, more preferably a methyl group or an ethyl group, and still more preferably a methyl group.

The group represented by R³¹ is particularly preferably a hydrogen atom or a methyl group.

Specific forms and preferable forms of the group represented by R³² are the same as forms described for R³¹.

Specific forms and preferable forms of the group represented by R³³ are the same as forms described for R³¹.

Specific examples of the tocopherol compound include the following compounds.

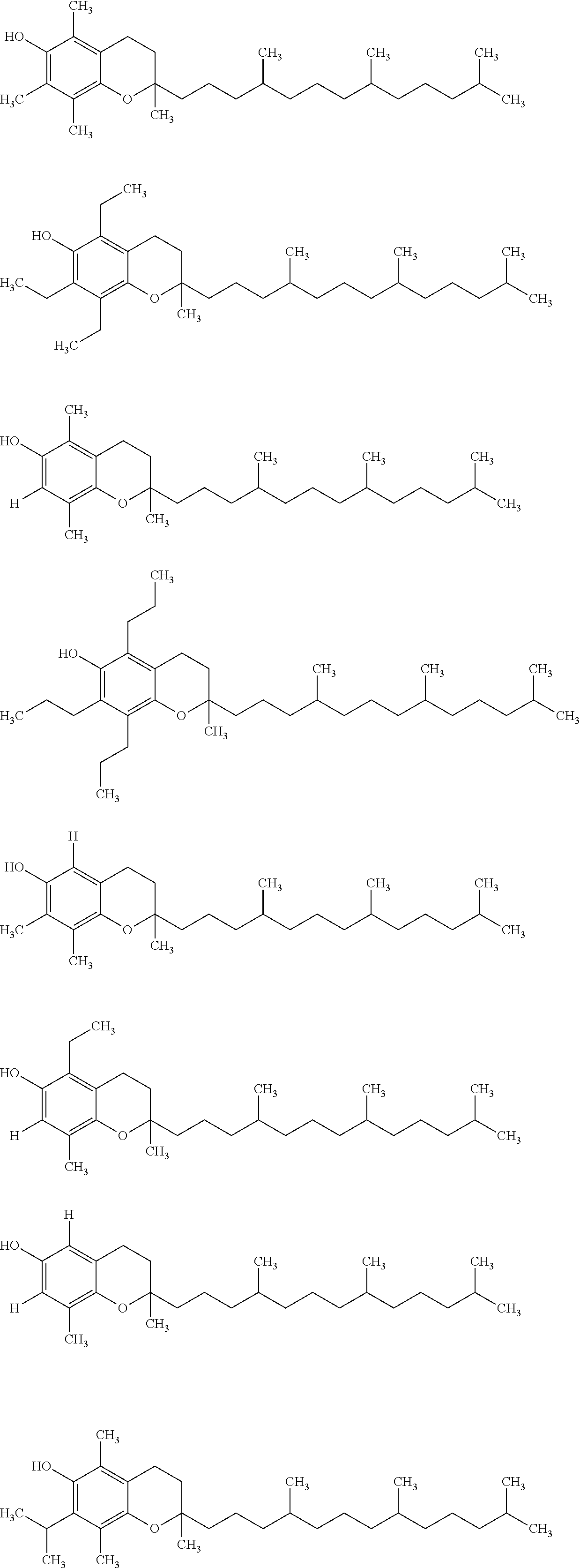

Specific examples of the tocotrienol compound include the following compounds.

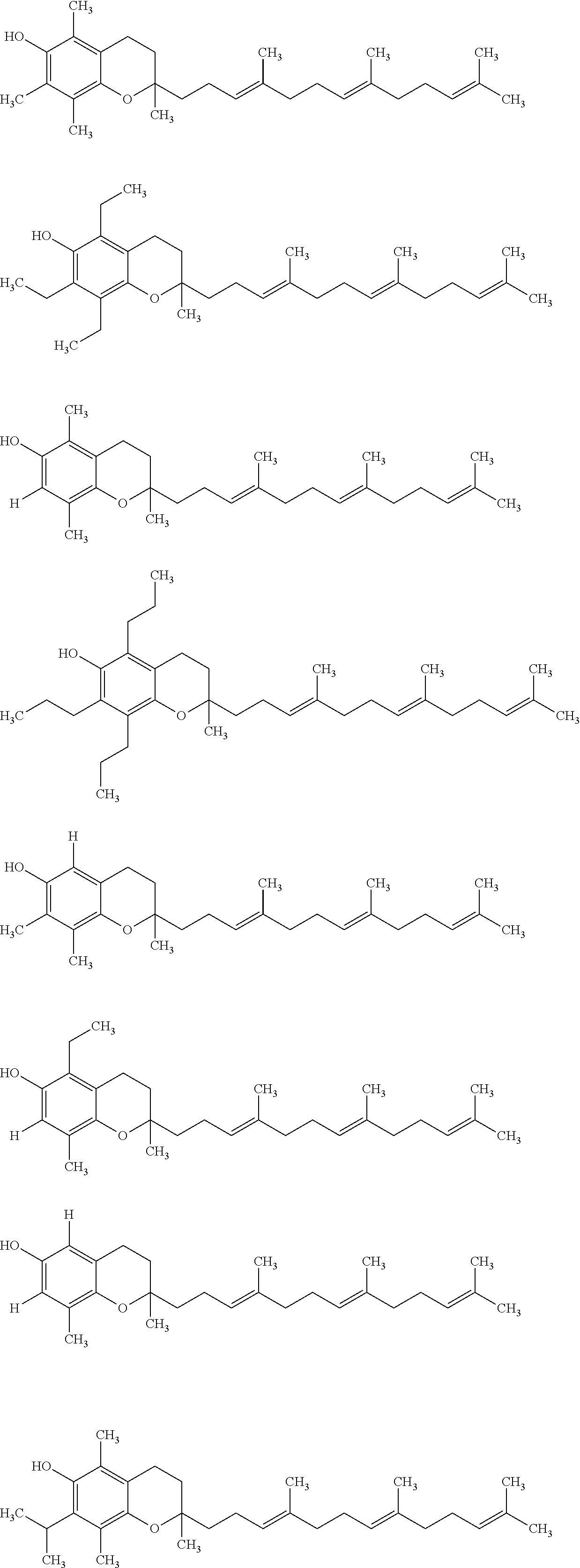

### —Phosphite Compound—

Examples of the phosphite compound include a compound represented by the following general formula (P1).

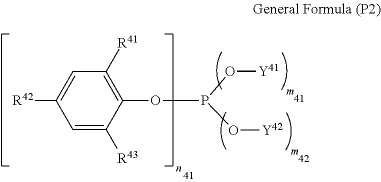

In the general formula (P1), each of R⁴¹, R⁴², and R⁴³ independently represents a hydrogen atom or an alkyl group having 1 to 12 carbon atoms, each of Y⁴¹ and Y⁴² independently represents an aliphatic hydrocarbon group, n₄₁ represents 1, 2, or 3, m₄₁ represents 0 or 1, and m₄₂ represents 0 or 1, provided that n41+m41+m42=3.

The alkyl group having 1 to 12 carbon atoms represented by R⁴¹ is preferably an alkyl group having 1 to 10 carbon atoms, and more preferably an alkyl group having 1 to 9 carbon atoms. The alkyl group having 1 to 12 carbon atoms represented by R⁴¹ may be linear, branched, or cyclic, but is preferably a linear or branched alkyl group.

Specific examples of the alkyl group having 1 to 12 carbon atoms represented by R⁴¹ include a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a tert-decyl group, an n-undecyl group, an isoundecyl group, a sec-dodecyl group, a tert-dodecyl group, an n-dodecyl group, an isododecyl group, a sec-dodecyl group, and a tert-dodecyl group.

Examples of the alkyl group having 1 to 12 carbon atoms represented by R⁴² include the same forms as the alkyl group described for R⁴¹

Examples of the alkyl group having 1 to 12 carbon atoms represented by R⁴³ include the same forms as the alkyl group described for R⁴¹

The group represented by R⁴¹ is preferably a hydrogen atom, a methyl group, or a tert-butyl group.

The group represented by R⁴² is preferably an alkyl group having 1 to 9 carbon atoms, more preferably a methyl group or a tert-butyl group, and still more preferably a tert-butyl group.

The group represented by R⁴³ is preferably a hydrogen atom, a methyl group, or a tert-butyl group.

In a case where n₄₁ is 2 or 3, a plurality of R⁴¹, R⁴², and R⁴³ may be the same group or different groups, respectively.

In a case where n₄₁ is 2 or 3, a plurality of R⁴¹, a plurality of R⁴³, or R⁴¹ and R⁴³ may be linked to form a ring.

The aliphatic hydrocarbon group represented by Y⁴¹ may be linear, branched, or alicyclic. From the viewpoint that the group easily enters between the molecular chains of the resin, the group represented by Y⁴¹ is preferably an aliphatic hydrocarbon group containing no alicyclic ring (that is, a chain aliphatic hydrocarbon group), and more preferably a linear aliphatic hydrocarbon group.

The aliphatic hydrocarbon group represented by Y⁴¹ may be a saturated aliphatic hydrocarbon group or an unsaturated aliphatic hydrocarbon group. The aliphatic hydrocarbon group represented by Y⁴¹ is preferably a saturated aliphatic hydrocarbon group from the viewpoint that the compound represented by the general formula (P1) easily disperses in the cellulose acylate (A).

From the viewpoint that the compound represented by the general formula (P1) easily disperses in the cellulose acylate (A), the aliphatic hydrocarbon group represented by Y⁴¹ preferably has 1 to 20 carbon atoms, more preferably has 1 to 12 carbon atoms, and still more preferably has 2 to 8 carbon atoms.

Specific forms and preferable forms of the aliphatic hydrocarbon group represented by Y⁴² are the same as forms described for Y⁴¹.

Specific examples of the aliphatic hydrocarbon group represented by Y⁴¹ and Y⁴² are shown below.

Y⁴¹, Y⁴²

| Linear and Saturated | Linear and Unsaturated | |
|---|---|---|
| —CH₃ | —CH═CH—CH₃ | —CH₂—CH═CH—CH₂CH₃ |
| —CH₂CH₃ | —CH═CH—C₅H₁₀CH₃ | —CH₂—CH═CH—C₄H₈CH₃ |
| —C₃H₆CH₃ | —CH═CH—C₉H₁₈CH₃ | —CH₂—CH═CH—C₈H₁₆CH₃ |
| —C₄H₈CH₃ | —CH═CH—C₁₃H₂₆CH₃ | —CH₂—CH═CH—C₁₆H₃₂CH₃ |
| —C₅H₁₀CH₃ | —CH═CH—C₁₇H₃₄CH₃ | —C₃H₆—CH═CH—C₇H₁₄CH₃ |
| —C₇H₁₄CH₃ | —CH₂—CH═CH₂ | —C₃H₆—CH═CH—C₁₄H₂₈CH₃ |
| —C₉H₁₈CH₃ | —C₆H₁₂—CH═CH₂ | —C₂H₄—CH═CH—C₂H₄CH₃ |
| —C₁₁H₂₂CH₃ | —C₁₀H₂₀—CH═CH₂ | —C₄H₈—CH═CH—C₄H₈CH₃ |
| —C₁₃H₂₆CH₃ | —C₁₄H₂₈—CH═CH₂ | —C₆H₁₂—CH═CH—C₆H₁₂CH₃ |
| —C₁₅H₃₀CH₃ | —C₁₈H₃₆—CH═CH₂ | —C₈H₁₆—CH═CH—C₈H₁₆CH₃ |

| | |
|---|---|
| —C₁₇H₃₄CH₃ | —CH₂—CH═CH—C₃H₆—CH═CH—C₃H₆CH₃ |
| —C₁₉H₃₈CH₃ | —CH₂—CH═CH—C₇H₁₄—CH═CH—C₇H₁₄CH₃ |

Y⁴¹, Y⁴²

| Branched and Saturated | Branched and Unsaturated |
|---|---|
| —CH(CH₃)₂ | —CH═CH—CH(CH₃)₂ |
| —C₄H₈—CH(CH₃)₂ | —CH═CH—C₃H₆—CH(CH₃)₂ |
| —C₉H₁₈—CH(CH₃)₂ | —CH═CH—C₉H₁₈—CH(CH₃)₂ |
| —C₁₄H₂₈—CH(CH₃)₂ | —CH═CH—C₁₅H₃₀—CH(CH₃)₂ |
| —C₁₇H₃₄—CH(CH₃)₂ | —CH═CH—C(CH₃)₃ |
| —C(CH₃)₃ | —CH═CH—C₃H₆—C(CH₃)₃ |
| —C₆H₁₂—C(CH₃)₃ | —CH═CH—C₈H₁₆—C(CH₃)₃ |
| —C₁₁H₂₂—C(CH₃)₃ | —CH═CH—C₁₄H₂₈—C(CH₃)₃ |
| —C₁₆H₃₂—C(CH₃)₃ | —CH═CH—CH(C₂H₅)₂ |
| —CH₂—CH(C₂H₅)₂ | —CH═CH—CH(C₆H₁₃)₂ |
| —CH₂—CH(C₆H₁₃)₂ | —CH═CH—CH(C₈H₁₇)₂ |
| —CH₂—CH(C₉H₁₉)₂ | —C₂H₄—CH═CH—C₃H₆—CH(CH₃)₂ |
| —CH(CH₃)—C₅H₁₀CH₃ | —C₃H₆—CH═CH—C₅H₁₀—CH(CH₃)₂ |
| —CH(CH₃)—C₁₂H₂₄CH₃ | —C₇H₁₄—CH═CH—C₇H₁₄—CH(CH₃)₂ |
| —CH(CH₃)—C₁₆H₃₂CH₃ | —CH(CH₃)—C₅H₁₀—CH═CH₂ |
| —CH(C₂H₅)—C₃H₆CH₃ | —CH(CH₃)—C₁₆H₃₂—CH═CH₂ |
| —CH(C₂H₅)—C₁₆H₃₂CH₃ | —C₄H₈—CH═CH—C₄H₈—CH═CH—C₄H₈—CH(CH₃)₂ |

n₄₁ represents 1, 2, or 3, preferably 2 or 3, and more preferably 3.

Specific examples of a compound in a case where n₄₁=2 in the general formula (P1) include “Irgafos 38” (bis(2,4-di-t-butyl-6-methylphenyl)-ethyl-phosphite) manufactured by BASF SE.

In a case where n₄₁=3 in the general formula (P1), the compound represented by the general formula (P1) is a compound represented by the following general formula (P1-a).

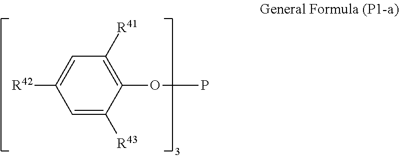

R⁴¹, R⁴², and R⁴³ in the general formula (P1-a) have the same meanings as R⁴¹, R⁴², and R⁴³ in the general formula (P1).

Specific examples of the compound represented by the general formula (P1-a) include “Irgafos 168” manufactured by BASF SE and “Irgafos TNPP” manufactured by BASF SE.

Examples of the phosphite compound include a compound represented by the following general formula (P2).

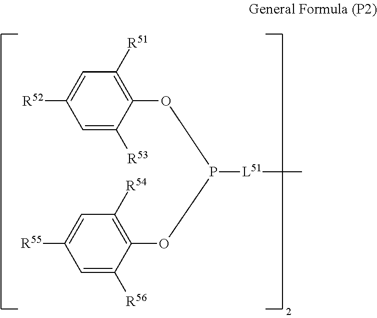

In the general formula (P2), each of R⁵¹, R⁵², R⁵³, R⁵⁴, R⁵⁵, and R⁵⁶ independently represents a hydrogen atom or an alkyl group having 1 to 12 carbon atoms, and L⁵¹ represents a single bond or a divalent linking group.

The alkyl group having 1 to 12 carbon atoms represented by R⁵¹ is preferably an alkyl group having 1 to 10 carbon atoms, and more preferably an alkyl group having 1 to 9 carbon atoms. The alkyl group having 1 to 12 carbon atoms represented by R⁵¹ may be linear, branched, or cyclic, but is preferably a linear or branched alkyl group.

Specific examples of the alkyl group having 1 to 12 carbon atoms represented by R⁵¹ include a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a tert-decyl group, an n-undecyl group, an isoundecyl group, a sec-dodecyl group, a tert-dodecyl group, an n-dodecyl group, an isododecyl group, a sec-dodecyl group, and a tert-dodecyl group.

Examples of the alkyl group having 1 to 12 carbon atoms represented by R⁵² include the same forms as the alkyl group described for R⁵¹.

Examples of the alkyl group having 1 to 12 carbon atoms represented by R⁵³ include the same forms as the alkyl group described for R⁵¹.

Examples of the alkyl group having 1 to 12 carbon atoms represented by R⁵⁴ include the same forms as the alkyl group described for R⁵¹.

Examples of the alkyl group having 1 to 12 carbon atoms represented by R⁵⁵ include the same forms as the alkyl group described for R⁵¹.

Examples of the alkyl group having 1 to 12 carbon atoms represented by R⁵⁶ include the same forms as the alkyl group described for R⁵¹

The group represented by R⁵¹ is preferably a hydrogen atom, a methyl group, or a tert-butyl group.

The group represented by R⁵² is preferably an alkyl group having 1 to 9 carbon atoms, more preferably a methyl group or a tert-butyl group, and still more preferably a tert-butyl group.

The group represented by R⁵³ is preferably a hydrogen atom, a methyl group, or a tert-butyl group.

The group represented by R⁵⁴ is preferably a hydrogen atom, a methyl group, or a tert-butyl group.

The group represented by R⁵⁵ is preferably an alkyl group having 1 to 9 carbon atoms, more preferably a methyl group or a tert-butyl group, and still more preferably a tert-butyl group.

The group represented by R⁵⁶ is preferably a hydrogen atom, a methyl group, or a tert-butyl group.

Examples of the divalent linking group represented by L⁵¹ include an alkylene group and an arylene group, preferably an alkylene group having 1 to 6 carbon atoms or a phenylene group, and more preferably an alkylene group having 1 to 4 carbon atoms or a phenylene group.

Specific examples of the compound represented by the general formula (P2) include “Irgafos P-EPQ” manufactured by BASF SE.

Examples of the phosphite compound include a compound represented by the following general formula (P3).

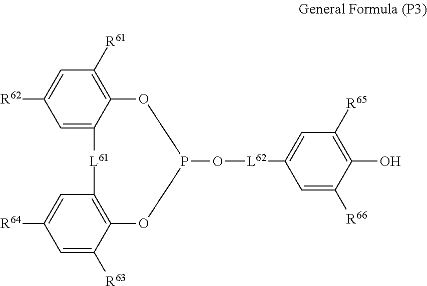

In the general formula (P3), each of R⁶¹, R⁶², R⁶³, R⁶⁴, R⁶⁵, and R⁶⁶ independently represents a hydrogen atom or an alkyl group having 1 to 12 carbon atoms, and each of L⁶¹ and L⁶² independently represents a single bond or a divalent linking group.

The alkyl group having 1 to 12 carbon atoms represented by R⁶¹ is preferably an alkyl group having 1 to 10 carbon atoms, and more preferably an alkyl group having 1 to 9 carbon atoms. The alkyl group having 1 to 12 carbon atoms represented by R⁶¹ may be linear, branched, or cyclic, but is preferably a linear or branched alkyl group.

Specific examples of the alkyl group having 1 to 12 carbon atoms represented by R⁶¹ include a methyl group, an ethyl group, an n-propyl group, an isopropyl group, an n-butyl group, a sec-butyl group, an isobutyl group, a tert-butyl group, an n-pentyl group, an isopentyl group, a neopentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a tert-decyl group, an n-undecyl group, an isoundecyl group, a sec-dodecyl group, a tert-dodecyl group, an n-dodecyl group, an isododecyl group, a sec-dodecyl group, and a tert-dodecyl group.

Examples of the alkyl group having 1 to 12 carbon atoms represented by R⁶² include same forms as the alkyl group described for R⁶¹.

Examples of the alkyl group having 1 to 12 carbon atoms represented by R⁶³ include the same forms as the alkyl group described for R⁶¹.

Examples of the alkyl group having 1 to 12 carbon atoms represented by R⁶⁴ include the same forms as the alkyl group described for R⁶¹.

Examples of the alkyl group having 1 to 12 carbon atoms represented by R⁶⁵ include the same forms as the alkyl group described for R⁶¹.

Examples of the alkyl group having 1 to 12 carbon atoms represented by R⁶⁶ include the same forms as the alkyl group described for R⁶¹

The group represented by R⁶¹ is preferably a hydrogen atom, a methyl group, or a tert-butyl group.

The group represented by R⁶² is preferably an alkyl group having 1 to 9 carbon atoms, more preferably a methyl group or a tert-butyl group, and still more preferably a tert-butyl group.

The group represented by R⁶³ is preferably a hydrogen atom, a methyl group, or a tert-butyl group.

The group represented by R⁶⁴ is preferably an alkyl group having 1 to 9 carbon atoms, more preferably a methyl group or a tert-butyl group, and still more preferably a tert-butyl group.

The group represented by R⁶⁵ is preferably a hydrogen atom, a methyl group, a tert-butyl group, or a tert-pentyl group.

The group represented by R⁶⁶ is preferably a hydrogen atom, a methyl group, a tert-butyl group, or a tert-pentyl group.

At least one of R⁶⁵ and R⁶⁶ is preferably an alkyl group, and the alkyl group is preferably a tert-butyl group or a tert-pentyl group.

Examples of the divalent linking group represented by L⁶¹ include an alkylene group, preferably an alkylene group having 1 to 3 carbon atoms, and more preferably an alkylene group having 1 or 2 carbon atoms.

L⁶¹ is particularly preferably a single bond or a methylene group.

Examples of the divalent linking group represented by L⁶² include an alkylene group and an arylene group, preferably an alkylene group having 1 to 6 carbon atoms or a phenylene group, and more preferably an alkylene group having 1 to 4 carbon atoms or a phenylene group.

Specific examples of the compound represented by the general formula (P3) include “Sumilizer GP” manufactured by Sumitomo Chemical Co., Ltd.

### —Hydroxylamine Compound—

In the exemplary embodiment, the hydroxylamine compound refers to a compound having a structure in which at least one hydroxy group directly bonds to a nitrogen atom of the amine. The hydroxylamine compound is preferably N,N-dialkylhydroxylamine.

Examples of the hydroxylamine compound include a compound represented by the following general formula (HA1).

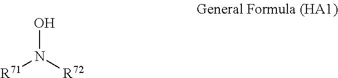

Each of R⁷¹ and R⁷² in the general formula (HA1) independently represents an alkyl group having 14 to 20 carbon atoms.

The alkyl group having 14 to 20 carbon atoms represented by R⁷¹ may be a linear alkyl group, a branched alkyl group, or an alicyclic alkyl group, but is preferably a linear or branched alkyl group, and more preferably a linear alkyl group.

In a case where the alkyl group having 14 to 20 carbon atoms represented by R⁷¹ is branched, the number of branched chains in the group is preferably 1 or more and 3 or less, more preferably 1 or 2, and still more preferably 1.

The alkyl group having 14 to 20 carbon atoms represented by R⁷¹ is preferably a linear or branched alkyl group having 16 to 18 carbon atoms, and particularly preferably a linear alkyl group having 16 to 18 carbon atoms.

Specific forms and preferable forms of the group represented by R⁷² are the same as forms described for R⁷¹.

Specific examples of the alkyl group having 14 to 20 carbon atoms represented by R⁷¹ and R⁷² are shown below.

R⁷¹, R⁷²

| Linear | Branched | |
|---|---|---|
| —C₁₃H₂₆CH₃ | —C₁₁H₂₂—CH(CH₃)₂ | —CH(CH₃)—C₁₁H₂₂CH₃ |
| —C₁₄H₂₈CH₃ | —C₁₃H₂₆—CH(CH₃)₂ | —CH(CH₃)—C₁₃H₂₆CH₃ |
| —C₁₅H₃₀CH₃ | —C₁₄H₂₈—CH(CH₃)₂ | —CH(CH₃)—C₁₄H₂₈CH₃ |
| —C₁₆H₃₂CH₃ | —C₁₅H₃₀—CH(CH₃)₂ | —CH(CH₃)—C₁₅H₃₀CH₃ |
| —C₁₇H₃₄CH₃ | —C₁₇H₃₄—CH(CH₃)₂ | —CH(CH₃)—C₁₇H₃₄CH₃ |
| —C₁₈H₃₆CH₃ | —C₁₀H₂₀—C(CH₃)₃ | —CH₂—CH(CH₃)—C₁₀H₂₀CH₃ |
| —C₁₉H₃₈CH₃ | —C₁₂H₂₄—C(CH₃)₃ | —CH₂—CH(CH₃)—C₁₂H₂₄CH₃ |
| | —C₁₄H₂₈—C(CH₃)₃ | —CH₂—CH(CH₃)—C₁₄H₂₈CH₃ |
| | —C₁₆H₃₂—C(CH₃)₃ | —CH₂—CH(CH₃)—C₁₆H₃₂CH₃ |

—C₃H₆—CH(CH₃)—C₃H₆—CH(CH₃)—C₅H₁₀CH₃
—C₃H₆—CH(CH₃)—C₃H₆—CH(CH₃)—C₇H₁₄CH₃

Specific examples of the compound represented by the general formula (HA1) include “Irgastab FS-042” manufactured by BASF SE.

The compound (G) may be used alone or in combination of two or more thereof. A form in which two or more are used in combination may be a form in which two or more in the same group (for example, in a hindered phenol compound) are used in combination, or a form in which two or more over different groups (for example, a hindered phenol compound and a tocopherol compound) are used in combination.

The form in which two or more are used in combination is preferably a form in which at least one selected from the group consisting of a hindered phenol compound and a hydroxylamine compound and at least one selected from a phosphite compound are used in combination.

### (Ester Compound (H): Component (H))

The resin composition according to the exemplary embodiment may further contain a specific ester compound (H).

The specific ester compound (H) is at least one selected from the group consisting of a compound represented by a general formula (1), a compound represented by a general formula (2), a compound represented by a general formula (3), a compound represented by a general formula (4), and a compound represented by a general formula (5).

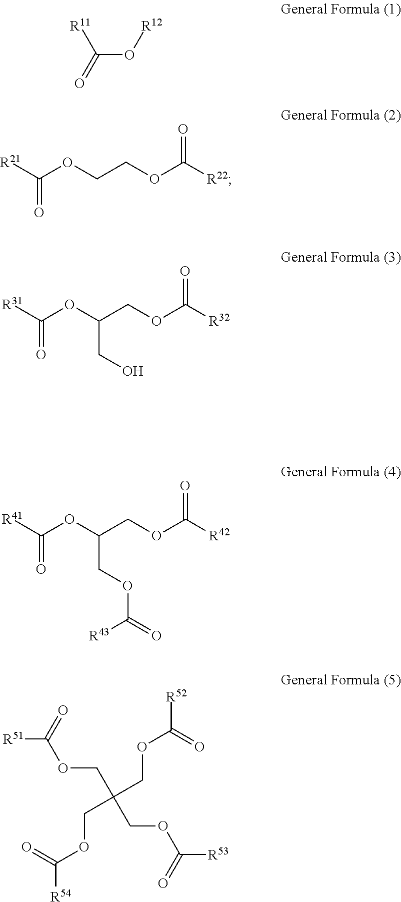

In the general formula (1), R¹¹ represents an aliphatic hydrocarbon group having 7 to 28 carbon atoms, and R¹² represents an aliphatic hydrocarbon group having 9 to 28 carbon atoms.

In the general formula (2), each of R²¹ and R²² independently represents an aliphatic hydrocarbon group having 7 to 28 carbon atoms.

In the general formula (3), each of R³¹ and R³² independently represents an aliphatic hydrocarbon group having 7 to 28 carbon atoms.

In the general formula (4), each of R⁴¹ R⁴², and R⁴³ independently represents an aliphatic hydrocarbon group having 7 to 28 carbon atoms.

In the general formula (5), each of R⁵¹, R⁵², R⁵³, and R⁵⁴ independently represents an aliphatic hydrocarbon group having 7 to 28 carbon atoms.

R¹¹ represents an aliphatic hydrocarbon group having 7 to 28 carbon atoms. The group represented by R¹¹ is preferably an aliphatic hydrocarbon group having 9 or more carbon atoms, more preferably an aliphatic hydrocarbon group having 10 or more carbon atoms, and still more preferably an aliphatic hydrocarbon group having 15 or more carbon atoms. The group represented by R¹¹ is preferably an aliphatic hydrocarbon group having 24 or less carbon atoms, more preferably an aliphatic hydrocarbon group having 20 or less carbon atoms, and still more preferably an aliphatic hydrocarbon group having 18 or less carbon atoms. The group represented by R¹¹ is particularly preferably an aliphatic hydrocarbon group having 17 carbon atoms.

The group represented by R¹¹ may be a saturated aliphatic hydrocarbon group or an unsaturated aliphatic hydrocarbon group. The group represented by R¹¹ is preferably a saturated aliphatic hydrocarbon group.

The group represented by R¹¹ may be a linear aliphatic hydrocarbon group, a branched aliphatic hydrocarbon group, or an aliphatic hydrocarbon group containing an alicyclic ring. The group represented by R¹¹ is preferably an aliphatic hydrocarbon group containing no alicyclic ring (that is, a chain aliphatic hydrocarbon group), and more preferably a linear aliphatic hydrocarbon group.

In a case where the group represented by R¹¹ is an unsaturated aliphatic hydrocarbon group, the number of unsaturated bonds in the group is preferably 1 or more and 3 or less, more preferably 1 or more and 2 or less, and still more preferably 1.

In the case where the group represented by R¹¹ is an unsaturated aliphatic hydrocarbon group, in the group, a linear saturated hydrocarbon chain having 5 to 24 carbon atoms is preferable, a linear saturated hydrocarbon chain having 7 to 22 carbon atoms is more preferable, a linear saturated hydrocarbon chain having 9 to 20 carbon atoms is still more preferable, and a linear saturated hydrocarbon chain having 15 to 18 carbon atoms is particularly preferable.

In a case where the group represented by R¹¹ is a branched aliphatic hydrocarbon group, the number of branched bonds in the group is preferably 1 or more and 3 or less, more preferably 1 or more and 2 or less, and still more preferably 1.

In a case where the group represented by R¹¹ is a branched aliphatic hydrocarbon group, a main chain of the group preferably has 5 to 24 carbon atoms, more preferably has 7 to 22 carbon atoms, still more preferably has 9 to 20 carbon atoms, and particularly preferably has 15 to 18 carbon atoms.

In a case where the group represented by R¹¹ is an aliphatic hydrocarbon group containing an alicyclic ring, the number of alicyclic rings in the group is preferably 1 or 2, and more preferably 1.

In the case where the group represented by R¹¹ is an aliphatic hydrocarbon group containing an alicyclic ring, the alicyclic group in the group is preferably an alicyclic group having 3 or 4 carbon atoms, and more preferably an alicyclic group having 3 carbon atoms.

In view of the surface glossiness of the resin molded body, the group represented by R¹¹ is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and particularly preferably a linear saturated aliphatic hydrocarbon group. The preferable number of carbons in these aliphatic hydrocarbon groups are as described above.

The group represented by R¹¹ may be a group in which a hydrogen atom in the aliphatic hydrocarbon group is substituted with a halogen atom (such as a fluorine atom, a bromine atom, and an iodine atom), an oxygen atom, a nitrogen atom, or the like, preferably not substituted.

R¹² represents an aliphatic hydrocarbon group having 9 or 28 carbon atoms. Examples of the group represented by R¹² include groups same as the group described for R¹¹. However, a number of carbon atoms in the group represented by R¹² is preferably as follows.

The group represented by R¹² is preferably an aliphatic hydrocarbon group having 10 or more carbon atoms, more preferably an aliphatic hydrocarbon group having 11 or more carbon atoms, and still more preferably an aliphatic hydrocarbon group having 16 or more carbon atoms. The group represented by R¹² is preferably an aliphatic hydrocarbon group having 24 or less carbon atoms, more preferably an aliphatic hydrocarbon group having 20 or less carbon atoms, and still more preferably an aliphatic hydrocarbon group having 18 or less carbon atoms. The group represented by R¹² is particularly preferably an aliphatic hydrocarbon group having 18 carbon atoms.

In view of the surface glossiness of the resin molded body, the group represented by R¹² is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and particularly preferably a linear saturated aliphatic hydrocarbon group. The preferable numbers of carbon atoms in these aliphatic hydrocarbon groups are as described above.

Specific forms and preferable forms of the groups represented by R²¹, R²², R³¹, R³², R⁴¹, R⁴², R⁴³, R⁵¹, R⁵², R⁵³, and R⁵⁴ are the same as the forms described for R¹¹.

Specific examples of the aliphatic hydrocarbon group having 7 to 28 carbon atoms represented by R¹¹, R²¹, R²², R³¹, R³², R⁴¹, R⁴², R⁴³, R⁵¹, R⁵², R⁵³, and R⁵⁴ and specific examples of the aliphatic hydrocarbon group having 9 or 28 carbon atoms represented by R¹² are shown below, but the exemplary embodiment is not limited to these.

R¹¹, R¹², R²¹, R²², R³¹, R³², R⁴¹, R⁴², R⁴³, R⁵¹, R⁵², R⁵³, R⁵⁴
Linear and saturated

| | | |
|---|---|---|
| —C₆H₁₂CH₃ | —C₁₂H₂₄CH₃ | —C₁₉H₃₈CH₃ |
| —C₇H₁₄CH₃ | —C₁₄H₂₈CH₃ | —C₂₀H₄₀CH₃ |
| —C₈H₁₆CH₃ | —C₁₅H₃₀CH₃ | —C₂₁H₄₂CH₃ |
| —C₉H₁₈CH₃ | —C₁₆H₃₂CH₃ | —C₂₃H₄₆CH₃ |
| —C₁₀H₂₀CH₃ | —C₁₇H₃₄CH₃ | —C₂₅H₅₀CH₃ |
| —C₁₁H₂₂CH₃ | —C₁₈H₃₆CH₃ | —C₂₇H₅₄CH₃ |

R¹¹, R¹², R²¹, R²², R³¹, R³², R⁴¹, R⁴², R⁴³, R⁵¹, R⁵², R⁵³, R⁵⁴
Linear and unsaturated

| | |
|---|---|
| —CH═CH—C₄H₈CH₃ | —C₂H₄—CH═CH—C₂H₄CH₃ |
| —CH═CH—C₆H₁₂CH₃ | —C₄H₁₈—CH═CH—C₄H₈CH₃ |
| —CH═CH—C₈H₁₆CH₃ | —C₅H₁₀—CH═CH—C₅H₁₀CH₃ |
| —CH═CH—C₁₄H₂₈CH₃ | —C₆H₁₂—CH═CH—C₆H₁₂CH₃ |
| —CH═CH—C₁₅H₃₀CH₃ | —C₇H₁₄—CH═CH—C₃H₆CH₃ |
| —CH═CH—C₁₆H₃₂CH₃ | —C₇H₁₄—CH═CH—C₅H₁₀CH₃ |
| —CH═CH—C₁₇H₃₄CH₃ | —C₇H₁₄—CH═CH—C₇H₁₄CH₃ |
| —CH═CH—C₁₈H₃₆CH₃ | —C₇H₁₄—CH═CH—C₈H₁₆CH₃ |
| —CH═CH—C₂₀H₄₀CH₃ | —C₇H₁₄—CH═CH—C₉H₁₈CH₃ |
| —CH═CH—C₂₅H₅₀CH₃ | —C₈H₁₆—CH═CH—C₈H₁₆CH₃ |
| —C₅H₁₀—CH═CH₂ | —C₉H₁₈—CH═CH—C₅H₁₀CH₃ |
| —C₇H₁₄—CH═CH₂ | —C₉H₁₈—CH═CH—C₇H₁₄CH₃ |
| —C₁₅H₃₀—CH═CH₂ | —C₁₀H₂₀—CH═CH—C₁₂H₂₄CH₃ |
| —C₁₆H₃₂—CH═CH₂ | —C₁₀H₂₀—CH═CH—C₁₅H₃₀CH₃ |
| —C₁₇H₃₄—CH═CH₂ | —C₁₁H₂₂—CH═CH—C₇H₁₄CH₃ |
| —C₁₈H₃₆—CH═CH₂ | —C₁₂H₂₄—CH═CH—C₁₂H₂₄CH₃ |
| —C₂₁H₄₂—CH═CH₂ | —C₁₃H₂₆—CH═CH—C₇H₁₄CH₃ |
| —C₂₆H₅₂—CH═CH₂ | —CH₂—CH═CH—C₇H₁₄—CH═CH—C₇H₁₄CH₃ |
| —CH₂—CH═CH—C₃H₆CH₃ | —C₇H₁₄—CH═CH—CH₂—CH═CH—C₄H₈CH₃ |
| —CH₂—CH═CH—C₇H₁₄CH₃ | —C₇H₁₄—CH═CH—C₇H₁₄—CH═CH—C₇H₁₄CH₃ |
| —CH₂—CH═CH—C₁₀H₂₀CH₃ | —C₇H₁₄—CH═CH—C₉H₁₈—CH═CH—C₇H₁₄CH₃ |
| —CH₂—CH═CH—C₁₆H₃₂CH₃ | —C₇H₁₄—CH═CH—CH₂—CH═CH—CH₂—CH═CH—CH₂CH₃ |
| —CH₂—CH═CH—C₂₄H₄₈CH₃ | —CH═CH—C₇H₁₄—CH═CH—C₇H₁₄—CH═CH—C₇H₁₄CH₃ |

R¹¹, R¹², R²¹, R²², R³¹, R³², R⁴¹, R⁴², R⁴³, R⁵¹, R⁵², R⁵³, R⁵⁴
Branched and saturated

| | |
|---|---|
| —C₅H₁₀—CH(CH₃)₂ | —CH(C₂H₅)—C₇H₁₄CH₃ |
| —C₁₀H₂₀—CH(CH₃)₂ | —CH(C₂H₅)—C₁₄H₂₈CH₃ |
| —C₁₄H₂₈—CH(CH₃)₂ | —CH(C₂H₅)—C₁₆H₃₂CH₃ |
| —C₁₅H₃₀—CH(CH₃)₂ | —CH(C₂H₅)—C₁₈H₃₆CH₃ |
| —C₁₆H₃₂—CH(CH₃)₂ | —CH(C₄H₉)—C₁₅H₃₀CH₃ |
| —C₁₇H₃₄—CH(CH₃)₂ | —CH(C₆H₁₃)—C₁₂H₂₄CH₃ |
| —C₂₀H₄₀—CH(CH₃)₂ | —CH(C₆H₁₃)—C₁₄H₂₈CH₃ |
| —C₂₅H₅₀—CH(CH₃)₂ | —CH(C₆H₁₃)—C₁₆H₃₂CH₃ |
| —C₆H₁₂—C(CH₃)₃ | —CH₂—CH(CH₃)—C₃H₆CH₃ |
| —C₁₀H₂₀—C(CH₃)₃ | —CH₂—CH(CH₃)—C₆H₁₂CH₃ |
| —C₁₄H₂₈—C(CH₃)₃ | —CH₂—CH(CH₃)—C₈H₁₆CH₃ |
| —C₁₅H₃₀—C(CH₃)₃ | —CH₂—CH(CH₃)—C₁₂H₂₄CH₃ |
| —C₁₆H₃₂—C(CH₃)₃ | —CH₂—CH(CH₃)—C₁₆H₃₂CH₃ |
| —CH(CH₃)—C₅H₁₀CH₃ | —CH₂—CH(CH₃)—C₂₀H₄₀CH₃ |
| —CH(CH₃)—C₁₀H₂₀CH₃ | —CH₂—CH(CH₃)—C₂₄H₄₈CH₃ |
| —CH(CH₃)—C₁₃H₂₆CH₃ | —CH₂—CH(C₆H₁₃)₂ |
| —CH(CH₃)—C₁₄H₂₈CH₃ | —CH₂—CH(C₆H₁₃)—C₇H₁₄CH₃ |
| —CH(CH₃)—C₁₅H₃₀CH₃ | —CH₂—CH(C₆H₁₃)—C₉H₁₈CH₃ |
| —CH(CH₃)—C₁₆H₃₂CH₃ | —CH₂—CH(C₆H₁₃)—C₁₂H₂₄CH₃ |
| —CH(CH₃)—C₁₇H₃₄CH₃ | —CH₂—CH(C₆H₁₃)—C₁₅H₃₀CH₃ |
| —CH(CH₃)—C₁₈H₃₆CH₃ | —CH₂—CH(C₈H₁₇)—C₁₉H₃₈CH₃ |
| —CH(CH₃)—C₂₂H₄₄CH₃ | —CH₂—CH(C₈H₁₇)—C₉H₁₈CH₃ |
| —CH(CH₃)—C₂₅H₅₀CH₃ | —CH₂—CH(C₁₀H₂₁)—C₁₂H₂₄CH₃ |

—C₂H₄—CH(CH₃)—C₃H₆—CH(CH₃)—C₃H₆—CH(CH₃)—C₃H₆—CH(CH₃)₂

R¹¹, R¹², R²¹, R²², R³¹, R³², R⁴¹, R⁴², R⁴³, R⁵¹, R⁵², R⁵³, R⁵⁴
Branched and unsaturated

| | |
|---|---|
| —CH═CH—C₅H₁₀—CH(CH₃)₂ | —CH₂—CH═CH—CH(CH₃)—CH₂CH₃ |
| —CH═CH—C₁₂H₂₄—CH(CH₃)₂ | —CH₂—CH═CH—CH(CH₃)—C₃H₆CH₃ |
| —CH═CH—C₁₅H₃₀—CH(CH₃)₂ | —CH₂—CH═CH—CH(CH₃)—C₇H₁₄CH₃ |
| —CH═CH—C₁₆H₃₂—CH(CH₃)₂ | —CH₂—CH═CH—CH(CH₃)—C₁₆H₃₂CH₃ |
| —CH═CH—C₁₈H₃₆—CH(CH₃)₂ | —CH₂—CH═CH—CH(CH₃)—C₂₂H₄₄CH₃ |
| —CH═CH—C₂₃H₄₆—CH(CH₃)₂ | —CH₂—CH═CH—CH₂—CH(CH₃)—CH₂CH₃ |
| —CH═CH—C₇H₁₄—C(CH₃)₃ | —CH₂—CH═CH—C₂H₄—CH(CH₃)—C₂H₄CH₃ |
| —CH═CH—C₁₂H₂₄—C(CH₃)₃ | —CH₂—CH═CH—C₂H₄—CH(CH₃)—C₄H₈CH₃ |
| —CH═CH—C₁₄H₂₈—C(CH₃)₃ | —CH₂—CH═CH—C₆H₁₂—CH(CH₃)—C₆H₁₂CH₃ |
| —CH—CH—C₁₆H₃₂—C(CH₃)₃ | —CH₂—CH═CH—C₇H₁₄—CH(CH₃)—C₇H₁₄CH₃ |
| —CH—CH—C₂₀H₄₀—C(CH₃)₃ | —CH₂—CH═CH—C₇H₁₄—CH(CH₃)—C₈H₁₆CH₃ |
| —CH═CH—CH(C₈H₁₇)₂ | —CH₂—CH═CH—CH₂—CH═CH—CH(CH₃)—C₃H₆CH₃ |
| —CH═CH—CH(C₆H₁₃)—C₇H₁₄CH₃ | —CH₂—CH═CH—CH₂—CH═CH—CH(CH₃)—C₇H₁₄CH₃ |
| —CH═CH—CH(C₆H₁₃)—C₁₁H₂₂CH₃ | —CH₂—CH═CH—CH₂—CH═CH—CH(CH₃)—C₁₆H₃₂CH₃ |
| —CH═CH—CH(C₈H₁₇)—C₉H₁₈ CH₃ | —CH₂—CH═CH—CH(CH₃)—CH═CH—CH₂—C₃H₆CH₃ |
| —CH═CH—CH(C₈H₁₇)—C₁₂H₂₄CH₃ | —CH₂—CH═CH—CH(CH₃)—CH═CH—CH₂—C₇H₁₄CH₃ |
| —C₃H₆—CH═CH—C₅H₁₀—CH(CH₃)₂ | —CH₂—CH═CH—CH(C₂H₅)—CH═CH—CH₂—C₇H₁₄CH₃ |
| —C₇H₁₄—CH═CH—C₆H₁₂—CH(CH₃)₂ | —CH₂—CH═CH—CH(CH₃)—CH═CH—CH₂—C₁₆H₃₂CH₃ |
| —C₇H₁₄—CH═CH—C₇H₁₄—CH(CH₃)₂ | —CH₂—CH═CH—CH(C₂H₅)—CH═CH—CH₂—C₁₆H₃₂CH₃ |
| —C₈H₁₆—CH═CH—C₆H₁₂—CH(CH₃)₂ | —CH₂—CH═CH—CH(CH₃)—CH═CH—CH₂—C₁₉H₃₈CH₃ |
| —C₈H₁₆—CH═CH—C₇H₁₄—CH(CH₃)₂ | —CH₂—CH═CH—CH(CH₃)—CH═CH—CH(CH₃)—CH₂CH₃ |
| —CH(CH₃)—C₁₄H₂₈—CH═CH₂ | —CH₂—CH═CH—CH(CH₃)—CH═CH—CH(CH₃)—C₃H₆CH₃ |
| —CH(CH₃)—C₁₆H₃₂—CH═CH₂ | —CH₂—CH═CH—CH(CH₃)—CH═CH—CH(CH₃)—C₇H₁₄CH₃ |
| —CH(C₂H₅)—C₁₄H₂₈—CH═CH₂ | —CH₂—CH═CH—CH(C₂H₅)—CH═CH—CH(C₂H₅)—C₇H₁₄CH₃ |
| —CH(C₂H₅)—C₁₆H₃₂—CH═CH₂ | —CH₂—CH═CH—CH(CH₃)—CH═CH—CH(CH₃)—C₁₂H₂₄CH₃ |
| —CH(C₄H₉)—C₁₄H₂₈—CH═CH₂ | —CH₂—CH═CH—CH(CH₃)—CH═CH—CH(CH₃)—C₁₅H₃₀CH₃ |
| —CH(C₆H₁₃)—C₁₀H₂₀—CH═CH₂ | —CH₂—CH═CH—CH(CH₃)—CH═CH—CH(CH₃)—C₁₈H₃₆ CH₃ |
| —CH(C₆H₁₃)—C₁₂H₂₄—CH═CH₂ | —C₄H₈—CH═CH—C₄H₈—CH═CH—C₄H₈—CH(CH₃)₂ |
| —CH₂—CH(C₆H₁₃)—C₇H₁₄—CH═CH₂ | —C₇H₁₄—CH═CH—C₇H₁₄—CH═CH—C₇H₁₄—CH(CH₃)₂ |

The ester compound (H) may be used alone or in combination of two or more thereof.

### [Content or Content Ratio of Component (A) to Component (F)]

The resin composition according to the exemplary embodiment contains the component (A), the component (B), and the component (C), and contains the component (D), the component (E), and the component (F) if necessary. A content or content ratio (all on a mass basis.) of each component in the resin composition according to the exemplary embodiment is preferably in the following range in view of the surface glossiness of the resin molded body.

An abbreviation of each component is as follows.

Cellulose acylate (A): Component (A)

Thermoplastic elastomer (B): Component (B)

Particles (C) of organic compound containing two or more nitrogen atoms in the molecule: Component (C)

Plasticizer (D): Component (D)

Polyester resin (E): Component (E)

Poly (meth)acrylate compound (F): Component (F)

The content of the component (A) in the resin composition according to the exemplary embodiment is preferably 50 mass % or more, more preferably 60 mass % or more, and still more preferably 70 mass % or more with respect to total mass of the resin composition.

The content of the component (B) in the resin composition according to the exemplary embodiment is preferably 0.5 mass % or more and 20 mass % or less, more preferably 3 mass % or more and 20 mass % or less, and still more preferably 5 mass % or more and 9 mass % or less with respect to the total mass of the resin composition.

The content of the component (C) in the resin composition according to the exemplary embodiment is preferably 0.03 mass % or more and 5 mass % or less, more preferably 0.1 mass % or more and 3.0 mass % or less, and still more preferably 0.3 mass % or more and 1.5 mass % or less with respect to the total mass of the resin composition.

The content of the component (D) in the resin composition according to the exemplary embodiment is preferably 0 mass % or more and 25 mass % or less, more preferably 3 mass % or more and 15 mass % or less, and still more preferably 5 mass % or more and 10 mass % or less with respect to the total mass of the resin composition.

The content of the component (E) in the resin composition according to the exemplary embodiment is preferably 0 mass % or more and 15 mass % or less, more preferably 0 mass % or more and 10 mass % or less, and still more preferably 0 mass % or more and 6 mass % or less with respect to the total mass of the resin composition.

The content of the component (F) in the resin composition according to the exemplary embodiment is preferably 0 mass % or more and 15 mass % or less, more preferably 0 mass % or more and 10 mass % or less, and still more preferably 0 mass % or more and 6 mass % or less with respect to the total mass of the resin composition.

The content ratio of the component (B) to the component (A) is preferably 0.025≤(B)/(A)≤0.3, more preferably 0.04≤(B)/(A)≤0.2, and still more preferably 0.07≤(B)/(A)≤0.15.

The content ratio of the component (C) to the component (A) is preferably 0.001≤(C)/(A)≤0.06, more preferably 0.002≤(C)/(A)≤0.04, and still more preferably 0.004≤(C)/(A)≤0.02.

The content ratio of the component (D) to the component (A) is preferably 0≤(D)/(A)≤0.35, more preferably 0.025≤(D)/(A)≤0.2, and still more preferably 0.05≤(D)/(A)≤0.15.

The content ratio of the component (E) to the component (A) is preferably 0≤(E)/(A)≤0.15, more preferably 0≤(E)/(A)≤0.10, and still more preferably 0≤(E)/(A)≤0.06.

The content ratio of the component (F) to the component (A) is preferably 0≤(F)/(A)≤0.15, more preferably 0≤(F)/(A)≤0.10, and still more preferably 0≤(F)/(A)≤0.06.

A content or content ratio of other additives is preferably in the following range. An abbreviation of each component is as follows.

Ester compound (G): Component (G)

At least one compound (G) selected from the group consisting of a hindered phenol compound, a tocopherol compound, a tocotrienol compound, a phosphite compound, and a hydroxylamine compound: Component (G)

The content of the component (G) in the resin composition according to the exemplary embodiment is preferably 0.1 mass % or more and 15 mass % or less, more preferably 0.5 mass % or more and 10 mass % or less, and still more preferably 1 mass % or more and 5 mass % or less with respect to the total mass of the resin composition.

The content ratio of the component (G) to the component (A) is preferably 0.001≤(G)/(A)≤0.15, more preferably 0.005≤(G)/(A)≤0.15, and still more preferably 0.01≤(G)/(A)≤0.07.

The content of the component (H) in the resin composition according to the exemplary embodiment is preferably 0.01 mass % or more and 5 mass % or less, more preferably 0.05 mass % or more and 2 mass % or less, and still more preferably 0.1 mass % or more and 1 mass % or less with respect to the total mass of the resin composition.

The content ratio of the component (H) to the component (A) is preferably 0.0001≤(H)/(A)≤0.075, more preferably 0.0005≤(H)/(A)≤0.03, and still more preferably 0.001≤(H)/(A)≤0.015.

### [Other Components]

The resin composition according to the exemplary embodiment may contain other components.

Examples of other components include a flame retardant, a compatibilizer, an antioxidant, a release agent, a lightproof agent, weatherproof agent, a colorant, a pigment, a modifier, a drip inhibitor, an antistatic agent, a hydrolysis inhibitor, a filler, and a reinforcing agent (such as glass fibers, carbon fibers, talc, clay, mica, glass flakes, milled glass, glass beads, crystalline silica, alumina, silicon nitride, aluminum nitride, and boron nitride).

If necessary, components (additives) such as an acid acceptor for preventing release of acetic acid and a reactive trapping agent may be added. Examples of the acid acceptor include an oxide such as magnesium oxide and aluminum oxide; a metal hydroxide such as magnesium hydroxide, calcium hydroxide, aluminum hydroxide, and hydrotalcite; calcium carbonate; and talc.

Examples of the reactive trapping agent include an epoxy compound, an acid anhydride compound, and a carbodiimide.

A content of each of the components is preferably 0 mass % or more and 5 mass % or less with respect to the total mass of the resin composition. Here, “0 mass %” means that other components are not contained.

The resin composition according to the exemplary embodiment may contain another resin except the resin (cellulose acylate (A) and the like). However, in a case where another resin is contained, a content of the another resin with respect to the total mass of the resin composition may be 5 mass % or less, and is preferably less than 1 mass %. It is more preferable that another resin is not contained (that is, 0 mass %).

Examples of the another resin include a well-known thermoplastic resin, specifically include: a polycarbonate resin; a polypropylene resin; a polyester resin; a polyolefin resin; a polyester carbonate resin; a polyphenylene ether resin; a polyphenylene sulfide resin; a polysulfone resin; a polyether sulfone resin; a polyarylene resin; a polyetherimide resin; a polyacetal resin; a polyvinyl acetal resin; a polyketone resin; a polyetherketone resin; a poly(ether ether ketone) resin; a polyarylketone resin; a polyether nitrile resin; a liquid crystal resin; a polybenzimidazole resin; a polyparabanic acid resin; a vinyl based polymer or copolymer obtained by polymerizing or copolymerizing one or more vinyl monomers selected from the group consisting of an aromatic alkenyl compound, a methacrylate, an acrylate, and a vinyl cyanide compound; a diene-aromatic alkenyl compound copolymer; a vinyl cyanide-diene-aromatic alkenyl compound copolymer; an aromatic alkenyl compound-diene-cyanide vinyl-N-phenylmaleimide copolymer; a vinyl cyanide-(ethylene-diene-propylene (EPDM))-aromatic alkenyl compound copolymer; a vinyl chloride resin; and a chlorinated vinyl chloride resin. These resins may be used alone or in combination of two or more thereof.

### [Method for Producing Resin Composition]

The resin composition according to the exemplary embodiment is manufactured by melting and kneading a mixture containing the cellulose acylate (A), the thermoplastic elastomer (B), the particles (C) of organic compound containing two or more nitrogen atoms in the molecule, other additives (the plasticizer (D), the polyester resin (E), the poly (meth)acrylate compound (F), and the like) if necessary, and other components. Besides, the resin composition according to the exemplary embodiment is also manufactured, for example, by dissolving the components in a solvent.

Examples of a unit for melt kneading include well-known units, specifically include a twin-screw extruder, a Henschel mixer, a Banbury mixer, a single-screw extruder, a multi-screw extruder, and a co-kneader.

### <Resin Molded Body>

The resin molded body according to the exemplary embodiment contains the resin composition according to the exemplary embodiment. That is, the resin molded body according to the exemplary embodiment has the same composition as the resin composition according to the exemplary embodiment.

A method for molding the resin molded body according to the exemplary embodiment is preferably injection molding in terms of high degree of freedom of shape. In terms of this, the resin molded body is preferably an injection molded body obtained by injection molding.

A cylinder temperature in the injection molding is, for example, 160° C. or higher and 280° C. or lower, preferably 180° C. or higher and 260° C. or lower. A mold temperature in the injection molding is, for example, 30° C. or higher and 90° C. or lower, preferably 40° C. or higher and 60° C. or lower.

The injection molding may be performed by using, for example, a commercially available apparatus such as NEX500 manufactured by Nissei Plastic Industrial Co., Ltd., NEX150 manufactured by Nissei Plastic Industrial Co., Ltd., NEX7000 manufactured by Nissei Plastic Industrial Co., Ltd., PNX40 manufactured by Nissei Plastic Industrial Co., Ltd., and SE50D manufactured by Sumitomo Machinery Corp.

The molding method for obtaining the resin molded body according to the exemplary embodiment is not limited to the injection molding described above, and extrusion molding, blow molding, hot press molding, calendar molding, coating molding, cast molding, dipping molding, vacuum forming, transfer molding, or the like may be applied.

The resin molded body according to the exemplary embodiment is suitably used for applications such as electronic/electric equipment, business equipment, home electric appliances, automobile interior materials, toys, containers, carriers, absorbents, and separation membranes. More specifically, housings of electronic/electric equipment and home electric appliances; various parts of electronic/electric equipment and home electric appliances; automobile interior parts; block assembly toys; plastic model kits; storage cases of CD-ROM, DVD, and the like; tableware; beverage bottles; food trays; wrapping materials; films; sheets; catalyst carriers; water absorbing materials; and humidity adjusting materials.

### EXAMPLES

Examples are enumerated below to describe the resin composition and the resin molded body according to the exemplary embodiment in more detail. Materials, use amounts, proportions, processing procedures, and the like shown in the following Examples can be modified as appropriate without departing from the spirit of the invention. Therefore, the resin composition and the resin molded body according to the exemplary embodiment should not be construed as being limited by the following specific examples.

### <Preparation of Materials>

The following materials are prepared.

### [Cellulose Acylate (A)]

CA1: “CAP482-20” manufactured by Eastman Chemical Company, cellulose acetate propionate, weight average polymerization degree: 716, substitution degree of acetyl group: 0.18, substitution degree of propionyl group: 2.49.
CA2: “CAP482-0.5” manufactured by Eastman Chemical Company, cellulose acetate propionate, weight average polymerization degree: 189, substitution degree of acetyl group: 0.18, substitution degree of propionyl group: 2.49.
CA3: “CAP504-0.2” manufactured by Eastman Chemical Company, cellulose acetate propionate, weight average polymerization degree: 133, substitution degree of acetyl group: 0.04, substitution degree of propionyl group: 2.09.
CA4: “CAB171-15” manufactured by Eastman Chemical Company, cellulose acetate butyrate, weight average polymerization degree: 754, substitution degree of acetyl group: 2.07, substitution degree of butyryl group: 0.73.
CA5: “CAB381-20” manufactured by Eastman Chemical Company, cellulose acetate butyrate, weight average polymerization degree: 890, substitution degree of acetyl group: 1.05, substitution degree of butyryl group: 1.74.
CA6: “CAB500-5” manufactured by Eastman Chemical Company, cellulose acetate butyrate, weight average polymerization degree: 625, substitution degree of acetyl group: 0.17, substitution degree of butyryl group: 2.64.
CA7: “L50” manufactured by Daicel Corporation, diacetyl cellulose, weight average polymerization degree: 570.
CA8: “LT-35” manufactured by Daicel Corporation, triacetyl cellulose, weight average polymerization degree: 385.
RC1: “Tenite propionate 360A4000012” manufactured by Eastman Chemical Company, cellulose acetate propionate, weight average polymerization degree: 716, substitution degree of acetyl group: 0.18, substitution degree of propionyl group: 2.49. In the article, dioctyl adipate corresponding to the component (D) is contained, cellulose acetate propionate is 88 mass %, and dioctyl adipate is 12 mass %.
RC3: “Treva GC6021” manufactured by Eastman Chemical Company, cellulose acetate propionate, weight average polymerization degree: 716, substitution degree of acetyl group: 0.18, substitution degree of propionyl group: 2.49. The article contains a chemical substance corresponding to the component (B), and a content thereof is 3 mass % to 10 mass %.

CA1 satisfies the following (2), (3), and (4). CA2 satisfies the following (4). (2) When the CAP is measured by the GPC method using tetrahydrofuran as a solvent, the weight average molecular weight (Mw) in terms of polystyrene is 160,000 or more and 250,000 or less, a ratio Mn/Mz of the number average molecular weight (Mn) in terms of polystyrene to the Z average molecular weight (Mz) in terms of polystyrene is 0.14 or more and 0.21 or less, and a ratio Mw/Mz of the weight average molecular weight (Mw) in terms of polystyrene to the Z average molecular weight (Mz) in terms of polystyrene is 0.3 or more and 0.7 or less. (3) When the CAP is measured by capillography under conditions of 230° C. in accordance with ISO 11443: 1995, a ratio η1/η2 of viscosity η1 (Pa·s) at a shear speed of 1216 (/sec) to viscosity η2 (Pa·s) at a shear speed of 121.6 (/sec) is 0.1 more and 0.3 or less. (4) When a small square plate test piece (D11 test piece specified by JIS K7139: 2009, 60 mm×60 mm, thickness 1 mm) obtained by injection molding of the CAP is left for 48 hours in an atmosphere at a temperature of 65° C. and a relative humidity of 85%, both an expansion rate in an MD direction and an expansion rate in a TD direction are 0.4% or more and 0.6% or less.

### [Thermoplastic Elastomer (B)]

EL1: “METABLEN W-600A” manufactured by Mitsubishi Chemical Corporation, polymer (b1) having core-shell structure
EL2: “METABLEN S-2006” manufactured by Mitsubishi Chemical Corporation, polymer (b1) having core-shell structure
EL3: “PARALOID EXL2315” manufactured by Rohm and Haas, polymer (b1) having core-shell structure
EL4: “Lotryl 29MA03” manufactured by Arkema, olefin polymer (b2)
EL5: “Kane Ace B-564” manufactured by Kaneka, MBS resin, polymer (b3) having core-shell structure
EL6: “Blendex 338” manufactured by Galata Chemicals (Artek), ABS core shell, polymer (b3) having core-shell structure
EL7: “Kraton FG1924G” manufactured by Kraton Corporation, styrene-ethylene-butadiene-styrene copolymer (b4)
EL8: “Estane ALR 72A” manufactured by Lubrizol, polyurethane (b5)
EL9: “Hytrel 3078” manufactured by Du Pont, polyester copolymer, polyester (b6)

### [Organic Compound Particles (C)]

NN1: “Cinquasia Red K 4104” manufactured by BASF SE, C.I.pigment violet 19, quinacridone, number of nitrogen atoms (N number) in molecule: 2, containing N—H bond, molecular weight: 312, particle diameter: 480 nm
NN2: “Paliotol Yellow K 1800” manufactured by BASF SE, C.I.pigment yellow 183, calcium=4,5-dichloro-2-[5-hydroxy-3-methyl-1-(3-sulfonatophenyl)-4-pyrazolyl azo] benzene sulfonate, number of nitrogen atoms (N number) in molecule: 4, containing N═N bond, molecular weight: 521, particle diameter: 650 nm
NN3: “Cromophtal Yellow K 0990” manufactured by BASF SE, C.I.pigment yellow 128, 3,3′-(2-chloro-5-methyl-1,4-phenylene) bis[imino (1-acetyl-2-oxo-2,1-ethanediyl) azo] bis[4-chloro-N-[2-(4-chlorophenoxy)-5-(trifluoromethyl) phenyl] benzamide], number of nitrogen atoms (N number) in molecule: 8, containing N—H bond, containing N═N bond, molecular weight: 1229, particle diameter: 880 nm
NN4: “Oracet Red 344” manufactured by BASF SE, C.I.sorvent red 135, 8,9,10,11-tetrachloro-12H-phthaloperin-12-one, number of nitrogen atoms (N number) in molecule: 2, not containing N═N bond, not containing N—H bond, molecular weight: 408, particle diameter: 300 nm
NN5: “Cromophtal Violet K 5700” manufactured by BASF SE, C.I.pigment violet 37, N,N′-[6,13-bis(acetylamino)-2,9-diethoxy triphenodioxazine-3,10-diyl] bis(benzamide), number of nitrogen atoms (N number) in molecule: 4, containing N—H bond, molecular weight: 727, particle diameter: 480 nm
NN6: “Cromophtal Yellow K 1310” manufactured by BASF SE, C.I.pigment yellow 215, Pyrimido [5,4-g] pteridine-2,4,6,8-tetramine, 4-methylbenzenesulfonate, base-hydrolysed, containing 20% or less of dispersing aid (fatty acid ester), number of nitrogen atoms (N number) in molecule: 10, containing N—H bond, molecular weight: 416, particle diameter: 880 nm
NN7: “Heliogen Blue K 6907” manufactured by BASF SE, C.I.pigment blue 15:1, phthalocyanine copper (α-type), number of nitrogen atoms (N number) in molecule: 8, organometallic compound, molecular weight: 576, particle diameter: 310 nm
NN8: “Paliogen Red K 3911” manufactured by BASF SE, C.I.pigment red 178, 2,9-bis[4-(phenylazo)phenyl] anthra [2,1,9-def: 6,5,10-d′e′f] diisoquinoline-1,3,8,10-tetraone, number of nitrogen atoms (N number) in molecule: 6, containing N═N bond, molecular weight: 751, particle diameter: 570 nm
NN9: “Paliotol Yellow K 0961” manufactured by BASF SE, C.I.pigment yellow 138, 4,5,6,7-tetrachloro-2-[2-[(4, 5,6,7-tetrachloro-2,3-dihydro-1,3-dioxo-1H-indene)-2-yl]-8-quinolinyl]-1H-isoindole-1,3(2H)-dione, number of nitrogen atoms (N number) in molecule: 2, not containing N═N bond, not containing N—H bond, molecular weight: 695, particle diameter: 770 nm
NN10: “Paliotol Yellow K 1841 FP” manufactured by BASF SE, C.I.pigment yellow 139, 5,5′-[1,3-dihydro-2H-isoindole-1,3-diylidene] bis[pyrimidine-2,4,6 (1H, 3H, 5H)-trione], containing 10% of N,N-bis(2-hydroxyethyl) oleamide, number of nitrogen atoms (N number) in molecule: 5, containing N—H bond, molecular weight: 367, particle diameter: 490 nm
NN11: “Irgazin Yellow K 2060” manufactured by BASF SE, C.I.pigment yellow 110, 4,5,6,7-tetrachloro-3-[[4-[(1-oxo-4,5,6,7-tetrachloro-2H-isoindole-3-ylidene) amino] phenyl] imino]-2H-isoindole-1(3H)-one, number of nitrogen atoms (N number) in molecule: 4, containing N—N bond, molecular weight: 642, particle diameter: 520 nm
NN12: “Irgazin Red K 3842” manufactured by BASF SE, C.I.pigment red 254, 3,6-bis(4-chlorophenyl)-2,5-dihydropyrrolo [3,4-c] pyrrole-1,4-dione, number of nitrogen atoms (N number) in molecule: 2, containing N—H bond, molecular weight: 357, particle diameter: 920 nm
NN13: “Oracet Blue 690” manufactured by BASF SE, C.I.sorvent blue 104, 1,4-bis(mesitylamino) anthraquinone, number of nitrogen atoms (N number) in molecule: 2, containing N—H bond, molecular weight: 329, particle diameter: 610 nm
NN14: “Oracet Orange 230” manufactured by BASF SE, C.I.sorvent orange 60, 12H-phthaloperin-12-one, number of nitrogen atoms (N number) in molecule: 2, not containing N═N bond, not containing N—H bond, molecular weight: 270, particle diameter: 290 nm
NN15: “Heliogen Green D 9360” manufactured by BASF SE, C.I.pigment green 36, copper compound pigment green 36, number of nitrogen atoms (N number) in molecule: 8, organometallic compound, molecular weight: 1394, particle diameter: 520 nm
NN16: “Heliogen Blue K 6902” manufactured by BASF SE, pigment blue 15:1, phthalocyanine copper (α-type), number of nitrogen atoms (N number) in molecule: 8, organometallic compound, molecular weight: 576, particle diameter: 1150 nm
NN17: “Oracet Violet 580” manufactured by BASF SE, C.I.sorvent violet 13, quinizarin blue, number of nitrogen atoms (N number) in molecule: 1, containing N—H bond, molecular weight: 329, particle diameter: 490 nm
NN18: “Oracet Yellow 125” manufactured by BASF SE, C.I.sorvent yellow 114, 3-hydroxy-2-(3-hydroxy-2-quinolyl)-1H-inden-1-one, number of nitrogen atoms (N number) in molecule: 1, not containing N═N bond, not containing N—H bond, molecular weight: 289, particle diameter: 840 nm
NN19: “Cinquasia Magenta K 4535” manufactured by BASF SE, C.I.pigment red 202, 2,9-dichloroquino [2,3-b] acridine-7,14 (5H, 12H)-dione, number of nitrogen atoms (N number) in molecule: 2, containing N—H bond, molecular weight: 381, particle diameter: 1430 nm

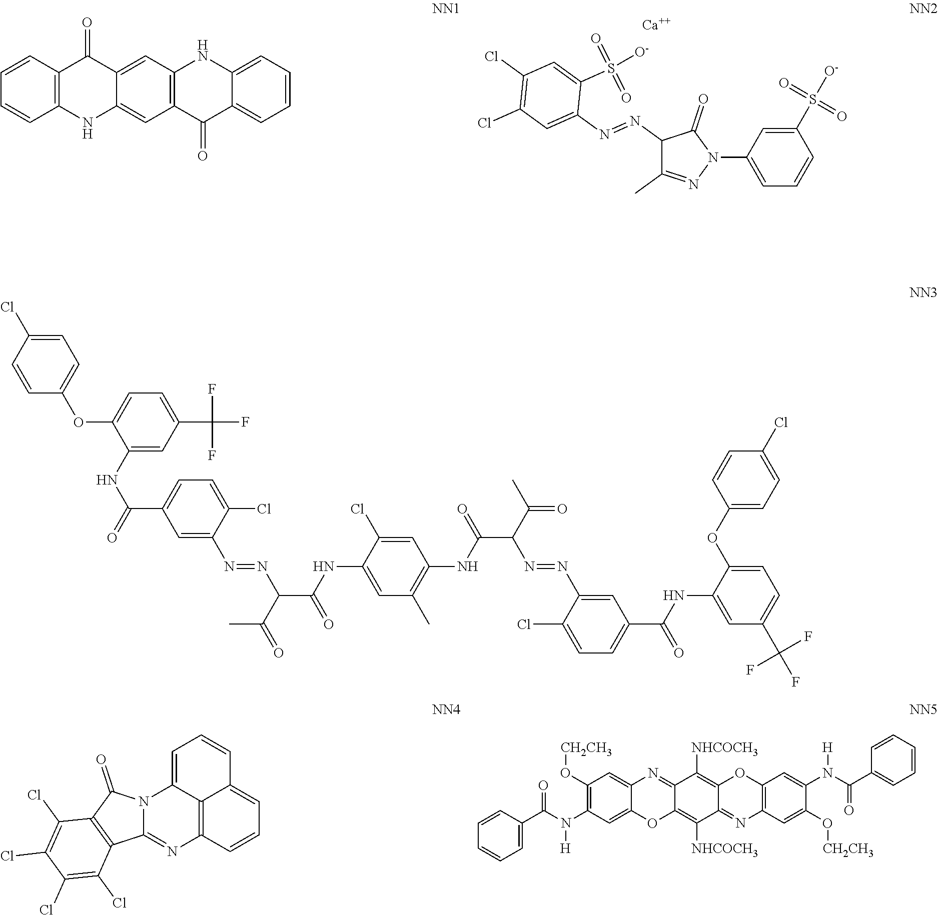

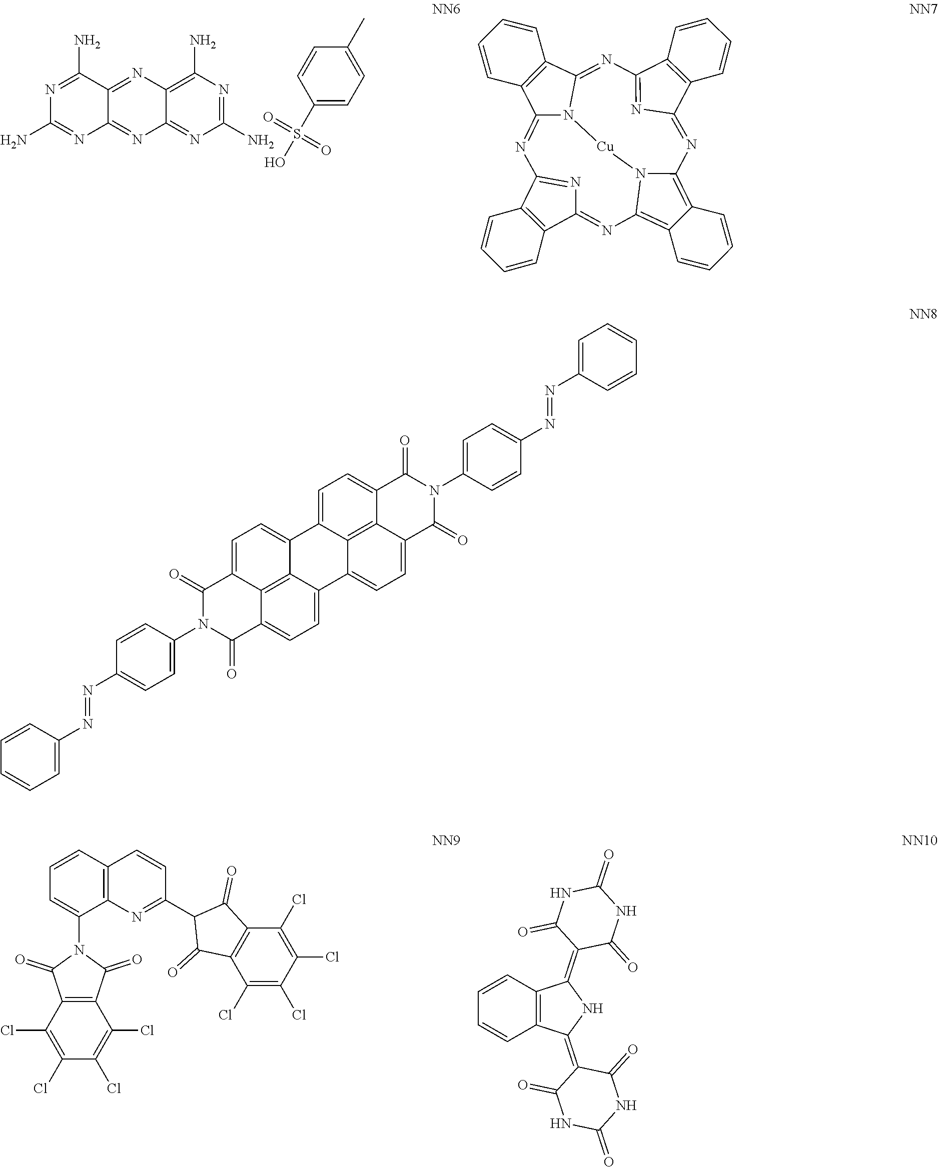

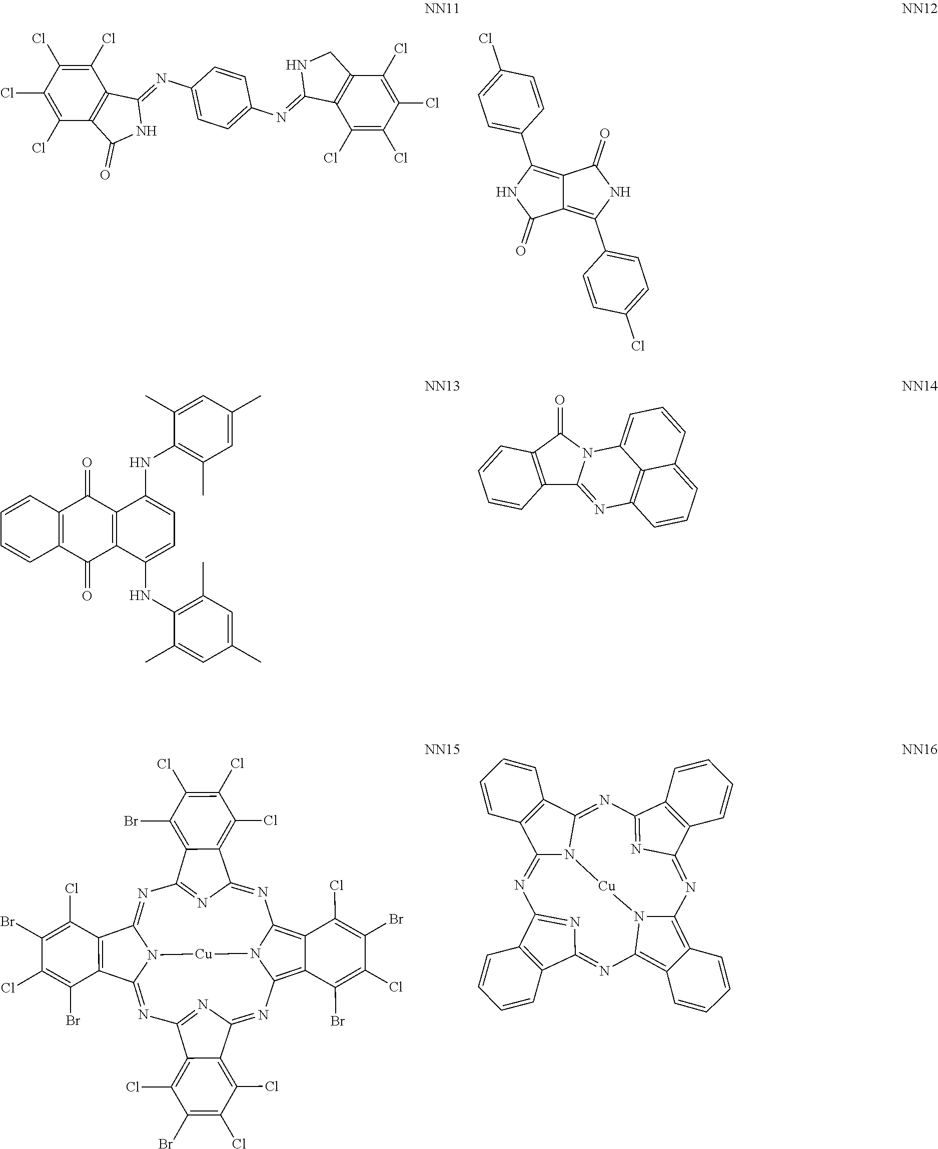

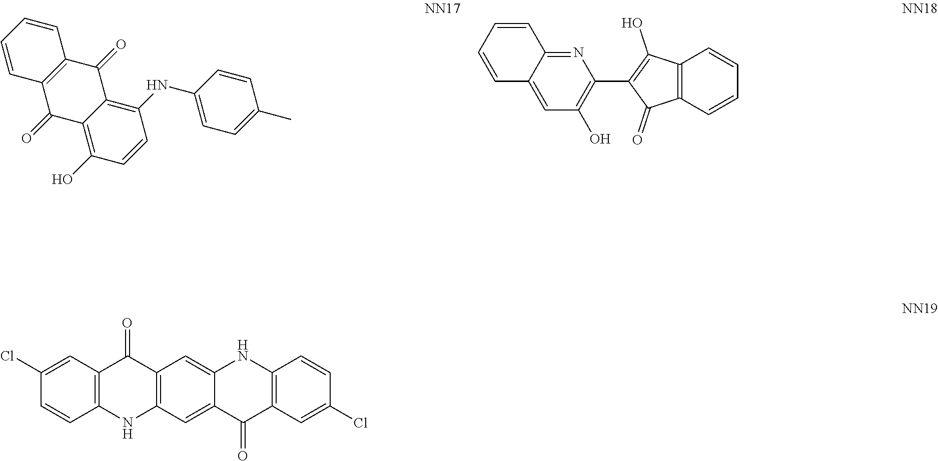 [SMILES: Cc1ccc(Nc2ccc(O)c3c2C(=O)c2ccccc2C3=O)cc1 ; O=C1C(c2nc3ccccc3cc2O)=C(O)c2ccccc21 ; O=c1c2cc(Cl)ccc2[nH]c2cc3c(=O)c4cc(Cl)ccc4[nH]c3cc12]

[Plasticizer (D)]
PL1: “NX-2026” manufactured by Cardolite, cardanol, molecular weight: 298 to 305
PL2: “Ultra LITE 2020” manufactured by Cardolite, hydroxy ethylated cardanol, molecular weight: 343 to 349
PL3: “GX-5170” manufactured by Cardolite, hydroxy ethylated cardanol, molecular weight: 827 to 833
PL4: “Ultra LITE 513” manufactured by Cardolite, glycidyl ether of cardanol, molecular weight: 354 to 361
PL5: “NC-514S” manufactured by Cardolite, cardanol-derived bifunctional epoxy compound, molecular weight: 534 to 537
PL6: “Daifatty 101”, manufactured by Daihachi Chemical Industry Co., Ltd., adipate-containing compound, molecular weight: 326 to 378
PL7: “DOA” manufactured by Mitsubishi Chemical Corporation, dioctyl adipate, molecular weight: 371
PL8: “CITROFOL AHII” manufactured by Jungbunzlauer, acetyl 2-ethylhexyl citrate, molecular weight: 571
PL9: “DOS”, bis (2-ethylhexyl) sebacate manufactured by Daishi Chemical Industry Co., Ltd., molecular weight: 427
PL10: “JP120” manufactured by Mitsubishi Chemical Corporation, gylcol benzoate, molecular weight: 327
PL11: “DOTP” manufactured by Mitsubishi Chemical Corporation, bis(2-ethylhexyl) terephthalate, molecular weight: 391
PL12: “ADK CIZER D-32” manufactured by ADEKA, epoxidized fatty acid 2-ethylhexyl, molecular weight: about 420
PL13: “PEG #600” manufactured by NOF CORPORATION, polyethylene glycol, molecular weight: about 600

### [Polyester Resin (E)]

PE1: “Ingeo 3001D” manufactured by Nature Works, polylactic acid

15 [Poly (Meth)acrylate Compound (F)]
PM1: “Delpet 720V” manufactured by ASAHI KASEI CORPORATION, polymethylmethacrylate

### [Other Additives]

ST1: “Irganox B225” manufactured by BASF SE, mixture of pentaerythritol tetrakis[3-(3′,5′-di-t-butyl-4′-hydroxyphenyl) propionate] and tris(2,4-di-t-butylphenyl) phosphite
MO 1: “SA-1” manufactured by Sakai Chemical, titanium oxide (IV); average particle diameter=150 nm
LUl: “Stearyl Stearate” manufactured by FUJIFILM Wako Pure Chemical, stearyl stearate, compound represented by general formula (1), R¹¹ has 17 carbon atoms, R¹² has 18 carbon atoms.

### Manufacture of Resin Composition, Injection Molding of Resin Molded Body

### Examples 1 to 61, Reference Examples 1 to 14, and Comparative Examples 1 to 20

Kneading is performed in a biaxial kneading apparatus (LTE20-44 manufactured by Labtech Engineering Company) at a feed composition ratio shown in Table 1 and a kneading temperature (cylinder temperature) shown in Table 2 to obtain a pellet (resin composition).

A D12 test piece (60 mm×60 mm×2 mm of thickness) is molded using this pellet at an injection peak pressure not exceeding 180 MPa and at a molding temperature (cylinder temperature) and a mold temperature shown in Table 2 with an injection molding machine (NEX 5001 manufactured by Nissei Plastic Industrial Co., Ltd.).

### <Evaluation of Surface Glossiness>

According to JIS Z8741: 1997 (ISO 2813: 1994), 60-degree specular glossiness of a surface of the D12 test piece is measured to evaluate the surface glossiness with a gloss checker (IG-410 manufactured by Horiba Ltd.).

TABLE 1

| | | | | | | | | Component | | | | | | Component | | | | | |
|---|---|---|---|---|---|---|---|---|---|---|---|---|---|---|---|---|---|---|---|
| | | | | Component | | | | (C)-2 | | | | Component | | (F) | | | | | |
| | | Component | | (B) | | Component | | Component | | Component | | (E) | | Poly | | | | | |
| | | (A) | | Thermoplastic | | (C)-1 | | (C)-3 | | (D) | | Polyester | | (meth)acrylate | | | | | |
| | | Bioresin | | Elastomer | | Organic Compound Particles | | | | Plasticizer | | Resin | | Compound | | Other Additives | | | |
| | | | Cate- | | Cate- | | Cate- | | Cate- | | Cate- | | Cate- | | Cate- | | Cate- | | Cate- |
| | | Type | gory | Type | gory | Type | gory | Type | gory | Type | gory | Type | gory | Type | gory | Type | gory | Type | gory |
| Ex- | 1 | CA1 | 100 | EL1 | 10 | NN1 | 0.5 | | | | | | | | | | | | |
| am- | 2 | CA1 | 100 | EL2 | 10 | NN1 | 0.5 | | | | | | | | | | | | |
| ples | 3 | CA1 | 100 | EL3 | 10 | NN1 | 0.5 | | | | | | | | | | | | |
| | 4 | CA1 | 100 | EL4 | 10 | NN1 | 0.5 | | | | | | | | | | | | |
| | 5 | CA1 | 100 | EL5 | 10 | NN1 | 0.5 | | | | | | | | | | | | |
| | 6 | CA1 | 100 | EL6 | 10 | NN1 | 0.5 | | | | | | | | | | | | |
| | 7 | CA1 | 100 | EL7 | 10 | NN1 | 0.5 | | | | | | | | | | | | |
| | 8 | CA1 | 100 | EL8 | 10 | NN1 | 0.5 | | | | | | | | | | | | |
| | 9 | CA1 | 100 | EL9 | 10 | NN1 | 0.5 | | | | | | | | | | | | |
| | 10 | CA2 | 100 | EL1 | 10 | NN1 | 0.5 | | | | | | | | | | | | |
| | 11 | CA3 | 100 | EL1 | 10 | NN1 | 0.5 | | | | | | | | | | | | |
| | 12 | CA4 | 100 | EL1 | 10 | NN1 | 0.5 | | | | | | | | | | | | |
| | 13 | CA5 | 100 | EL1 | 10 | NN1 | 0.5 | | | | | | | | | | | | |
| | 14 | CA6 | 100 | EL1 | 10 | NN1 | 0.5 | | | | | | | | | | | | |
| | 15 | CA7 | 75 | EL1 | 10 | NN1 | 0.5 | | PL6 | 25 | | | | | | | | | |
| | 16 | CA8 | 75 | EL1 | 10 | NN1 | 0.5 | | PL6 | 25 | | | | | | | | | |
| | 17 | CA1 | 100 | EL1 | 10 | NN2 | 0.5 | | | | | | | | | | | | |
| | 18 | CA1 | 100 | EL1 | 10 | NN3 | 0.5 | | | | | | | | | | | | |
| | 19 | CA1 | 100 | EL1 | 10 | NN4 | 0.5 | | | | | | | | | | | | |
| | 20 | CA1 | 100 | EL1 | 10 | NN5 | 0.5 | | | | | | | | | | | | |

TABLE 2

| | | | | | | | | Component | | | | | | Component | | | | | |
|---|---|---|---|---|---|---|---|---|---|---|---|---|---|---|---|---|---|---|---|
| | | | | Component | | | | (C)-2 | | | | Component | | (F) | | | | | |
| | | Component | | (B) | | Component | | Component | | Component | | (E) | | Poly | | | | | |
| | | (A) | | Thermoplastic | | (C)-1 | | (C)-3 | | (D) | | Polyester | | (meth)acrylate | | | | | |
| | | Bioresin | | Elastomer | | Organic Compound Particles | | | | Plasticizer | | Resin | | Compound | | Other Additives | | | |
| | | | Cate- | | Cate- | | Cate- | | Cate- | | Cate- | | Cate- | | Cate- | | Cate- | | Cate- |
| | | Type | gory | Type | gory | Type | gory | Type | gory | Type | gory | Type | gory | Type | gory | Type | gory | Type | gory |
| Ex- | 21 | CA1 | 100 | EL1 | 10 | NN6 | 0.5 | | | | | | | | | | | | |
| am- | 22 | CA1 | 100 | EL1 | 10 | NN7 | 0.5 | | | | | | | | | | | | |
| ples | 23 | CA1 | 100 | EL1 | 10 | NN8 | 0.5 | | | | | | | | | | | | |
| | 24 | CA1 | 100 | EL1 | 10 | NN9 | 0.5 | | | | | | | | | | | | |
| | 25 | CA1 | 100 | EL1 | 10 | NN10 | 0.5 | | | | | | | | | | | | |
| | 26 | CA1 | 100 | EL1 | 10 | NN11 | 0.5 | | | | | | | | | | | | |
| | 27 | CA1 | 100 | EL1 | 10 | NN12 | 0.5 | | | | | | | | | | | | |
| | 28 | CA1 | 100 | EL1 | 10 | NN13 | 0.5 | | | | | | | | | | | | |
| | 29 | CA1 | 100 | EL1 | 10 | NN14 | 0.5 | | | | | | | | | | | | |
| | 30 | CA1 | 100 | EL1 | 10 | NN15 | 0.5 | | | | | | | | | | | | |
| | 31 | CA1 | 100 | EL1 | 10 | NN16 | 0.5 | | | | | | | | | | | | |
| | 32 | CA1 | 91.5 | EL1 | 7.5 | NN1 | 0.5 | | | PL1 | 8.5 | | | | | ST1 | 0.5 | | |
| | 33 | CA1 | 91.5 | EL1 | 7.5 | NN1 | 0.5 | | | PL2 | 8.5 | | | | | ST1 | 0.5 | | |
| | 34 | CA1 | 91.5 | EL1 | 7.5 | NN1 | 0.5 | | | PL3 | 8.5 | | | | | ST1 | 0.5 | | |
| | 35 | CA1 | 91.5 | EL1 | 7.5 | NN1 | 0.5 | | | PL4 | 8.5 | | | | | ST1 | 0.5 | | |
| | 36 | CA1 | 91.5 | EL1 | 7.5 | NN1 | 0.5 | | | PL5 | 8.5 | | | | | ST1 | 0.5 | | |
| | 37 | CA1 | 91.5 | EL1 | 7.5 | NN1 | 0.5 | | | PL6 | 8.5 | | | | | | | | |
| | 38 | CA1 | 91.5 | EL1 | 7.5 | NN1 | 0.5 | | | PL7 | 8.5 | | | | | MO1 | 0.01 | | |
| | 39 | CA1 | 91.5 | EL1 | 7.5 | NN1 | 0.5 | | | PL8 | 8.5 | | | | | | | | |
| | 40 | CA1 | 91.5 | EL1 | 7.5 | NN1 | 0.5 | | | PL9 | 8.5 | | | | | | | | |

TABLE 3

| | | | | Component | | | | Component | | | | | | Component | | | | | |
|---|---|---|---|---|---|---|---|---|---|---|---|---|---|---|---|---|---|---|---|
| | | | | (B) | | | | (C)-2 | | | | Component | | (F) | | | | | |
| | | Component | | Thermo- | | Component | | Component | | Component | | (E) | | Poly | | | | | |
| | | (A) | | plastic | | (C)-1 | | (C)-3 | | (D) | | Polyester | | (meth)acrylate | | | | | |
| | | Bioresin | | Elastomer | | Organic Compound Particles | | | | Plasticizer | | Resin | | Compound | | Other Additives | | | |
| | | | Cate- | | Cate- | | Cate- | | Cate- | | Cate- | | Cate- | | Cate- | | Cate- | | Cate- |
| | | Type | gory | Type | gory | Type | gory | Type | gory | Type | gory | Type | gory | Type | gory | Type | gory | Type | gory |
| Ex- | 41 | CA1 | 91.5 | EL1 | 7.5 | NN1 | 0.5 | | | PL10 | 8.5 | | | | | | | | |
| am- | 42 | CA1 | 91.5 | EL1 | 7.5 | NN1 | 0.5 | | | PL11 | 8.5 | | | | | | | | |
| ples | 43 | CA1 | 91.5 | EL1 | 7.5 | NN1 | 0.5 | | | PL12 | 8.5 | | | | | | | | |
| | 44 | CA1 | 91.5 | EL1 | 7.5 | NN1 | 0.5 | | | PL13 | 8.5 | | | | | | | | |
| | 45 | CA1 | 91.5 | EL1 | 7.5 | NN1 | 0.5 | | | PL1 | 8.5 | PE1 | 5 | PM1 | 5 | ST1 | 0.5 | LU1 | 2 |
| | 46 | CA1 | 91.5 | EL1 | 7.5 | NN1 | 0.5 | | | PL4 | 8.5 | PE1 | 5 | PM1 | 5 | ST1 | 0.5 | LU1 | 2 |
| | 47 | RC3 | 100 | | | NN1 | 0.5 | | | | | | | | | | | | |
| | 48 | RC3 | 100 | EL1 | 5 | NN1 | 0.5 | | | | | | | | | | | | |
| | 49 | RC3 | 100 | | | NN1 | 0.5 | | | PL1 | 5 | | | | | ST1 | 0.5 | | |
| | 50 | RC3 | 100 | | | NN1 | 0.5 | | | PL4 | 5 | | | | | ST1 | 0.5 | | |
| | 51 | RC1 | 100 | EL1 | 5 | NN1 | 0.5 | | | | | | | | | | | | |
| | 52 | CA1 | 100 | EL1 | 10 | NN1 | 0.03 | | | | | | | | | | | | |
| | 53 | CA1 | 100 | EL1 | 10 | NN1 | 0.1 | | | | | | | | | | | | |
| | 54 | CA1 | 100 | EL1 | 10 | NN1 | 1 | | | | | | | | | | | | |
| | 55 | CA1 | 100 | EL1 | 10 | NN1 | 1.5 | | | | | | | | | | | | |
| | 56 | CA1 | 100 | EL1 | 10 | NN1 | 2 | | | | | | | | | | | | |
| | 57 | CA1 | 100 | EL1 | 10 | NN1 | 0.2 | NN7 | 0.02 | | | | | | | | | | |
| | 58 | CA1 | 100 | EL1 | 10 | NN1 | 0.2 | NN7 | 0.02 | | | | | | | | | | |
| | | | | | | | | NN19 | 0.02 | | | | | | | | | | |
| | 59 | CA1 | 100 | EL1 | 10 | NN2 | 0.2 | NN19 | 0.02 | PL1 | 8.5 | | | | | | | | |
| | 60 | CA1 | 100 | EL1 | 10 | NN3 | 0.2 | NN19 | 0.02 | PL4 | 8.5 | | | | | | | | |
| | 61 | CA1 | 100 | EL1 | 10 | NN2 | 0.2 | NN19 | 0.02 | | | | | | | MO1 | 0.01 | | |

TABLE 4

| | | | | | | | | Component | | | | | | Component | | | | | |
|---|---|---|---|---|---|---|---|---|---|---|---|---|---|---|---|---|---|---|---|
| | | | | Component | | | | (C)-2 | | | | Component | | (F) | | | | | |
| | | Component | | (B) | | Component | | Component | | Component | | (E) | | Poly | | | | | |
| | | (A) | | Thermoplastic | | (C)-1 | | (C)-3 | | (D) | | Polyester | | (meth)acrylate | | | | | |
| | | Bioresin | | Elastomer | | Organic Compound Particles | | | | Plasticizer | | Resin | | Compound | | Other Additives | | | |
| | | | Cate- | | Cate- | | Cate- | | Cate- | | Cate- | | Cate- | | Cate- | | Cate- | | Cate- |
| | | Type | gory | Type | gory | Type | gory | Type | gory | Type | gory | Type | gory | Type | gory | Type | gory | Type | gory |
| Ref- | 1 | CA1 | 100 | | | | | | | | | | | | | | | | |
| er- | 2 | CA1 | 91.5 | EL1 | 7.5 | | | | | PL1 | 8.5 | | | | | ST1 | 0.5 | | |
| ence | 3 | CA1 | 91.5 | EL1 | 7.5 | | | | | PL1 | 8.5 | PE1 | 5 | PM1 | 5 | ST1 | 0.5 | LU1 | 2 |
| Ex- | 4 | CA1 | 91.5 | EL1 | 7.5 | | | | | PL4 | 8.5 | PE1 | 5 | PM1 | 5 | ST1 | 0.5 | LU1 | 2 |
| am- | 5 | CA1 | 100 | EL1 | 10 | | | | | | | | | | | | | | |
| ples | 6 | CA2 | 100 | EL1 | 10 | | | | | | | | | | | | | | |
| | 7 | CA3 | 100 | EL1 | 10 | | | | | | | | | | | | | | |
| | 8 | CA4 | 100 | EL1 | 10 | | | | | | | | | | | | | | |
| | 9 | CA5 | 100 | EL1 | 10 | | | | | | | | | | | | | | |
| | 10 | CA6 | 100 | EL1 | 10 | | | | | | | | | | | | | | |
| | 11 | CA7 | 75 | EL1 | 10 | | | | | PL6 | 25 | | | | | | | | |
| | 12 | CA8 | 75 | EL1 | 10 | | | | | PL6 | 25 | | | | | | | | |
| | 13 | CA1 | 100 | EL1 | 10 | NN17 | 0.5 | | | | | | | | | | | | |
| | 14 | CA1 | 100 | EL1 | 10 | NN18 | 0.5 | | | | | | | | | | | | |

TABLE 5

| | | | | | | | | Component | | | | | | Component | | | | | |
|---|---|---|---|---|---|---|---|---|---|---|---|---|---|---|---|---|---|---|---|
| | | | | Component | | | | (C)-2 | | | | Component | | (F) | | | | | |
| | | Component | | (B) | | Component | | Component | | Component | | (E) | | Poly | | | | | |
| | | (A) | | Thermoplastic | | (C)-1 | | (C)-3 | | (D) | | Polyester | | (meth)acrylate | | | | | |
| | | Bioresin | | Elastomer | | Organic Compound Particles | | | | Plasticizer | | Resin | | Compound | | Other Additives | | | |
| | | | Cate- | | Cate- | | Cate- | | Cate- | | Cate- | | Cate- | | Cate- | | Cate- | | Cate- |
| | | Type | gory | Type | gory | Type | gory | Type | gory | Type | gory | Type | gory | Type | gory | Type | gory | Type | gory |
| Com- | 1 | CA1 | 100 | | | NN1 | 0.5 | | | | | | | | | | | | |
| par- | 2 | CA1 | 91.5 | | | NN1 | 0.5 | | | PL1 | 8.5 | | | | | ST1 | 0.5 | | |
| ative | 3 | CA1 | 91.5 | | | NN1 | 0.5 | | | PL1 | 8.5 | PE1 | 5 | PM1 | 5 | ST1 | 0.5 | LU1 | 2 |
| Ex- | 4 | CA1 | 91.5 | | | NN1 | 0.5 | | | PL4 | 8.5 | PE1 | 5 | PM1 | 5 | ST1 | 0.5 | LU1 | 2 |
| am- | 5 | CA1 | 100 | | | NN2 | 0.5 | | | | | | | | | | | | |
| ples | 6 | CA1 | 100 | | | NN3 | 0.5 | | | | | | | | | | | | |
| | 7 | CA1 | 100 | | | NN4 | 0.5 | | | | | | | | | | | | |
| | 8 | CA1 | 100 | | | NN5 | 0.5 | | | | | | | | | | | | |
| | 9 | CA1 | 100 | | | NN6 | 0.5 | | | | | | | | | | | | |
| | 10 | CA1 | 100 | | | NN7 | 0.5 | | | | | | | | | | | | |
| | 11 | CA1 | 100 | | | NN8 | 0.5 | | | | | | | | | | | | |
| | 12 | CA1 | 100 | | | NN9 | 0.5 | | | | | | | | | | | | |
| | 13 | CA1 | 100 | | | NN10 | 0.5 | | | | | | | | | | | | |
| | 14 | CA1 | 100 | | | NN11 | 0.5 | | | | | | | | | | | | |
| | 15 | CA1 | 100 | | | NN12 | 0.5 | | | | | | | | | | | | |
| | 16 | CA1 | 100 | | | NN13 | 0.5 | | | | | | | | | | | | |
| | 17 | CA1 | 100 | | | NN14 | 0.5 | | | | | | | | | | | | |
| | 18 | CA1 | 100 | | | NN15 | 0.5 | | | | | | | | | | | | |
| | 19 | CA1 | 100 | | | NN16 | 0.5 | | | | | | | | | | | | |
| | 20 | RC1 | 100 | | | NN1 | 0.5 | | | | | | | | | | | | |

TABLE 6

| | | | | | | | | | Component (C)-2 Organic | | | | |
|---|---|---|---|---|---|---|---|---|---|---|---|---|---|
| | | | | | | | | | Compound | | | | |
| | | | | | | | | | Particle: Physical Prpperty | | | | |
| | | | | | | | | | Component (C)-3 Organic | | | | Eval- |
| | | | | | Component (C)-1 Organic Compound | | | | Compound | | | | uation |
| | | Conditions | | | Particles: Physical Prpperty | | | | Particle: Physical Prpperty | | | | 60- |
| | | Kneading | Molding | Mold | | | Volume | | | | Volume | | degree |
| | | Tem- | Tem- | Tem- | | | Average | | | | Average | | surface |
| | | per- | per- | per- | N | | Particle | Mole- | N | | Particle | Mole- | glossi- |
| | | ature | ature | ature | num- | | Diameter | cular | num- | | Diameter | cular | ness |
| | | (° C.) | (° C.) | (° C.) | ber | Type | nm | Weight | ber | Type | nm | Weight | % |
| Examples | 1 | 220 | 220 | 40 | 2 | Containing N—H Bond | 480 | 312 | | | | | 88 |
| | 2 | 220 | 220 | 40 | 2 | Containing N—H Bond | 480 | 312 | | | | | 86 |
| | 3 | 220 | 220 | 40 | 2 | Containing N—H Bond | 480 | 312 | | | | | 86 |
| | 4 | 220 | 220 | 40 | 2 | Containing N—H Bond | 480 | 312 | | | | | 85 |
| | 5 | 220 | 220 | 40 | 2 | Containing N—H Bond | 480 | 312 | | | | | 85 |
| | 6 | 220 | 220 | 40 | 2 | Containing N—H Bond | 480 | 312 | | | | | 85 |
| | 7 | 220 | 220 | 40 | 2 | Containing N—H Bond | 480 | 312 | | | | | 86 |
| | 8 | 220 | 220 | 40 | 2 | Containing N—H Bond | 480 | 312 | | | | | 85 |
| | 9 | 220 | 220 | 40 | 2 | Containing N—H Bond | 480 | 312 | | | | | 86 |
| | 10 | 220 | 220 | 40 | 2 | Containing N—H Bond | 480 | 312 | | | | | 85 |
| | 11 | 220 | 220 | 40 | 2 | Containing N—H Bond | 480 | 312 | | | | | 88 |
| | 12 | 220 | 220 | 40 | 2 | Containing N—H Bond | 480 | 312 | | | | | 87 |
| | 13 | 220 | 220 | 40 | 2 | Containing N—H Bond | 480 | 312 | | | | | 88 |
| | 14 | 220 | 220 | 40 | 2 | Containing N—H Bond | 480 | 312 | | | | | 87 |
| | 15 | 220 | 220 | 40 | 2 | Containing N—H Bond | 480 | 312 | | | | | 88 |
| | 16 | 230 | 230 | 40 | 2 | Containing N—H Bond | 480 | 312 | | | | | 80 |
| | 17 | 220 | 220 | 40 | 4 | Containing N═N Bond | 650 | 521 | | | | | 81 |
| | 18 | 220 | 220 | 40 | 8 | Containing N—H Bond | 880 | 1229 | | | | | 87 |
| | | | | | | Containing N═N Bond | | | | | | | |
| | 19 | 220 | 220 | 40 | 2 | Not Containing N═N | 300 | 408 | | | | | 82 |
| | | | | | | Bond | | | | | | | |
| | | | | | | Not Containing N—H | | | | | | | |
| | | | | | | Bond | | | | | | | |
| | 20 | 220 | 220 | 40 | 4 | Containing N—H Bond | 480 | 727 | | | | | 87 |

TABLE 7

| | | | | | | | | | Component (C)-2 Organic | | | | |
|---|---|---|---|---|---|---|---|---|---|---|---|---|---|
| | | | | | | | | | Compound | | | | |
| | | | | | | | | | Particle: Physical Prpperty | | | | |
| | | | | | | | | | Component (C)-3 Organic | | | | Eval- |
| | | | | | Component (C)-1 Organic Compound | | | | Compound | | | | uation |
| | | Conditions | | | Particles: Physical Prpperty | | | | Particle: Physical Prpperty | | | | 60- |
| | | Kneading | Molding | Mold | | | Volume | | | | Volume | | degree |
| | | Tem- | Tem- | Tem- | | | Average | | | | Average | | surface |
| | | per- | per- | per- | N | | Particle | Mole- | N | | Particle | Mole- | glossi- |
| | | ature | ature | ature | num- | | Diameter | cular | num- | | Diameter | cular | ness |
| | | (° C.) | (° C.) | (° C.) | ber | Type | nm | Weight | ber | Type | nm | Weight | % |
| Examples | 21 | 220 | 220 | 40 | 10 | Containing N—H Bond | 880 | 416 | | | | | 88 |
| | 22 | 220 | 220 | 40 | 8 | Organometallic Compound | 310 | 576 | | | | | 87 |
| | 23 | 220 | 220 | 40 | 6 | Containing N═N Bond | 570 | 751 | | | | | 88 |
| | 24 | 220 | 220 | 40 | 2 | Not Containing N═N Bond | 770 | 695 | | | | | 81 |
| | | | | | | Not Containing N—H Bond | | | | | | | |
| | 25 | 220 | 220 | 40 | 5 | Containing N—H Bond | 490 | 367 | | | | | 86 |
| | 26 | 220 | 220 | 40 | 4 | Containing N—H Bond | 520 | 642 | | | | | 88 |
| | 27 | 220 | 220 | 40 | 2 | Containing N—H Bond | 920 | 357 | | | | | 88 |
| | 28 | 220 | 220 | 40 | 2 | Containing N—H Bond | 610 | 329 | | | | | 88 |
| | 29 | 220 | 220 | 40 | 2 | Not Containing N═N Bond | 290 | 270 | | | | | 80 |
| | | | | | | Not Containing N—H Bond | | | | | | | |
| | 30 | 220 | 220 | 40 | 8 | Organometallic Compound | 520 | 1394 | | | | | 82 |
| | 31 | 210 | 210 | 40 | 8 | Organometallic Compound | 1150 | 576 | | | | | 81 |
| | 32 | 210 | 210 | 40 | 2 | Containing N—H Bond | 480 | 312 | | | | | 95 |
| | 33 | 210 | 210 | 40 | 2 | Containing N—H Bond | 480 | 312 | | | | | 96 |
| | 34 | 210 | 210 | 40 | 2 | Containing N—H Bond | 480 | 312 | | | | | 95 |
| | 35 | 210 | 210 | 40 | 2 | Containing N—H Bond | 480 | 312 | | | | | 96 |
| | 36 | 210 | 210 | 40 | 2 | Containing N—H Bond | 480 | 312 | | | | | 94 |
| | 37 | 210 | 210 | 40 | 2 | Containing N—H Bond | 480 | 312 | | | | | 96 |
| | 38 | 210 | 210 | 40 | 2 | Containing N—H Bond | 480 | 312 | | | | | 96 |
| | 39 | 210 | 210 | 40 | 2 | Containing N—H Bond | 480 | 312 | | | | | 94 |
| | 40 | 210 | 210 | 40 | 2 | Containing N—H Bond | 480 | 312 | | | | | 87 |

TABLE 8

| | | | | | | | | | Component (C)-2 Organic | | | | |
|---|---|---|---|---|---|---|---|---|---|---|---|---|---|
| | | | | | | | | | Compound | | | | |
| | | | | | | | | | Particle: Physical Prpperty | | | | |
| | | | | | | | | | Component (C)-3 Organic | | | | Eval- |
| | | | | | Component (C)-1 Organic Compound | | | | Compound | | | | uation |
| | | Conditions | | | Particle: Physical Prpperty | | | | Particle: Physical Prpperty | | | | 60- |
| | | Kneading | Molding | Mold | | | Volume | | | | Volume | | degree |
| | | Tem- | Tem- | Tem- | | | Average | | | | Average | | surface |
| | | per- | per- | per- | N | | Particle | Mole- | N | | Particle | Mole- | glossi- |
| | | ature | ature | ature | num- | | Diameter | cular | num- | | Diameter | cular | ness |
| | | (° C.) | (° C.) | (° C.) | ber | Type | nm | Weight | ber | Type | nm | Weight | % |
| Ex- | 41 | 210 | 210 | 40 | 2 | Containing N—H Bond | 480 | 312 | | | | | 93 |
| am- | 42 | 210 | 210 | 40 | 2 | Containing N—H Bond | 480 | 312 | | | | | 93 |
| ples | 43 | 210 | 210 | 40 | 2 | Containing N—H Bond | 480 | 312 | | | | | 94 |
| | 44 | 210 | 210 | 40 | 2 | Containing N—H Bond | 480 | 312 | | | | | 90 |
| | 45 | 210 | 210 | 40 | 2 | Containing N—H Bond | 480 | 312 | | | | | 95 |
| | 46 | 210 | 210 | 40 | 2 | Containing N—H Bond | 480 | 312 | | | | | 95 |
| | 47 | 230 | 230 | 40 | 2 | Containing N—H Bond | 480 | 312 | | | | | 84 |
| | 48 | 220 | 220 | 40 | 2 | Containing N—H Bond | 480 | 312 | | | | | 84 |
| | 49 | 220 | 220 | 40 | 2 | Containing N—H Bond | 480 | 312 | | | | | 94 |
| | 50 | 220 | 200 | 40 | 2 | Containing N—H Bond | 480 | 312 | | | | | 94 |
| | 51 | 200 | 200 | 40 | 2 | Containing N—H Bond | 480 | 312 | | | | | 96 |
| | 52 | 200 | 200 | 40 | 2 | Containing N—H Bond | 480 | 312 | | | | | 95 |
| | 53 | 200 | 200 | 40 | 2 | Containing N—H Bond | 480 | 312 | | | | | 93 |
| | 54 | 200 | 200 | 40 | 2 | Containing N—H Bond | 480 | 312 | | | | | 88 |
| | 55 | 200 | 200 | 40 | 2 | Containing N—H Bond | 480 | 312 | | | | | 87 |
| | 56 | 200 | 200 | 40 | 2 | Containing N—H Bond | 480 | 312 | | | | | 83 |
| | 57 | 200 | 200 | 40 | 2 | Containing N—H Bond | 480 | 312 | 8 | Organometallic | 310 | 576 | 88 |
| | | | | | | | | | | Compound | | | |
| | 58 | 200 | 200 | 40 | 2 | Containing N—H Bond | 480 | 312 | 8 | Organometallic | 310 | 576 | 87 |
| | | | | | | | | | | Compound | | | |
| | | | | | | | | | 2 | Containing N—H | 1430 | 381 | |
| | | | | | | | | | | Bond | | | |
| | 59 | 200 | 200 | 40 | 4 | Containing N═N Bond | 650 | 521 | 2 | Containing N—H | 1430 | 381 | 94 |
| | | | | | | | | | | Bond | | | |
| | 60 | 200 | 200 | 40 | 8 | Containing N—H Bond | 880 | 1229 | 2 | Containing N—H | 1430 | 381 | 93 |
| | | | | | | Containing N═N Bond | | | | Bond | | | |
| | 61 | 200 | 200 | 40 | 4 | Containing N═N Bond | 650 | 521 | 2 | Containing N—H | 1430 | 381 | 87 |
| | | | | | | | | | | Bond | | | |

TABLE 9

| | | | | | | | | | Component (C)-2 Organic | | | | |
|---|---|---|---|---|---|---|---|---|---|---|---|---|---|
| | | | | | | | | | Compound | | | | |
| | | | | | | | | | Particle: Physical Prpperty | | | | |
| | | | | | | | | | Component (C)-3 Organic | | | | Eval- |
| | | | | | Component (C)-1 Organic Compound | | | | Compound | | | | uation |
| | | Conditions | | | Particle: Physical Prpperty | | | | Particle: Physical Prpperty | | | | 60- |
| | | Kneading | Molding | Mold | | | Volume | | | | Volume | | degree |
| | | Tem- | Tem- | Tem- | | | Average | | | | Average | | surface |
| | | per- | per- | per- | N | | Particle | Mole- | N | | Particle | Mole- | glossi- |
| | | ature | ature | ature | num- | | Diameter | cular | num- | | Diameter | cular | ness |
| | | (° C.) | (° C.) | (° C.) | ber | Type | nm | Weight | ber | Type | nm | Weight | % |
| Examples | 1 | 230 | 230 | 40 | | | | | | | | | 95 |
| | 2 | 210 | 210 | 40 | | | | | | | | | 96 |
| | 3 | 210 | 210 | 40 | | | | | | | | | 94 |
| | 4 | 210 | 210 | 40 | | | | | | | | | 94 |
| | 5 | 220 | 220 | 40 | | | | | | | | | 95 |
| | 6 | 220 | 220 | 40 | | | | | | | | | 95 |
| | 7 | 220 | 220 | 40 | | | | | | | | | 94 |
| | 8 | 220 | 220 | 40 | | | | | | | | | 95 |
| | 9 | 220 | 220 | 40 | | | | | | | | | 94 |
| | 10 | 220 | 220 | 40 | | | | | | | | | 94 |
| | 11 | 220 | 220 | 40 | | | | | | | | | 96 |
| | 12 | 230 | 230 | 40 | | | | | | | | | 96 |
| | 13 | 220 | 220 | 40 | 1 | Containing N—H | 490 | 329 | | | | | 93 |
| | | | | | | Bond | | | | | | | |
| | 14 | 220 | 220 | 40 | 1 | Not Containing | 840 | 289 | | | | | 95 |
| | | | | | | N═N Bond | | | | | | | |
| | | | | | | Not Containing N—H | | | | | | | |
| | | | | | | Bond | | | | | | | |

TABLE 10

| | | | | | | | | | Component (C)-2 Organic | | | | |
|---|---|---|---|---|---|---|---|---|---|---|---|---|---|
| | | | | | | | | | Compound | | | | |
| | | | | | | | | | Particle: Physical Prpperty | | | | |
| | | | | | | | | | Component (C)-3 Organic | | | | Eval- |
| | | | | | Component (C)-1 Organic Compound | | | | Compound | | | | uation |
| | | Conditions | | | Particle: Physical Prpperty | | | | Particle: Physical Prpperty | | | | 60- |
| | | Kneading | Molding | Mold | | | Volume | | | | Volume | | degree |
| | | Tem- | Tem- | Tem- | | | Average | | | | Average | | surface |
| | | per- | per- | per- | N | | Particle | Mole- | N | | Particle | Mole- | glossi- |
| | | ature | ature | ature | num- | | Diameter | cular | num- | | Diameter | cular | ness |
| | | (° C.) | (° C.) | (° C.) | ber | Type | nm | Weight | ber | Type | nm | Weight | % |
| Com- | 1 | 230 | 230 | 40 | 2 | Containing N—H Bond | 480 | 312 | | | | | 77 |
| parative | 2 | 210 | 210 | 40 | 2 | Containing N—H Bond | 480 | 312 | | | | | 78 |
| Examples | 3 | 210 | 210 | 40 | 2 | Containing N—H Bond | 480 | 312 | | | | | 77 |
| | 4 | 210 | 210 | 40 | 2 | Containing N—H Bond | 480 | 312 | | | | | 75 |
| | 5 | 230 | 230 | 40 | 4 | Containing N═N Bond | 650 | 521 | | | | | 76 |
| | 6 | 230 | 230 | 40 | 8 | Containing N—H Bond | 880 | 1229 | | | | | 75 |
| | | | | | | Containing N═N Bond | | | | | | | |
| | 7 | 230 | 230 | 40 | 2 | Not Containing N═N | 300 | 408 | | | | | 75 |
| | | | | | | Bond | | | | | | | |
| | | | | | | Not Containing N—H | | | | | | | |
| | | | | | | Bond | | | | | | | |
| | 8 | 230 | 230 | 40 | 4 | Containing N—H Bond | 480 | 727 | | | | | 74 |
| | 9 | 230 | 230 | 40 | 10 | Containing N—H Bond | 880 | 416 | | | | | 78 |
| | 10 | 230 | 230 | 40 | 8 | Organometallic | 310 | 576 | | | | | 77 |
| | | | | | | Compound | | | | | | | |
| | 11 | 230 | 230 | 40 | 6 | Containing N═N Bond | 570 | 751 | | | | | 74 |
| | 12 | 230 | 230 | 40 | 2 | Not Containing N═N | 770 | 695 | | | | | 77 |
| | | | | | | Bond | | | | | | | |
| | | | | | | Not Containing N—H | | | | | | | |
| | | | | | | Bond | | | | | | | |
| | 13 | 230 | 230 | 40 | 5 | Containing N—H Bond | 490 | 367 | | | | | 75 |
| | 14 | 230 | 230 | 40 | 4 | Containing N—H Bond | 520 | 642 | | | | | 75 |
| | 15 | 230 | 230 | 40 | 2 | Containing N—H Bond | 920 | 357 | | | | | 76 |
| | 16 | 230 | 230 | 40 | 2 | Containing N—H Bond | 610 | 329 | | | | | 77 |
| | 17 | 230 | 230 | 40 | 2 | Not Containing N═N | 290 | 270 | | | | | 76 |
| | | | | | | Bond | | | | | | | |
| | | | | | | Not Containing N—H | | | | | | | |
| | | | | | | Bond | | | | | | | |
| | 18 | 230 | 230 | 40 | 8 | Organometallic | 520 | 1394 | | | | | 73 |
| | | | | | | Compound | | | | | | | |
| | 19 | 230 | 230 | 40 | 8 | Organometallic | 1150 | 576 | | | | | 77 |
| | | | | | | Compound | | | | | | | |
| | 20 | 200 | 200 | 40 | 2 | Containing N—H Bond | 480 | 312 | | | | | 75 |

From results shown in the tables, it is understood that in the resin composition of the exemplary embodiment, a resin molded body having high surface glossiness (gloss) is obtained as compared with the resin composition of the Comparative Examples.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A resin composition comprising:
a cellulose acylate (A);
a thermoplastic elastomer (B); and
particles (C) of at least one type of organic compound containing two or more nitrogen atoms in a molecule.

2. The resin composition according to claim 1,
wherein the thermoplastic elastomer (B) is at least one thermoplastic elastomer selected from the group consisting of:
a polymer (b1) having a core-shell structure including a core layer and a shell layer containing alkyl (meth)acrylate on a surface of the core layer;
an olefin polymer (b2) that is a polymer of an α-olefin and alkyl (meth)acrylate and contains 60 mass % or more of monomers derived from the α-olefin;
a polymer (b3) having a core-shell structure including a core layer containing a butadiene polymer, and a shell layer containing a polymer selected from a styrene polymer and an acrylonitrile-styrene polymer on a surface of the core layer;
a styrene-ethylene-butadiene-styrene copolymer (b4);
a polyurethane (b5); and
a polyester (b6).

3. The resin composition according to claim 1,
wherein the cellulose acylate (A) is at least one selected from the group consisting of cellulose acetate, cellulose acetate propionate, and cellulose acetate butyrate.

4. The resin composition according to claim 3,
wherein the cellulose acylate (A) is at least one selected from the cellulose acetate propionate and the cellulose acetate butyrate.

5. The resin composition according to claim 1,
wherein the organic compound of the particles (C) contains at least one of a nitrogen-nitrogen double bond and a nitrogen-hydrogen bond.

6. The resin composition according to claim 1,
wherein the organic compound of the particles (C) is an organometallic compound.

7. The resin composition according to claim 1,
wherein a molecular weight of the organic compound of the particles (C) is 300 or more and 1,300 or less.

8. The resin composition according to claim 1,
wherein a volume average diameter of the particles (C) is 10 nm or more and 1,000 nm or less.

9. The resin composition according to claim 1, further containing a plasticizer (D).

10. The resin composition according to claim 1,
wherein the plasticizer (D) contains at least one selected from the group consisting of a cardanol compound, a dicarboxylic acid diester, a citrate, a polyether compound including one or more unsaturated bonds in the molecule, a polyether ester compound, a glycol benzoate, a compound represented by the following general formula (6), and an epoxidized fatty acid ester, 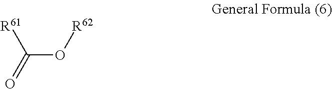
wherein, in the general formula (6), R⁶¹ represents an aliphatic hydrocarbon group having 7 to 28 carbon atoms, and R⁶² represents an aliphatic hydrocarbon group having 1 to 8 carbon atoms.

11. The resin composition according to claim 1, further comprising a polyester resin (E).

12. The resin composition according to claim 11,
wherein the polyester resin (E) is a polyhydroxyalkanoate.

13. The resin composition according to claim 1, further comprising a poly(meth)acrylate compound (F).

14. A resin molded body comprising the resin composition according to claim 1.

15. The resin molded body according to claim 14,
wherein the resin molded body is an injection molded body.

16. The resin composition according to claim 2,
wherein the cellulose acylate (A) is at least one selected from the group consisting of cellulose acetate, cellulose acetate propionate, and cellulose acetate butyrate.

17. The resin composition according to claim 16,
wherein the cellulose acylate (A) is at least one selected from the cellulose acetate propionate and the cellulose acetate butyrate.

18. The resin composition according to claim 2, wherein the organic compound of the particles (C) contains at least one of a nitrogen-nitrogen double bond and a nitrogen-hydrogen bond.

19. The resin composition according to claim 3, wherein the organic compound of the particles (C) contains at least one of a nitrogen-nitrogen double bond and a nitrogen-hydrogen bond

20. The resin composition according to claim 4, wherein the organic compound of the particles (C) contains at least one of a nitrogen-nitrogen double bond and a nitrogen-hydrogen bond.
